(19) United States
(12) Patent Application Publication
(10) Pub. No.: US 2026/0291856 A1
(43) Pub. Date: Sep. 24, 2026

(54) COMMUNICATION SYSTEM, MANAGEMENT DEVICE, CONTROL DEVICE, CONTROL METHOD, AND NON-TRANSITORY STORAGE MEDIUM STORING CONTROL PROGRAM

(71) Applicant: DENSO CORPORATION, Kariya-city (JP)

(72) Inventors: Yukihiro YAMAKAWA, Kariya-city (JP); Tomoya TOKUNAGA, Kariya-city (JP)

(21) Appl. No.: 19/565,668

(22) Filed: Mar. 13, 2026

(30) Foreign Application Priority Data
Mar. 18, 2025 (JP) 2025-043625

(51) Int. Cl. H04L 45/00; H04L 45/24; H04L 45/74

(52) U.S. Cl. CPC H04L 45/22; H04L 45/24; H04L 45/74

(57) ABSTRACT

A communication system is provided that includes a control device, a management device, a main communication route and a redundant route. The main communication route enables a main message to be communicated between the management device and the control device and include a main communication line connecting the management device and the control device. The redundant route includes a redundant communication line connecting between two or more target devices. The communication system further includes a message arbitration unit that is provided in one or more of the management device and the control device, and that performs arbitration on two or more of the messages.

### CROSS-REFERENCE OF RELATED APPLICATIONS

This application is based on Japanese Patent Application No. 2025-043625 filed in Japan on Mar. 18, 2025. The entire disclosure of the above application is incorporated herein by reference.

### TECHNICAL FIELD

The present disclosure relates to a communication system, a management device, a control device, a control method, and a non-transitory storage medium storing a control program.

### BACKGROUND

A vehicle includes a number of electronic control units (hereinafter referred to as ECUs) to control onboard equipment. A technology is known to reduce power consumption of a communication system for a vehicle as a whole by transitioning some unnecessary ECUs from a wake-up state to a sleep state.

### SUMMARY

According to an aspect of the present disclosure, a communication system is provided. In the communication system, a management device and a control device are capable of communicating a message through a communication line. The management device sends a main message regarding activation or stop of the control device and a redundant message having the same message as the main message to the control device by using a main communication route and a redundant route. The control device and/or the management device performs arbitration on two or more of the messages.

### BRIEF DESCRIPTION OF DRAWINGS

Objects, features and advantages of the present disclosure will become apparent from the following detailed description made with reference to the accompanying drawings.

FIG. 1A is a functional block diagram illustrating an overall configuration of a communication system according to a first embodiment.

FIG. 1B is a functional block diagram illustrating part of the communication system.

FIG. 2 is a functional block diagram illustrating a mobility computer.

FIG. 3 is a functional block diagram illustrating a battery ECU.

FIG. 4 is a functional block diagram illustrating a first PNB ECU.

FIG. 5 is a functional block diagram illustrating a second PNB ECU.

FIG. 6 is a functional block diagram illustrating a first zone ECU.

FIG. 7 is a functional block diagram illustrating a second zone ECU.

FIG. 8 is a diagram illustrating state transition in a vehicle.

FIG. 9 is a sequence diagram in a case of active-keeping (Part 1).

FIG. 10 is a flowchart illustrating a vehicle power state keeping process by a management device.

FIG. 11 is a diagram illustrating an example of a main communication route and a redundant route (Part 1).

FIG. 12 is a flowchart illustrating a receiving process for a vehicle power state.

FIG. 13 is diagram illustrating a message arbitration process.

FIG. 14 is a flowchart illustrating a message arbitration process (Part 1).

FIG. 15A is a flowchart illustrating the message arbitration process (Part 2).

FIG. 15B is a functional block diagram illustrating each ECU regarding the message arbitration for the vehicle power state.

FIG. 16A is a flowchart illustrating the message arbitration process (Part 3).

FIG. 16B is a functional block diagram illustrating each ECU regarding message arbitration for a stop preparation request (Part 1).

FIG. 16C is a functional block diagram illustrating each ECU regarding the message arbitration for the stop preparation requests (Part 2).

FIG. 17 is a flowchart illustrating a message relaying process for the vehicle power state.

FIG. 18 is a flowchart illustrating a message receiving process for the vehicle power state.

FIG. 19 is a flowchart illustrating a message sending process for the vehicle power state.

FIG. 20 is a sequence diagram in a case of active-keeping (Part 2-1) and changing the vehicle power state (Part 1).

FIG. 21 is a sequence diagram in a case of active-keeping (Part 2-2) and changing the vehicle power state (Part 2).

FIG. 22 is a diagram illustrating an example of a main communication route and a redundant route (Part 2).

FIG. 23 is a flowchart illustrating a stop process by the management device.

FIG. 24 is a sequence diagram illustrating a stop preparation process (Part 1).

FIG. 25A is a flowchart illustrating the stop preparation process (Part 1).

FIG. 25B is a diagram Illustrating a difficulty associated with communication cutoff.

FIG. 26 is a flowchart illustrating a message receiving process for the stop preparation request.

FIG. 27 is a flowchart illustrating a message relaying process for the stop preparation request.

FIG. 28 is a flowchart illustrating a message relaying process for stop preparation completion.

FIG. 29 is a flowchart illustrating a message receiving process for the stop preparation completion.

FIG. 30 is a sequence diagram illustrating a power control process at a time of stop (Part 1).

FIG. 31 is a flowchart illustrating a power control process at a time of stop/activation (Part 1).

FIG. 32 is a flowchart illustrating a message relaying process for a power control request at a time of stop/activation.

FIG. 33 is a flowchart illustrating a message receiving process for a power control request at a time of stop/activation.

FIG. 34 is a flowchart illustrating a message relaying process for power control completion at a time of stop/activation.

FIG. 35 is a flowchart illustrating a message receiving process for power control completion at a time of stop/activation.

FIG. 36 is a sequence diagram illustrating the stop preparation process (Part 2).

FIG. 37 is a flowchart illustrating the stop preparation process (Part 2).

FIG. 38 is a sequence diagram illustrating the power control process at a time of stop (Part 2).

FIG. 39 is a flowchart illustrating the power control process at a time of stop/activation (Part 2).

FIG. 40 is a flowchart illustrating an activation process by a management device.

FIG. 41 is a sequence diagram illustrating a sending process for an NM message.

FIG. 42 is a flowchart illustrating receiving process for the NM message.

FIG. 43 is a flowchart illustrating an arbitration process on the NM message.

FIG. 44 is a flowchart illustrating a relaying process for the NM message.

FIG. 45 is a sequence diagram illustrating a power control process at a time of activation (Part 1).

FIG. 46 is a sequence diagram illustrating the power control process at a time of activation (Part 2).

FIG. 47A is a diagram illustrating ECU functional blocks and controls regarding a communication cutoff detection process and route switchover according to a modification of the first embodiment.

FIG. 47B is a diagram illustrating abnormality detection-and-route switchover control in a communication system according to a second embodiment.

FIG. 48 is a diagram illustrating management of the vehicle power state according to a third embodiment (Part 1).

FIG. 49 is a diagram illustrating management of the vehicle power state according to the third embodiment (Part 2).

FIG. 50 is a diagram illustrating management of stop preparation according to a fourth embodiment.

FIG. 51A is a functional block diagram illustrating an overall configuration of a communication system according to a fifth embodiment.

FIG. 51B is a functional block diagram illustrating a third zone ECU.

### DETAILED DESCRIPTION

A vehicle includes a number of electronic control units (hereinafter referred to as ECUs) to control onboard equipment, and a communication system is constructed by connecting these ECUs to communication buses. In this type of communication system, a technology is known to reduce power consumption of the system as a whole by transitioning some unnecessary ECUs from a wake-up state to a sleep state. As means for activating and stopping the ECU, there is a configuration in which mechanical relay control is performed for each system for example.

In contrast to a configuration that uses mechanical relay control, there is arising a technology in recent years that employs high-performance semiconductor power switches (hereafter referred to as IPDs (Intelligent Power Devices)) which can configure various power states using software in a dynamic and low power consumption manner. In the configuration employing the IPD, power control can be performed on an ECU-by-ECU basis by combining an activation-stop control based on IPD on/off and an activation-stop control based on communication frames. However, there is a concern that a failure to execute a correct stop process due to a communication abnormality could lead to an equipment malfunction.

It is an object of the present disclosure to provide a communication system, a control method of an electronic control unit, and a control program for an electronic control unit that can normally keep operating, stop or activate even if a communication abnormality occurs.

According to a first aspect of the present disclosure, a communication system is provided that comprises:
a plurality of control devices and a management device configured to be capable of communicating a message through a communication line;
a main communication route that enables a main message to be communicated between the management device and a control device, and that includes a main communication line connecting the management device and the control device, wherein the control device is included in the plurality of control devices; and
a redundant route that includes a redundant communication line connecting between two or more target devices, wherein the two or more target devices are between at least two of the management device and the plurality of control devices, and the redundant route is one or more redundant routes,
wherein the management device is configured to send the main message regarding activation or stop of the control device and a redundant message having the same message as the main message to the control device by using the main communication route and the redundant route, wherein the redundant message is one or more redundant messages.

The communication system further comprises a message arbitration unit that is provided in one or more of: the management device and the control device, and that performs arbitration on two or more of: the main message and the one or more redundant messages. Since the message arbitration unit performs the arbitration on two or more of the main message and the one or more redundant messages, it is possible to normally keep operating, stop or activate even if a communication abnormality occurs.

According to a second aspect of the present disclosure, the management device included in the above communication system is provided.

According to a third aspect of the present disclosure, the control device included in the above communication system is provided.

According to a fourth aspect of the present disclosure, a control method performed by a communication system is provided,
the communication system including:
a plurality of control devices and a management device configured to be capable of communicating a message through a communication line;
a main communication route that enables a main message to be communicated between the management device and a control device, and that includes a main communication line connecting the management device and the control device, wherein the control device is included in the plurality of control devices; and
a redundant route that includes a redundant communication line connecting between two or more target devices, wherein the two or more target devices are between at least two of the management device and the plurality of control devices, and the redundant route is one or more redundant routes,
wherein the management device is configured to send the main message regarding activation or stop of the control device and a redundant message having the same message as the main message to the control device by using the main communication route and the redundant route, wherein the redundant message is one or more redundant messages,
the control method comprising:
by a message arbitration unit provided in one or more of the management device and the control device, performing arbitration on two or more of: the main message and the one or more redundant messages.

According to a fifth aspect of the present disclosure, a control program executed by a communication system is provided,
the communication system including:
a plurality of control devices and a management device configured to be capable of communicating a message through a communication line;
a main communication route that enables a main message to be communicated between the management device and a control device, and that includes a main communication line connecting the management device and the control device, wherein the control device is included in the plurality of control devices; and
a redundant route that includes a redundant communication line connecting between two or more target devices, wherein the two or more target devices are between at least two of the management device and the plurality of control devices, and the redundant route is one or more redundant routes,
the control program causing:
the management device to send the main message regarding activation or stop of the control device and a redundant message having the same message as the main message to the control device by using the main communication route and the redundant route, wherein the redundant message is one or more redundant messages; and
one or more of the management device and the control device to perform arbitration on two or more of: the main message and the one or more redundant messages.

Embodiments will be described below. In the following embodiments, like reference symbols are used to refer to like parts to omit redundant descriptions.

### First Embodiment

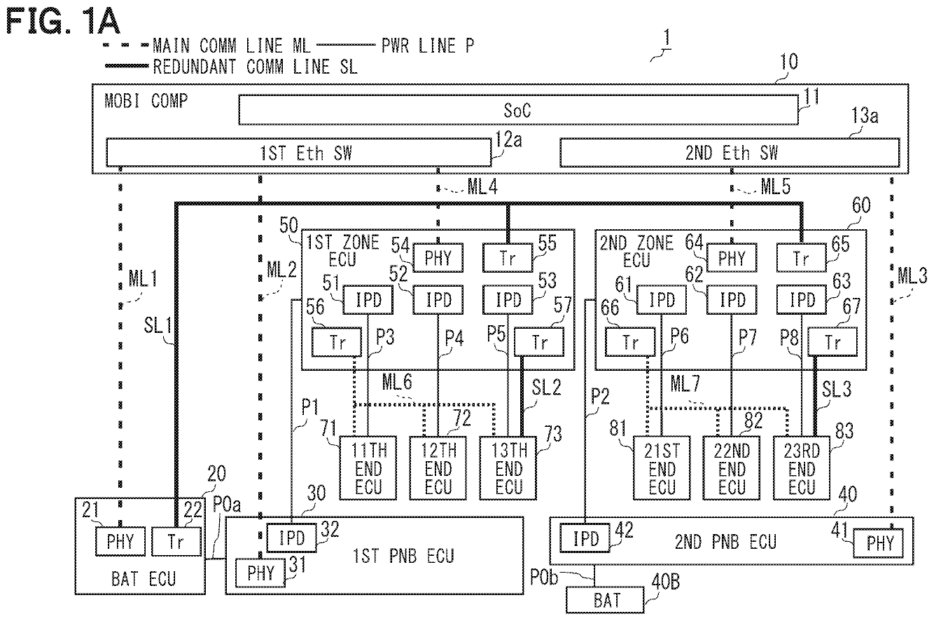

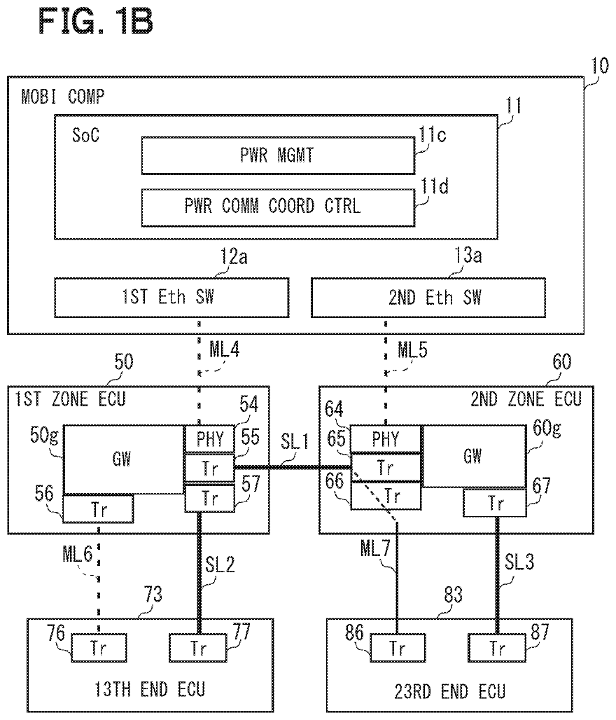

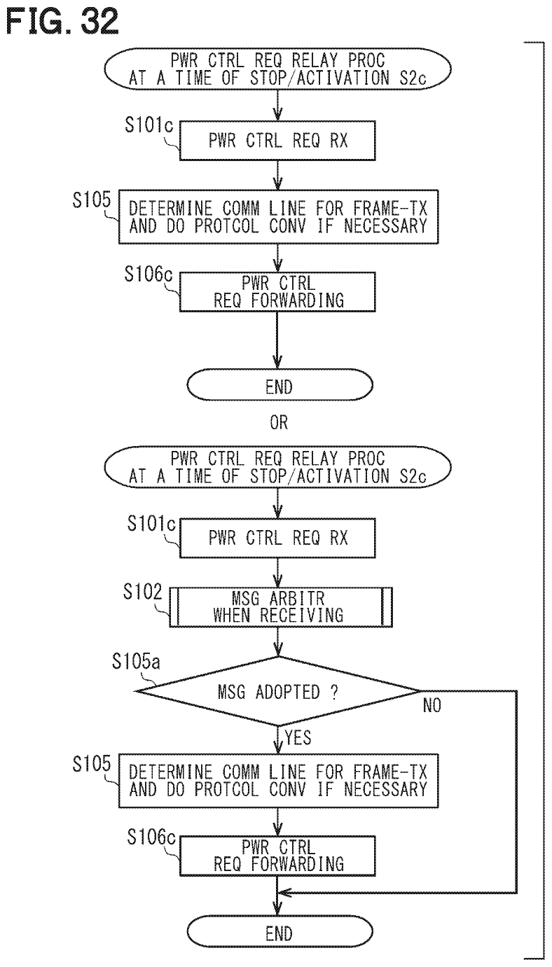

A first embodiment will be described with reference to FIGS. 1 to 47B. A communication system 1 is based on a star-type zone architecture and zone topology and includes a plurality of ECUs arranged according to divisions called zones, which indicate locations in a vehicle body, for example, front, rear, left and right.

As shown in FIG. 1A, the communication system 1 mounted on the vehicle (corresponding to a movable body) includes a mobility computer 10 (corresponding to a management device), a battery ECU 20 communicably connected to the mobility computer 10, a first PNB ECU 30, a second PNB ECU 40, a first zone ECU 50, a second zone ECU 60, an eleventh end ECU 71, a twelfth end ECU 72, a thirteenth end ECU 73, a twenty-first end ECU 81, a twenty-second end ECU 82, and a twenty-third end ECUs 83. The eleventh end ECU 71, the twelfth end ECU 72 and the thirteenth end ECU 73 are communicably connected to the first zone ECU 50. The twenty-first end ECU 81, the twenty-second end ECU 82, and the twenty-third end ECUs 83 are communicably connected to the second zone ECU 60.

The eleventh end ECU 71, the twelfth end ECU 72, and the thirteenth end ECU 73 may be referred to collectively as end ECUs 71 to 73. The end ECU 71 to 73 corresponds to a cascade-connection control device connected to the first zone ECU 50 for cascade-connection. Similarly, the twenty-first end ECU 81, the twenty-second end ECU 82, and the twenty-third end ECU 83 may be referred to collectively as end ECUs 81 to 83. The end ECU 81 to 83 corresponds to a cascade-connection control device connected to the second zone ECU 60 for cascade-connection. FIG. 1B schematically shows part of FIG. 1A and illustrates main and redundant communication routes.

The battery ECU 20 is connected to a battery (not shown in the drawings) of a high voltage system and manages power distribution. The PNB ECU indicates an abbreviation for Power Net Box. The first PNB ECU 30 represents an ECU for high voltage power distribution management. The second PNB ECU 40 is connected to a battery 40B of a low voltage system and represents an ECU for low voltage power distribution management.

In FIG. 1A, the two zone ECUs 50 and 60 are illustrated as zone ECUs communicably connected to the mobility computer 10, but there may be one or three or more zone ECUs communicably connected to the mobility computer 10. Although three end ECUs 71 to 73 are illustrated as ECUs communicably connected to the first zone ECU 50, there may be one, two or four or more end ECUs communicably connected to the first zone ECU 50. The first zone ECU 50 and the end ECU 73 constitute high voltage system ECUs (corresponding to high voltage system control devices) supplied with power by the relatively high voltage battery and are used to operate the high voltage system. The second zone ECU 60 and the end ECUs 81 to 83 constitute low voltage system ECUs (corresponding to low voltage system control devices) supplied with power from the relatively low voltage battery 40B and are used to operate a system other than the high voltage system.

Similarly, three end ECUs 81, 82, 83 are illustrated as end ECUs communicably connected to the second zone ECU 60, but there may be one, two, or four or more end ECUs communicably connected to the second zone ECU 60. The mobility computer 10 is a management device capable of controlling the operations of the battery ECU 20, the first zone ECU 50, the second zone ECU 60, and the end ECUs 71 to 73, 81 to 83.

The mobility computer 10 and the battery ECU 20 are communicably connected to each other via a first main communication line ML1. The mobility computer 10 and the first PNB ECU 30 are communicably connected to each other via a second main communication line ML2. The mobility computer 10 and the second PNB ECU 40 are communicably connected to each other via a third main communication line ML3. The mobility computer 10 and the first zone ECU 50 are communicably connected to each other via a fourth main communication line ML4. The mobility computer 10 and the second zone ECU 60 are communicably connected to each other via a fifth main communication line ML5.

The battery ECU 20, the first zone ECU 50, and the second zone ECU 60 are connected to each other via a redundant communication line SL1. The first zone ECU 50 and the end ECUs 71 to 73 are communicably connected to each other via a sixth main communication line ML6. The first zone ECU 50 and the thirteenth end ECU 73 are communicably connected to each other via a second redundant communication line SL2, which is separate from the sixth main communication line ML6.

The second zone ECU 60 and the end ECUs 81 to 83 are communicably connected to each other via a seventh main communication line ML7. The second zone ECU 60 and the twenty-third end ECU 83 are communicably connected to each other via a third redundant communication line SL3, which is separate from the seventh main communication line ML7.

### Manner to Distribute Power to Mobility Computer 10 and Each ECU

In FIG. 1A and FIG. 1B, part of power lines is omitted. The battery ECU 20 is supplied with power for operation from a battery not shown in the drawings and distributes the supplied power to the mobility computer 10 and the first PNB ECU 30. The low voltage battery 40B is connected to the second PNB ECU 40 through a power line P0b, and the power is distributed from the battery 40B to the second PNB ECU 40. The first PNB ECU 30 includes an intelligent power device (IPD) 32 which is a high-performance semiconductor power switch. The IPD 32 is interposed between a power line P0a extending from the battery ECU 20 to the first PNB ECU 30 and a power line P1 extending from the first PNB ECU 30 to the first zone ECU 50.

The second PNB ECU 40 includes an IPD 42 which is a high-performance semiconductor power switch. The IPD 42 is interposed between a power line P0b extending from battery 40B to the second PNB ECU 40 and a power line P2 extending from the second PNB ECU 40 to the second zone ECU 60.

The IPD is a high-performance semiconductor power switch with built-in protection circuitry to protect against high heat and high temperatures. IPDs are also referred to as semiconductor fuses, IPS (Intelligent Power switch), smart switches, etc. Compared to mechanical relays having mechanical contacts, IPDs do not have mechanical contacts, and thus have advantages of superior mechanical durability and quietness, as well as compact size. In addition, IDPs have a protection function that does not exist in mechanical relays, thus ensuring a high level of reliability.

The first PNB ECU 30 is capable of turning ON and OFF the IPD 32 based on an on/off instruction for the IPD 32 from the mobility computer 10 and switching over the first zone ECU 50 between a power-supplied state and a power cutoff state. The first zone ECU 50 includes IPDs 51, 52, and 53, which are high-performance semiconductor power switches.

The IPD 51 is interposed between the power line P1 extending from the first PNB ECU 30 to the first zone ECU 50 and a power line P3 extending from the first zone ECU 50 to the eleventh end ECU 71. The IPD 52 is interposed between the power line P1 extending from the first PNB ECU 30 to the first zone ECU 50 and a power P4 extending from the first zone ECU 50 to the twelfth end ECU 72. The IPD 53 is interposed between the power line P1 extending from the first PNB ECU 30 to the first zone ECU 50 and a power line P5 extending from the first zone ECU 50 to the thirteenth end ECU 73.

The first zone ECU 50 turns ON and OFF each IPD 51, 52, 53 based on an on/off instruction for the IPD 51, 52, 53 from the mobility computer 10 to switch over the end ECU 71, 72, 73 between the power-supplied state and the power cutoff state.

The second PNB ECU 40 is supplied with power from the battery 40B. The second PNB ECU 40 turns ON and OFF the IPD 42 based on an on/off instruction for the IPD 42 from the mobility computer 10 to switch over the second zone ECU 60 between the power-supplied state and the power cutoff state. The second zone ECU 60 includes IPDs 61, 62, and 63, which are high-performance semiconductor power switches.

The IPD 61 is interposed between the power line P2 extending from the second PNB ECU 40 to the second zone ECU 60 and a power line P6 extending from the second zone ECU 60 to the twenty-first end ECU 81. The IPD 62 is interposed between the power line P2 extending from the second PNB ECU 40 to the second zone ECU 60 and a power line P7 extending from the second zone ECU 60 to the twenty-second end ECU 82. The IPD 63 is interposed between the power line P2 extending from the second PNB ECU 40 to the second zone ECU 60 and a power line P8 extending from the second zone ECU 60 to the twenty-third end ECU 83.

The second zone ECU 60 turns ON and OFF each IPD 61, 62, 63 based on an on/off instruction for the IPD 61, 62, 63 from the mobility computer 10 to switch over each end ECU 81, 82, 83 between the power-supplied state and the power cutoff state.

### On main communication lines ML1 to ML7 and redundant communication lines SL1 to SL3

Hereafter, part or all of the main communication lines ML1 to ML7 may be abbreviated as main communication lines ML. Part or all of the redundant communication lines SL1 to SL3 may be abbreviated as redundant communication lines SL. The main communication line ML is a communication line normally used to communicate the main message. The redundant communication line SL is a communication line that is provided in order to keep vehicle operation appropriately or in order to stop vehicle operation appropriately. For example, the redundant communication line SL may be provided for a case where part of the main communication line ML is cut off due to, for example, some influences. The redundant communication line SL may be provided in order to activate or stop power supply normally, or in order to stop the high voltage system appropriately.

### On PHY

As shown in FIG. 1A, the battery ECU 20 includes a PHY 21. The first PNB ECU 30 includes a PHY 31. The second PNB ECU 40 includes a PHY 41. The first zone ECU 50 includes a PHY 54. The second zone ECU 60 includes a PHY 64. These PHYs 21, 31, 54, 64 perform communications conforming to so-called automotive Ethernet standards. Ethernet is a registered trademark. These PHYs 21, 31, 54, 64 are communication circuits that can communicate with a first Ethernet switch 12a and a second Ethernet switch 13a of the mobility computer 10.

### On Communication Circuit for CAN Standards

As shown in FIG. 1A, the battery ECU 20 includes a communication circuit 22. The first zone ECU 50 includes communication circuits 55, 56, 57. The second zone ECU 60 includes communication circuits 65, 66, 67. Although not shown in FIG. 1A, the end ECUs 71 to 73, 81 to 83 include communication circuits having the same functions as the communication circuits 55, 56, 57, 65, 66, 67. The communication circuit 55, 56, 57, 65, 66, 67 includes a transistor Tr for the physical layer and can cause signals to be communicated by changing the level of each communication line to a H/L level according to on/off of the transistor Tr constituting the communication circuit 55, 56, 57, 65, 66, 67.

The communication circuit 55, 56, 57, 65, 66, 67 can cause communications based on communication frames conforming to communication protocols of CAN (Controller Area Network) or CAN FD (CAN With Flexible Data Rate), for example, at the physical layer and higher layers. CAN FD is standards that extend the CAN protocol specification. For each communication group defined based on the zones, the communication system 1 collectively shifts one or more ECUs belonging to the communication group to the wake-up or sleep state. In the communication system 1, an NM frame is used to wake up the ECU in the sleep state, wherein the NM frame is an automotive Ethernet/CAN frame in which activation information designating an active group (a group to be active) is included in the NM message. NM is an abbreviation for Network Management.

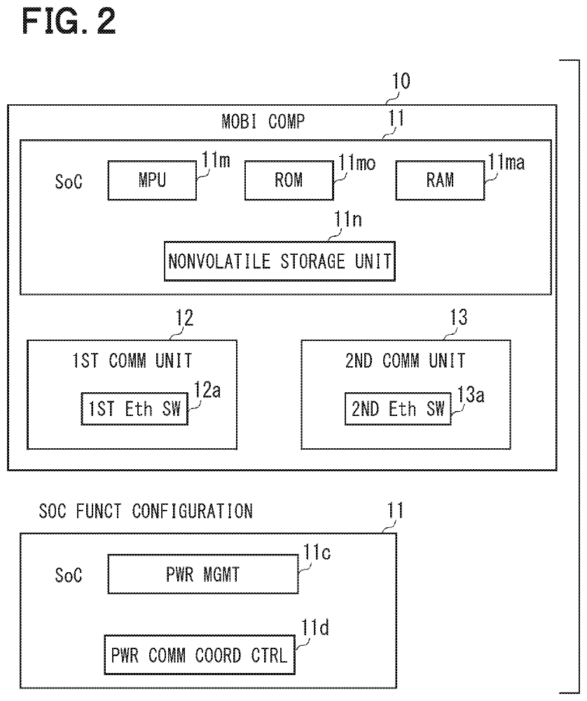

A hardware configuration of a respective component shown in FIG. 1A will be schematically described below with reference to FIGS. 2 to 7.

### Electrical Configuration of Mobility Computer 10

As shown in FIG. 2, the mobility computer 10 includes a SoC 11 as a mobility computer control device, and further includes a first mobility computer communication unit 12, and a second mobility computer communication unit 13. The first mobility computer communication unit 12 includes the first Ethernet switch 12a, and the second mobility computer communication unit 13 includes the second Ethernet switch 13a. The Ethernet switches 12a and 13a constitute a switching hub.

The SoC 11 is a device that performs various calculations and other processing related to operation of the mobility computer 10, etc., and includes, for example, a MPU 11m, a RAM 11ma, a ROM 11mo, and a mobility computer nonvolatile storage unit 11n. The SoC 11 constituting the mobility computer 10 has functions of power management 11c and power communication coordination control 11d, as shown in FIG. 1B. The SoC is an abbreviation for System-On-Chip.

Various functions of the SoC 11 serving as the mobility computer control device are implemented by the MPU 11m executing a program stored in a non-transitory tangible storage medium. The non-transitory tangible storage medium is, for example, the ROM 11mo or the mobility computer nonvolatile storage unit 11n. When the program is executed by the MPU 11m, a method corresponding to the program is executed. In the present embodiment, when a stop activation control program is executed by the MPU 11m, a method corresponding to the stop activation control program for the electronic control unit is executed. The number of microcontrollers constituting the control unit of the mobility computer 10 may be one or more. A method of implementing the various functions of the control device of the mobility computer 10 is not limited to software, and part or all of elements of the various functions may be implemented by using one or more hardware pieces. For example, when the above function is implemented by a hardware communication circuit, the communication circuit may be a digital circuit including many logic circuits, or an analog circuit, or a combination of the digital circuit and the analog circuit. The mobility computer nonvolatile storage unit 11n is, for example, a nonvolatile memory, such as a flash memory, an EEPROM, etc., that can be rewritten with various data.

As shown in FIG. 1A, the first Ethernet switch 12a of the first mobility computer communication unit 12 is connected to the first main communication line ML1, the second main communication line ML2, and the fourth main communication line ML4. The first Ethernet switch 12a performs data communication with the battery ECU 20 via the main communication line ML1, with the first PNB ECU 30 via the main communication line ML2, and with the first zone ECU 50 via the main communication line ML4.

The second Ethernet switch 13a is connected to the third main communication line ML3 and the fifth main communication line ML5. The second Ethernet switch 13a of the second mobility computer communication unit 13 performs data communication with the second PNB ECU 40 via the third main communication line ML3 and with the second zone ECU 60 via the fifth main communication line ML5.

### Electrical Configuration of the Battery ECU 20

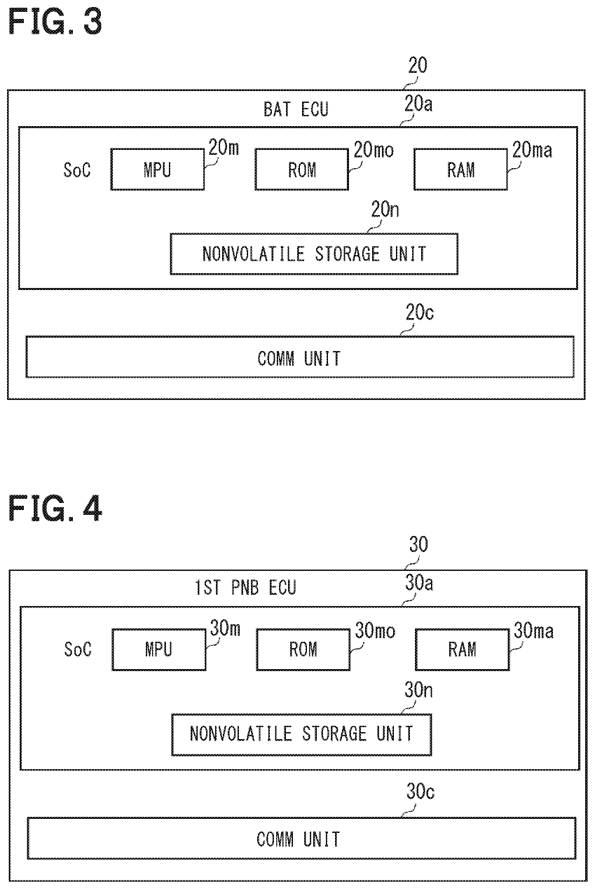

As shown in FIG. 3, the battery ECU 20 includes a SoC 20a as a battery ECU control device, and further includes a battery ECU communication unit 20c. The SoC 20a is a device that performs various calculations and other processing related to operation of the battery ECU 20, etc., and includes, for example, a MPU 20m, a RAM 20ma, a ROM 20mo, and a battery ECU nonvolatile storage unit 20n.

Various functions of the SoC 20a are implemented by the MPU 20m executing a program stored in a non-transitory tangible storage medium. The non-transitory tangible storage medium is, for example, the ROM 20mo or the battery ECU nonvolatile storage unit 20n. When the program is executed by MPU 20m, a method corresponding to the program is executed. In the present embodiment, when a stop activation control program is executed by the MPU 20m, a method corresponding to the stop activation control program for the electronic control unit is executed. The number of microcontrollers constituting the battery ECU control unit of the battery ECU 20 may be one or more. A method of implementing the various functions of the battery ECU control device of the battery ECU 20 is not limited to software, and part or all of elements of the various functions may be implemented by using one or more hardware pieces. For example, when the above function is implemented by a hardware communication circuit, the communication circuit may be a digital circuit including many logic circuits, or an analog circuit, or a combination of the digital circuit and the analog circuit. The battery ECU nonvolatile storage unit 20n is, for example, a nonvolatile memory, such as a flash memory, an EEPROM, etc., that can be rewritten with various data.

The battery ECU communication unit 20c includes a communication circuit 22 using the PHY 21 and the transistor Tr, as shown in FIG. 1A. The PHY 21 performs data communication with the mobility computer 10 via the main communication line ML1, and the communication circuit 22 performs data communication with the first zone ECU 50 and the second zone ECU 60 via the redundant communication line SL1. In the present embodiment, the battery ECU communication unit 20c does not have an Eth-CAN gateway. This is because it is sufficient that an Eth-CAN gateway is provided in the zone ECU 50, 60. The Eth-CAN gateway is a gateway that performs protocol conversion between a communication frame of the PHY 21 and a communication frame of the communication circuit 22. As with the case of the first zone ECU 50 and the second zone ECU 60 described below, the Eth-CAN gateways 50ga and 60ga may be provided.

### Electrical Configuration of the First PNB ECU 30

As shown in FIG. 4, the first PNB ECU 30 includes a SoC 30a as a first PNB control device and further includes a first PNB ECU communication unit 30c. The SoC 30a is a device that performs various calculations and other processing related to operation of the first PNB ECU 30, etc., and includes for example, a MPU 30m, a RAM 30ma, a ROM 30mo, and a first PNB nonvolatile storage unit 30n.

Various functions of the SoC 30a are implemented by MPU 30m executing a program stored in a non-transitory tangible storage medium. The non-transitory tangible storage medium is, for example, the ROM 30mo or the first PNB nonvolatile storage unit 30n. When the program is executed by the MPU 30m, a method corresponding to the program is executed. In the present embodiment, when a stop activation control program is executed by the MPU 30m, a method corresponding to the stop activation control program for the electronic control unit is executed. The number of microcontrollers constituting the first PNB control unit of the first PNB ECU 30 may be one or more. A method of implementing the various functions of the first PNB control unit of the first PNB ECU 30 is not limited to software, and part or all of elements of the various functions may be implemented by using one or more hardware pieces. For example, when the above function is implemented by a hardware communication circuit, the communication circuit may be a digital circuit including many logic circuits, or an analog circuit, or a combination of the digital circuit and the analog circuit.

The first PNB nonvolatile storage unit 30n is, for example, a nonvolatile memory, such as a flash memory, an EEPROM, etc., that can be rewritten with various data. The first PNB ECU communication unit 30c includes a PHY 31 as shown in FIG. 1A, and the PHY 31 performs data communication with the mobility computer 10 via the main communication line ML2.

### Electrical Configuration of the Second PNB ECU 40

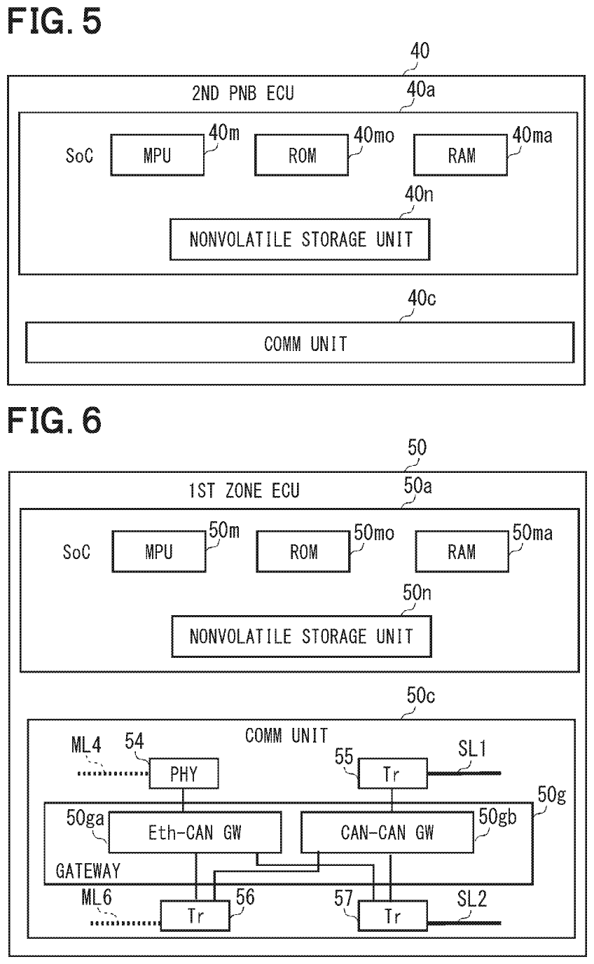

As shown in FIG. 5, the second PNB ECU 40 includes a SoC 40a as a second PNB control device and further includes a second PNB ECU communication unit 40c. The SoC 40a is a device that performs various calculations and other processing related to operation of the second PNB ECU 40, etc., and includes, for example, a MPU 40m, a RAM 40ma, a ROM 40mo, a second PNB ECU nonvolatile storage unit 40n.

Various functions of the SoC 40a are implemented by the MPU 40m executing a program stored in a non-transitory tangible storage medium. The non-transitory tangible storage medium is, for example, the ROM 40mo or the second PNB ECU nonvolatile storage unit 40n. When the program is executed by the MPU 40m, a method corresponding to the program is executed. In the present embodiment, when a stop activation control program is executed by the MPU 50m, a method corresponding to the stop activation control program for the electronic control unit is executed. The number of microcontrollers constituting the second PNB control unit of the second PNB ECU 40 may be one or more. A method of implementing the various functions of the first PNB control unit of the second PNB ECU 40 is not limited to software, and part or all of elements of the various functions may be implemented by using one or more hardware pieces. For example, when the above function is implemented by a hardware communication circuit, the communication circuit may be a digital circuit including many logic circuits, or an analog circuit, or a combination of the digital circuit and the analog circuit.

The second PNB ECU nonvolatile storage unit 40n is, for example, a nonvolatile memory, such as a flash memory, an EEPROM, etc., that can be rewritten with various data. The second PNB ECU communication unit 40c includes a PHY 41 as shown in FIG. 1A, and the PHY 41 performs data communication with the mobility computer 10 via the main communication line ML3.

### Electrical Configuration of the First Zone ECU 50

The first zone ECU 50 and the second zone ECU 60 can control the vehicle as a whole while dividing resources into divisions of the vehicle. The divisions may be a front division and a rear division, or, a left division and a right division. The first zone ECU 50 is, for example, an ECU that manages all of the ECUs in the front division of the vehicle.

As shown in FIG. 6, the first zone ECU 50 includes a SoC 50a as a first zone control device and further includes a first zone communication unit 50c. The SoC 50a is a device that performs various calculation processes and other processing related to operation of the first zone ECU 50, etc., and includes, for example, a MPU 50m, a RAM 50ma, a ROM 50mo, and a first zone nonvolatile storage unit 50n.

Various functions of the SoC 50a are implemented by the MPU 50m executing a program stored in a non-transitory tangible storage medium. The non-transitory tangible storage medium is, for example, the ROM 50mo or the first zone nonvolatile storage unit 50n. When the program is executed by MPU 50m, a method corresponding to the program is executed. In the present embodiment, when a stop activation control program is executed by the MPU 60m, a method corresponding to the stop activation control program for the electronic control unit is executed. The number of microcontrollers constituting the first zone control unit of the first zone ECU 50 may be one or more. A method of implementing the various functions of the first zone control unit of the first zone ECU 50 is not limited to software, and part or all of elements of the various functions may be implemented by using one or more hardware pieces. For example, when the above function is implemented by a hardware communication circuit, the communication circuit may be a digital circuit including many logic circuits, or an analog circuit, or a combination of the digital circuit and the analog circuit.

The first zone nonvolatile storage unit 50n is, for example, a nonvolatile memory, such as a flash memory, an EEPROM, etc., that can be rewritten with various data. The first zone communication unit 50c includes a gateway 50g, a PHY 54, and communication circuits 55, 56, 57.

The PHY 54 is connected to the fourth main communication line ML4. The communication circuit 55 is connected to the redundant communication line SL1. The communication circuit 56 is connected to the sixth main communication line ML6. The communication circuit 57 is connected to the second redundant communication line SL2.

The PHY 54 performs data communication with the mobility computer 10 via the fourth main communication line ML4. The communication circuit 55 performs data communication with the battery ECU 20 and the second zone ECU 60 via the redundant communication line SL1. The communication circuit 56 performs data communication with the ECUs 71 to 73 via the sixth main communication line ML6. The communication circuit 57 performs data communication with the end ECU 73 via the second redundant communication line SL6.

FIG. 1B illustrates communication circuits 76,77 built into the thirteenth end ECU 73. The communication circuit 76, 77 includes a transceiver that can communicate based on the CAN standards. The communication circuit 56 performs data communication with the communication circuit 76 of the thirteenth end ECU 73. The communication circuit 57 performs data communication with the communication circuit 77 of the thirteenth end ECU 73 via the third redundant communication line SL3. The gateway 50g has a function of switching over the communication line being the relay destination and the transmission destination for the communication frames of the PHY 54 and the communication circuits 55 to 57, as well as a function of protocol conversion between the Ethernet standards and the CAN standards (Eth-CAN gateway 50ga in FIG. 6). The gateway 50g also has a CAN-CAN gateway function (CAN-CAN gateway 50gb in FIG. 6) to switch over the communication line being the relay destination and the transmission destination for the communication frames of the communication circuits 55 to 57.

### Electrical Configuration of the Second Zone ECU 60

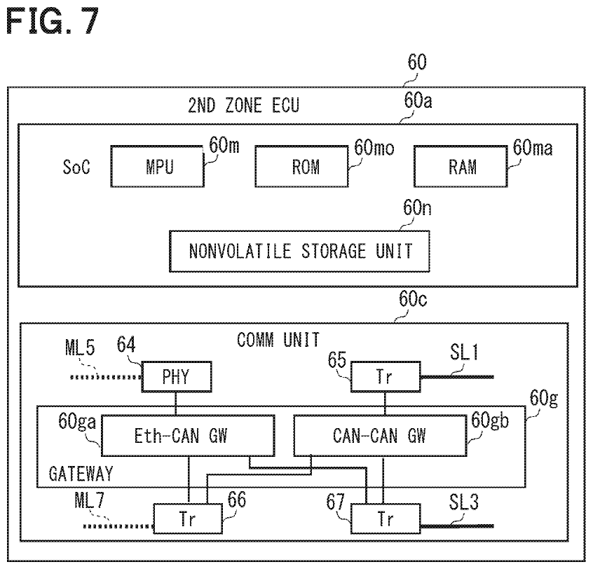

The second zone ECU 60 is, for example, an ECU that manages all of the ECUs in the rear division of the vehicle. As shown in FIG. 7, the second zone ECU 60 includes a SoC 60a as a second zone control device and further includes a second zone communication unit 60c. The SoC 60a is a device that performs various calculation processes and other processing related to operation of the second zone ECU 60 and includes, for example, a MPU 60m, a RAM 60ma, a ROM 60mo, and a second zone nonvolatile storage unit 60n.

Various functions of SoC 60a are implemented by the MPU 60m executing a program stored in a non-transitory tangible storage medium. The non-transitory tangible storage medium is, for example, the ROM 60mo or the second zone nonvolatile storage unit 60n. When the program is executed by the MPU 60m, a method corresponding to the program is executed. In the present embodiment, when a stop activation control program is executed by the MPU 60m, a method corresponding to the stop activation control program for the electronic control unit is executed. The number of microcontrollers constituting the second zone control unit of the second zone ECU 60 may be one or more. A method of implementing the various functions of the first zone control unit of the second zone ECU 60 is not limited to software, and part or all of elements of the various functions may be implemented by using one or more hardware pieces. For example, when the above function is implemented by a hardware communication circuit, the communication circuit may be a digital circuit including many logic circuits, or an analog circuit, or a combination of the digital circuit and the analog circuit.

The second zone nonvolatile storage unit 60n is, for example, a nonvolatile memory, such as a flash memory, an EEPROM, etc., that can be rewritten with various data. The second zone communication unit 60c includes a gateway 60g, a PHY 64, and communication circuits 65 to 67. The PHY 64 performs data communication with the mobility computer 10 via the main communication line ML5. The communication circuit 65 performs data communication with the battery ECU 20 and the first zone ECU 50 via the redundant communication line SL1. The communication circuit 66 performs data communication with the end ECUs 81 to 83 via the main communication line ML7. The communication circuit 67 performs data communication with the end ECU 83 via the redundant communication line SL3.

FIG. 1B illustrates the communication circuits 86, 87 built into the twenty-third end ECU 83. The communication circuit 86, 87 includes a transceiver capable of communicating based on the CAN standards. The communication circuit 66 performs data communication with the communication circuit 86 of the twenty-third end ECU 83. The communication circuit 67 performs data communication with communication circuit 87 of the twenty-third end ECU 83 via the redundant communication line SL3. The gateway 60g has a function (Eth-CAN gateway 60ga) of switching over the communication line being the relay destination and the transmission destination for the communication frames of the PHY 64 and the communication circuits 65 to 67, as well as a function of protocol conversion between the Ethernet standards and the CAN standards. The gateway 60 g has a gateway function (CAN-CAN gateway 60gb) that switches over the communication line being the relay destination and the transmission destination for the communication frames of the communication circuits 65 to 67.

### Communication Between the First, Second Ethernet Switches 12a, 13a and the PHYs 21, 31, 41, 54, 64

The first Ethernet switch 12a of the mobility computer 10 and the PHY21 of the battery ECU 20 communicate with each other through the main communication line ML1 based on the automotive Ethernet standards. The frame of the automotive Ethernet includes address information of the source and address information of the destination. This address information is not included in the CAN frame. In the automotive Ethernet frame, data for CAN-ID generation is embedded in a beginning part of a payload being a data area. As described below, when the zone ECU 50, 60 relays the frame to another end ECU 71 to 73, 81 to 83, the zone ECU 50, 60 references to the data for CAN-ID generation.

Similarly, the first Ethernet switch 12a of the mobility computer 10 and the PHY31 of the first PNB ECU 30 communicate with other through the main communication line ML2 based on the automotive Ethernet standards. The second Ethernet switch 13a of the mobility computer 10 and the PHY41 of the second PNB ECU 40 communicate with each other through the main communication line ML3 based on the automotive Ethernet standards. The first Ethernet switch 12a of the mobility computer 10 and the PHY 54 of the first zone ECU 50 communicate with each other through the main communication line ML4 based on the automotive Ethernet standards. The second Ethernet switch 13a of the mobility computer 10 and the PHY 64 of the second zone ECU 60 communicate with each other through the main communication line ML5 based on the automotive Ethernet standards. The PHYs 21, 31, 41, 54, 64 are communication circuits that primarily perform Layer I (physical layer) functions but may also have part or all of the Layer II functions. The SoC 11 of the mobility computer 10 uses the mobility computer communication unit 12, 13 to perform routing on the main communication route and the redundant route to execute individual communication processes individually with other ECUs.

The “main communication route” in the present disclosure is a route for mainly communicating the main message. The main communication route allows main messages to be communicated between the mobility computer 10 and another ECU (20, 50, 60, 71 to 73, 81 to 83) and includes the main communication line ML connecting the mobility computer 10 or a third zone ECU 90 to another ECU (20, 50, 60, 71 to 73, 81 to 83). The “redundant route” in the present disclosure is a route for communicating main messages or redundant messages. One or more redundant routes may include a redundant communication line SL being a communication route connecting between target devices, wherein the target device may be between at least two or more of: the mobility computer 10 and other ECUs (20, 50, 60, 71 to 73, 81 to 83).

Basic power supplying and communication functions are configured as described above. The mobility computer 10 and the battery ECU 20 are always supplied with power from the battery. In normal use, the mobility computer 10 is always supplied with power from the battery through the battery ECU 20. In this case, the mobility computer 10 and the battery ECU 20 keep the wake-up state. A management table is stored in the mobility computer nonvolatile storage unit 11 n or the RAM 11ma of the mobility computer 10.

In normal use of the vehicle, each of the first PNB ECU 30, the second PNB ECU 40, the first zone ECU 50, and the second zone ECU 60 operates and changes the vehicle power state to the power-off state, the sleep state, and the wake-up state. The management table retains the vehicle power states of these ECUs 30, 40, 50, 60. The mobility computer 10 manages the vehicle power states of the first PNB ECU 30, the second PNB ECU 40, the first zone ECU 50, and the second zone ECU 60 via the function of the power management 11c by retaining and changing the data in the management table. The mobility computer 10 broadcasts the message for the vehicle power state to all of the ECUs (20, 30, 40, 50, 60, 71 to 73, 81 to 83) as shown below. The message for the vehicle power state is a message included in messages common in a single vehicle.

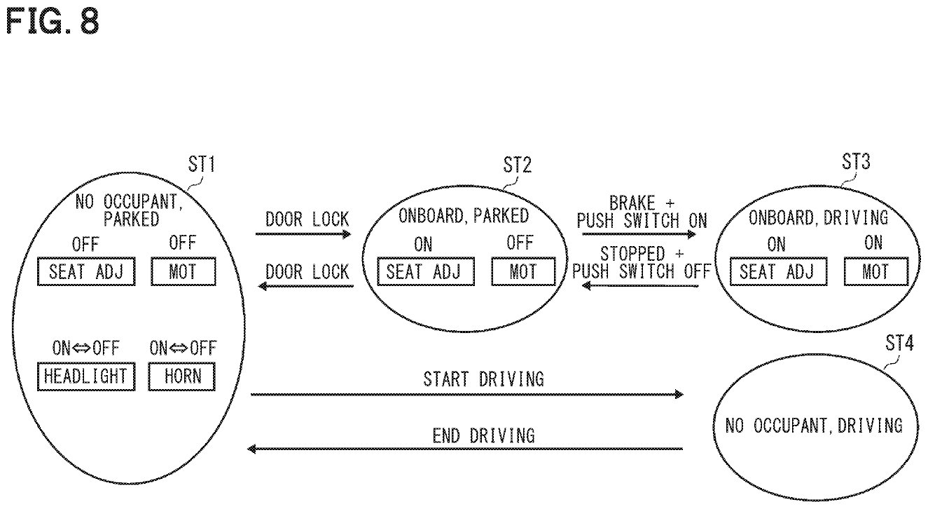

The status of the vehicle is illustrated in FIG. 8. As an occupant repeatedly gets in/out of the vehicle or drives/parks the vehicle, the status changes from and to a status T1 representing “no-occupant, parked”, a status ST2 representing “onboard, parked”, a status ST3 representing “onboard, driving”, and a ST4 representing “no occupant, driving” in the form illustrated in FIG. 8. The mobility computer 10 in the vehicle can perform detection by an on/off combination of a door lock sensor, a brake sensor, and a push switch (power button) (none of which are shown in the drawings), and can use a vehicle speed sensor and a position detection sensor to determine if the vehicle is parked/running. The presence or absence of an occupant onboard may be detected by an occupant sensor such as a DSM (driver status monitor).

The mobility computer 10 keeps or switches over the vehicle power state of each ECU (50, 60, 71 to 73, 81 to 83) according to state transition. The state transition is, for example, status change from ST1 to ST2, from ST2 to ST3, from ST3 to ST2, from ST2 to ST1, from ST1 to ST4, and from ST4 to ST1.

In normal time, the mobility computer 10 sends the main message for the vehicle power state to each ECU 30, 40, 50, 60 through the main communication line ML1 to ML7, and the zone ECU 50, 60 relays the main message for the vehicle power state to the end ECUs 71 to 73, 81 to 83.

However, the communication through the main communication line ML may be cut off. A first cause is some external noise that makes it impossible to communicate the main message through the main communication line. A second cause is a physical damage of the main communication line ML. A third cause is hardware or other defects of the first Ethernet switch 12a (or second Ethernet switch 13a). In such cases, even if a defect occurs in the main communication line ML connecting between ECUs based on the communication architecture and topology, the redundant route using at least in part the redundant communication line SL may be used for the redundant message to be communicable.

An object of the redundant communication line SL is, for example, to deliver the message for the vehicle power state to the high voltage system ECU mainly in a case where one communication route is lost at a time of stop of the high voltage system. For this reason, the redundant message for the vehicle power state may be broadcasted. In this case, it may be preferable to periodically send the redundant message all the time.

The contents of the redundant message will be schematically described.

### On Redundant Message Communicated Through Redundant Communication Line SL

Examples of the redundant message communicated through the redundant communication line SL include a message for the vehicle power state, a message for a stop preparation request, a message for a power control request, and an NM message included in an NM frame.

In order to keep or change each status inside or outside the vehicle, it may be preferable to always send the redundant message for the vehicle power state from the mobility computer 10 or another device to each ECU. The stop preparation request is a message for causing each ECU to perform a preparation process before stopping, for example, at a time of stop of the high voltage system. In the vehicle, there is an ECU that starts the stop process in response to the stop preparation request. In other words, the stop preparation request triggers start of the stop process at the ECU. For this reason, it may be preferable to send the redundant message for a stop preparation request to each ECU from the mobility computer 10 or another device. The power control request indicates a request to control power-on or power-off of each ECU. Because wrong power controlling of the power of each ECU increases risk, it may be preferable to send the redundant message for the power control request to each ECU from the mobility computer 10 or another device. The NM message indicates a message constituting data of the NM frame generated by the mobility computer 10. When waking up the ECU in the sleep mode, the mobility computer 10 sends the NM frame in which the activation information designating the active group is included in the NM message. For this reason, it may be preferable to send the NM message of the NM frame from the mobility computer 10 or another device to each ECU.

The sequence for each ECU to be kept active even in the event of communication abnormality will be described below.

### Active-Keeping Sequence (Message Communication for Vehicle Power state)

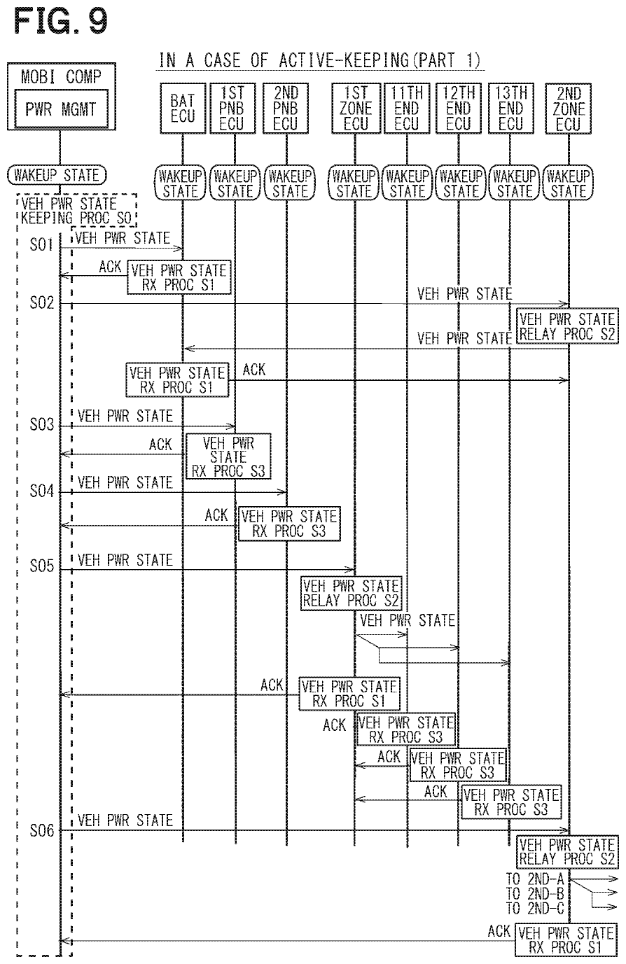

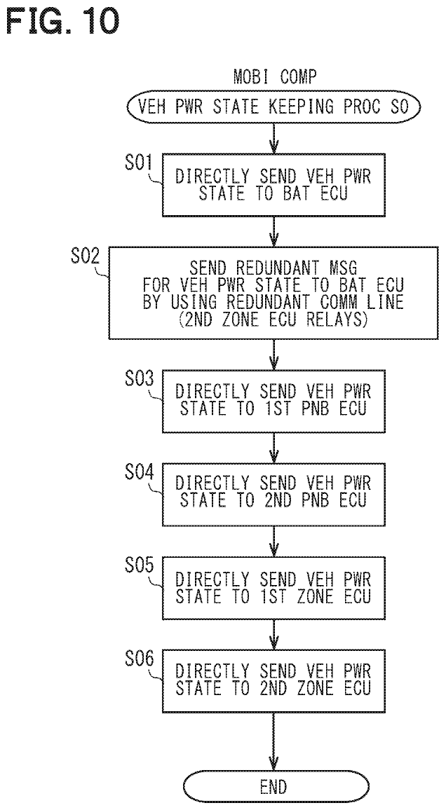

An example of an active-keeping sequence is shown in FIG. 9. It is assumed that the vehicle power state of each ECU 30, 40, 50, 60 is the wake-up state. In the normal time, the mobility computer 10 executes a vehicle power state keeping process S0 shown in FIG. 9 and FIG. 10.

In the vehicle power state keeping process S0 in FIG. 10, the mobility computer 10 sends the main message for the vehicle power state directly from the first Ethernet switch 12a to the battery ECU 20 through the main communication line ML1 (S01). The mobility computer 10 then sends the redundant message for the vehicle power state to the battery ECU 20 by using the redundant communication line SL1 (S02). In this case, the second zone ECU 60 may relay the redundant message.

The mobility computer 10 sends the main message for the vehicle power state to the first PNB ECU 30 through the main communication line ML2 (S03). The mobility computer 10 sends the main message for the vehicle power state to the second PNB ECU 40 through the main communication line ML3 (S04). The mobility computer 10 sends the main message for the vehicle power state to the first zone ECU 50 through the main communication line ML4 (S05). The mobility computer 10 sends the main message for the vehicle power state to the second zone ECU 60 through the main communication line ML5 (S06).

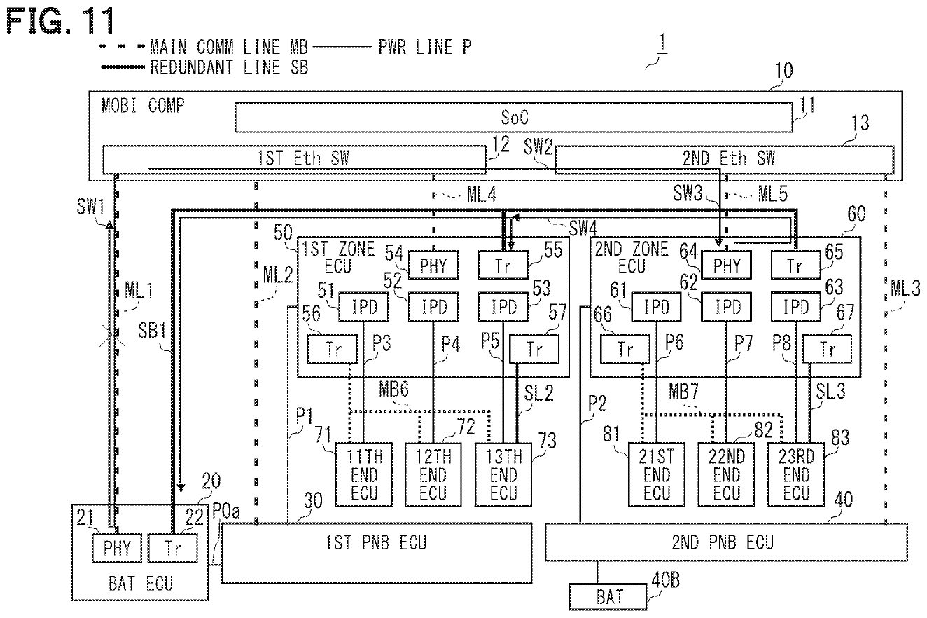

The following describes a reason why the mobility computer 10 sends the redundant message for the vehicle power state to the battery ECU 20 as in S02. For example, FIG. 11 shows the communication route SW1 to SW4 of the message for each communication order. It is considered that the first Ethernet switch 12a of the mobility computer 10 sends the main message for the vehicle power state through the main communication line ML1, but the message is sent back without reaching the destination address. In this case, the first Ethernet switch 12a of the mobility computer 10 determines that the main communication line ML1 extending to the battery ECU 20 is in communication cutoff (cutoff of the communication route SW1). The first Ethernet switch 12a in the mobility computer 10 duplicates the main message to generate the redundant message and sends the redundant message to the second Ethernet switch 13a. The second Ethernet switch 13a receives the redundant message from the first Ethernet switch 12a and sends the redundant message to the second zone ECU 60 through the main communication line ML5 (communications through communication routes SW2 and SW3).

In the second zone ECU 60, when the PHY 64 receives the redundant message, the gateway 60g performs protocol conversion on the redundant message, and the communication circuit 65 sends the redundant message to the battery ECU 20 and the first zone ECU 50 through redundancy communication line SL1 (communication through the communication route SW3). This allows both the first zone ECU 50 and the battery ECU 20 to receive the redundant message.

In the mobility computer 10 including multiple Ethernet switches 12a 13a, the message is sent from the second Ethernet switch 13a separate from the first Ethernet switch 12a being main. This allows the redundant message to be sent to the battery ECU 20 (or the first zone ECU 50) even if any of the first to third causes above makes it impossible for the mobility computer communication unit 12 to communicate through the main communication line ML4.

### Vehicle Power State Receiving Process

As shown in FIG. 9, when the mobility computer 10 sends the main message for the vehicle power state to the battery ECU 20, the first zone ECU 50 and the second zone ECU 60 in S01, S03, S05, the respective ECU 20, 50, 60 executes a vehicle power state message receiving process S1.

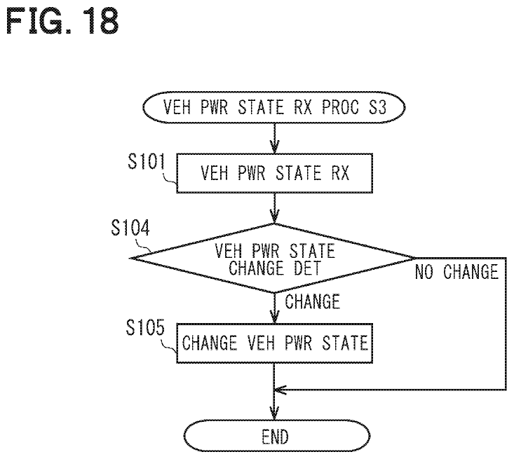

When the mobility computer 10 sends the main message for the vehicle power state to the first PNB ECU 30 in S03, the first PNB ECU 30 executes a vehicle power state message receiving process S3. When the mobility computer 10 sends the main message for the vehicle power state to the second PNB ECU 40 in S04, the second PNB ECU 40 executes the vehicle power state message receiving process S3. The message receiving process S3 will be described later (see FIG. 18), which includes a message determination process without message arbitration.

### On Message Receiving Process S1

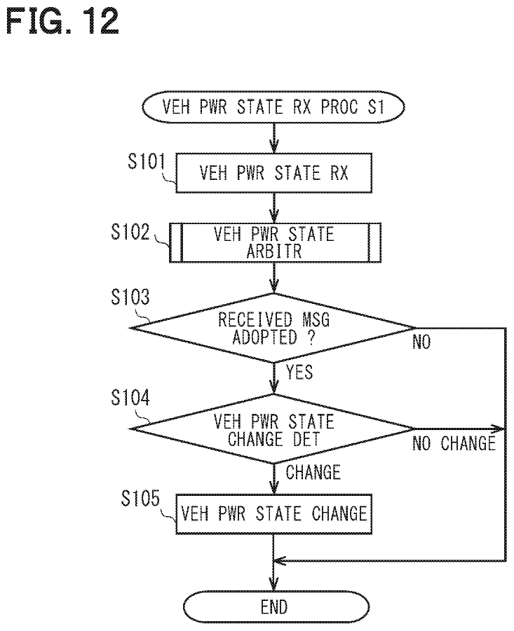

The message receiving process S1 shown in FIG. 12 includes a process of arbitrating messages. Upon receiving the message for the vehicle power state (S101), each ECU 20, 50, 60 executes the arbitration process on the message for the vehicle power state (S102).

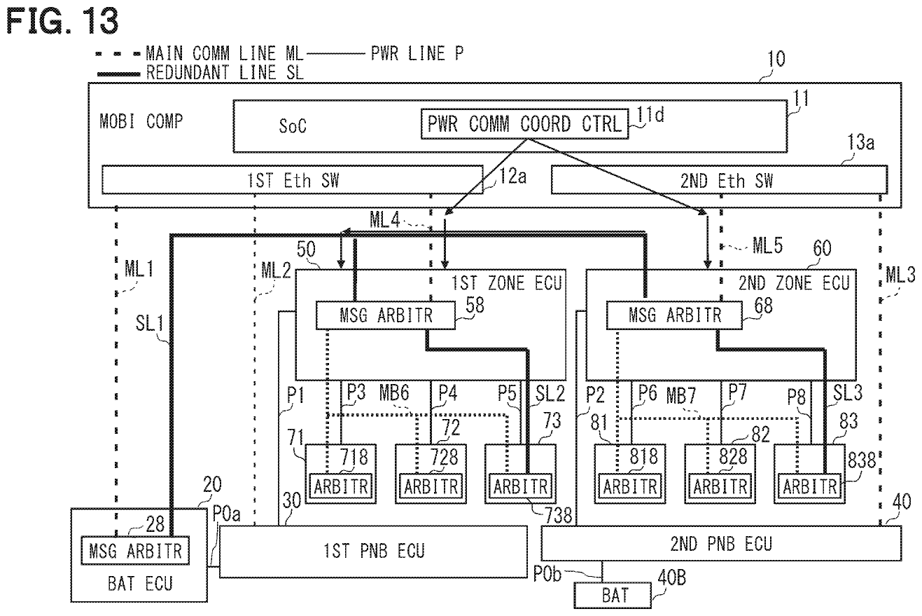

The message arbitration in S102 is illustrated in FIG. 13. In the example shown in FIG. 13, the ECUs 20, 50, and 60, respectively, include message arbitration units 28, 58, and 68 that arbitrate two or more messages among the main messages and one or more redundant messages. The end ECUs 71, 72, and 73, respectively, include message arbitration units 718, 728, and 738. The end ECUs 81, 82, and 83, respectively, include message arbitration units 818, 828, and 838. Functions of ECUs 20, 50, 60 will be described below.

### Vehicle Power State Message Arbitration and Cutoff Determination

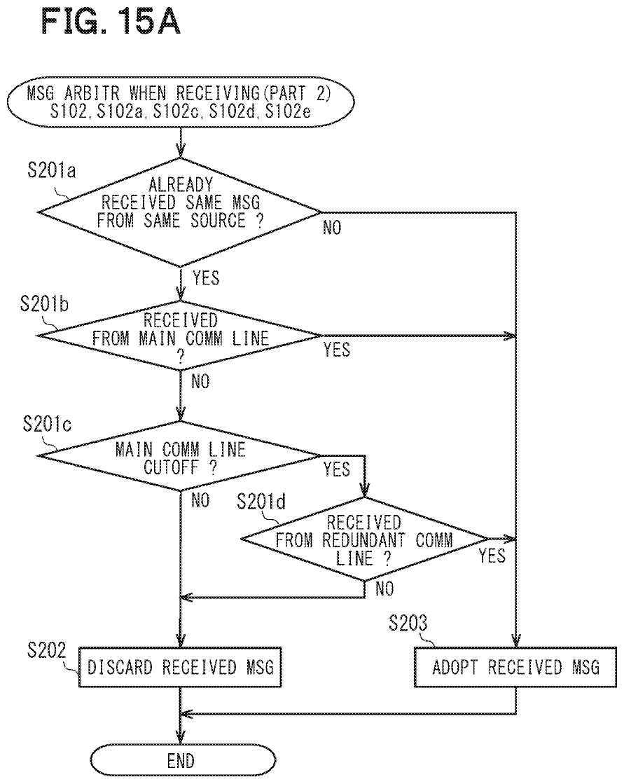

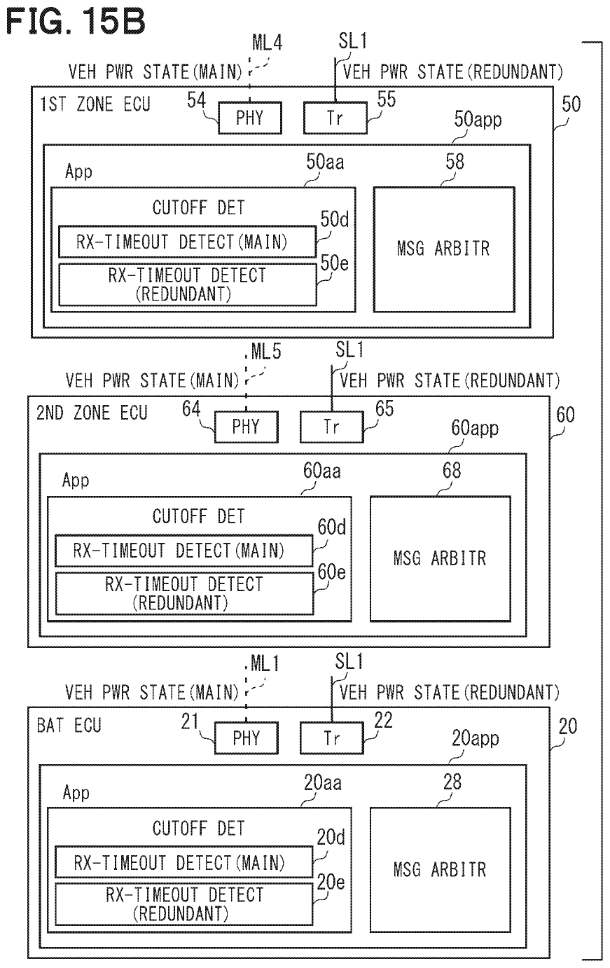

FIG. 15B shows a vehicle power state message processing function built into the ECU 20, 50, 60. The second zone ECU 60 and the battery ECU 20 as well as the first zone ECU 50 have similar functions. As shown in FIG. 15B, the first zone ECU 50 may use a cutoff determination application 50aa to determine the cutoff of the main communication line ML and the cutoff of the redundant communication line SL. The cutoff determination application 50aa may use a function of reception timeout detection 50d, 50e, which counts a communication time and detects whether or not a timeout time has been reached. A function of reception timeout detection 50d includes a function of determining the cutoff of the main communication line ML. A function of reception timeout detection 50e includes a function of determining the cutoff of the redundant communication line SL. If the function of the reception timeout detection 50d determines that the main communication line ML4 is cut off, the first zone ECU 50 switches over to the redundant communication line SL1 determined as not cut off to send the messages for communication from now on to the mobility computer 10 by using the second zone ECU 60 as a relay ECU. If the function of the reception timeout detection 50e determines that the redundant communication line SL1 is cut off, the first zone ECU50 switches over to the main communication line ML4 determined as not cut off to send the message for communication from now on to the mobility computer 10. Although the cutoff determination has been described for the message for the vehicle power state, the same is applicable to the stop preparation request, the stop preparation completion notification, the power control request at a time of stop or activation, the power control completion notifications at a time of stop or activation, and the NM message described later.

The second zone ECU 60 may use a cutoff determination application 60aa to determine the cutoff of the main communication line ML and the cutoff of the redundant communication line SL. The cutoff determination application 60aa may use a function of reception timeout detection 60d, 60e, which counts a communication time and detects whether a timeout time has been reached or not. The function of the reception timeout detection 60d includes a function of determining the cutoff of the main communication line ML. The function of the reception timeout detection 60e includes a function of determining the cutoff of the redundant communication line SL. If the function of the reception timeout detection 60d determines that the main communication line ML5 is cut off, the second zone ECU 60 switches over to the redundant communication line SL1 determined as not cut off to send the message for communication from now on to the mobility computer 10 by using the first zone ECU 50 as a relay ECU. If the function of the reception timeout detection 60e determines that the redundant communication line SL1 is cut off, the second zone ECU 60 switches over to the main communication line ML5 determined as not cut off to send the message for communication from now on to the mobility computer 10. Although the cutoff determination has been described for the message for the vehicle power state, the same is applicable to the stop preparation request, the stop preparation completion notification, the power control request at a time of stop or activation, the power control completion notification at a time of stop or activation, and the NM message described later.

The battery ECU 20 may use a cutoff determination application 20aa to determine the cutoff of the main communication line ML and the cutoff of the redundant communication line SL. The cutoff determination application 20aa may use a function of reception timeout detection 20d and 20e, which counts a communication time and detects whether a timeout time has been reached or not. The function of the reception timeout detection 20d includes a function of determining the cutoff of the main communication line ML. The function of the reception timeout detection 20e includes a function of determining the cutoff of the redundant communication line SL. If the function of the reception timeout detection 20d determines that the main communication line ML1 is cut off, the battery ECU 20 switches over to the redundant communication line SL1 determined as not cut off to send the message for communication from now on to the mobility computer 10 by using the first zone ECU 50 or the second zone ECU 60 as a relay ECU. If the function of the reception timeout detection 20e determines that the redundant communication line SL1 is cut off, the battery ECU 20 switches over to the main communication line ML1 determined as not cut off to send the message for communication from now on to the mobility computer 10. Although the description has been given for the message for the vehicle power state, the same is applicable to the stop preparation request, the stop preparation completion notification, the power control request at a time of stop or activation, the power control completion notification at a time of stop or activation, and the NM message described later.

### Message Arbitration Method

A message arbitration method at a time of message reception and relay will be described. Although description will be given on the message for the vehicle power state, the same is applicable to other messages including a message for stop preparation request, a message for power control request at a time of stop/activation as described below, as well as a message for completion notifications (stop preparation completion notification, and power control completion notification at a time of stop/activation). Any of the following several methods is applicable to the message arbitration.

A function of the message arbitration unit 28, 58, 68 of the ECU 20, 50, and 60 will be described as a representative, but the same is applicable to the processing of the message arbitration unit 718, 728, 738, 818, 828, 838.

### Message Arbitration at a Time of Receipt (Part 1)

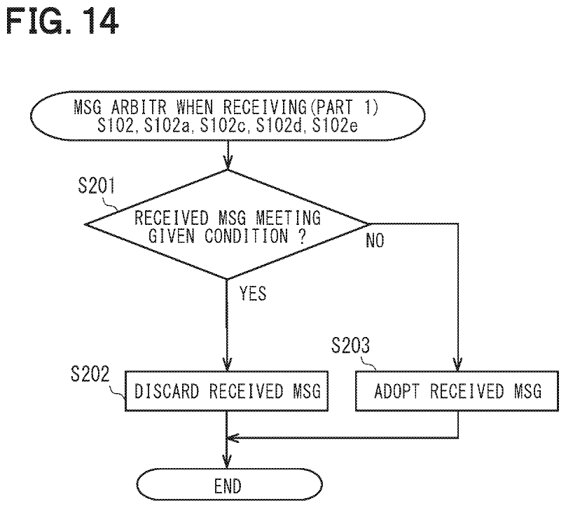

As shown in FIG. 14, each ECU 20, 50, 60 sequentially spools past received messages and determines whether or not a message meeting a given condition has been received (S201). For example, as the given condition in S201, the ECU 20, 50, 60 may use such a condition that the same message has already been received from the same source (S201a: see FIG. 15A). If this condition is met, the message received this time may be discarded (S202) and the message already received may be adopted.

### Message Arbitration at a Time of Receipt (Part 2)

Another example is as follows. The given condition in S201 of FIG. 14 may include receipt from a communication line meeting a certain condition (in this case, the main communication line ML). The message arbitration unit 28, 58, 68 may determine from which communication line among the main communication line ML and the redundant communication line SL the message has been received. As shown specifically in FIG. 15A, the ECUs 20, 50, 60 determines whether or not the message has been received through the main communication line ML (S201b). If the message has been received through the main communication line ML, the ECUs 20, 50, 60 adopts this received message (S203). The ECU 20, 50, 60 adopts the received message on the condition that: the main communication line ML has already been determined as cut off (YES in S201c): and the received message is from the redundant communication line SL (S203). The ECU 20, 50, 60 discards the received message (S202) if the main communication line ML is not determined as cut off in S201c, or the received message is not from the redundant communication line SL in S201d.

In other words, as long as the main communication line ML is not cut off, the message received from the main communication line ML is preferentially adopted (S203) even when the redundant communication line SL is not cut off. In this case, the message received from the redundant communication line SL may be spooled to an internal memory and retained until the same message is received from the main communication line ML, and the message may be discarded upon elapse of a certain time (S202).

In this example, although the message received from the main communication line ML is basically adopted, the redundant message received from the redundant communication line SL may be adopted on condition that the main communication line ML has been determined as cut off. After detecting the cutoff of the main communication line ML, the message received through the redundant communication line SL may be adopted.

### Message Arbitration at a Time of Receipt (Part 3)

Yet another example will be described. The message arbitration unit 28, 58, and 68 may arbitrate which of the main message and the redundant messages is to be adopted. In this case, as the given condition of S201 in FIG. 14, the message arbitration units 28, 58, and 68 may determine whether the received message is the main message or the redundant message to adopt the main message with higher priority than the redundant message (S203). The redundant message received earlier may be spooled to an internal memory and retained until the main message having the same message is received. The redundant message may be discarded upon receipt of a certain time (S202).

If both the main message and the redundant message are received, the message arbitration units 28, 58, 68 may adopt the earlier received message among the main message and the redundant message (S203).

### Message Arbitration at a Time of Receipt (Part 4)

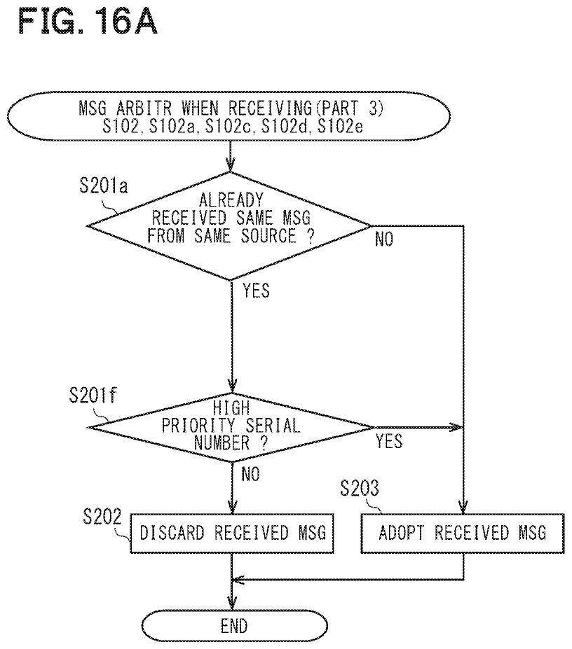

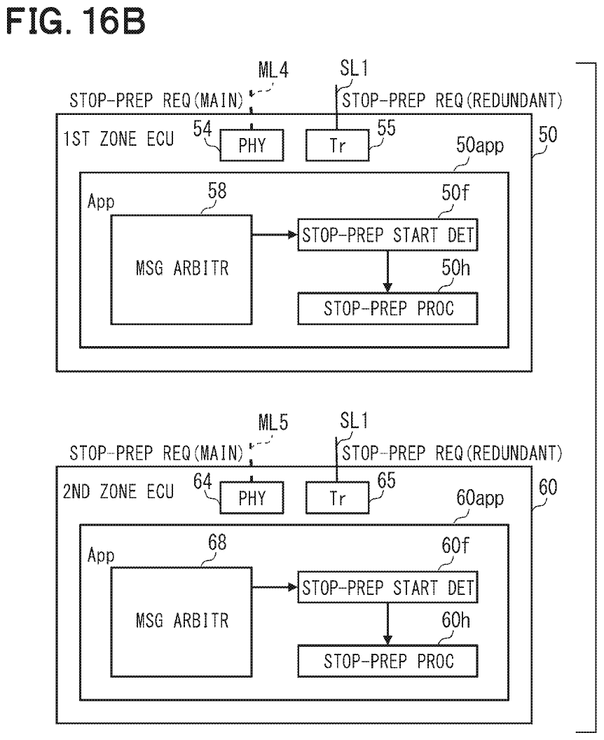

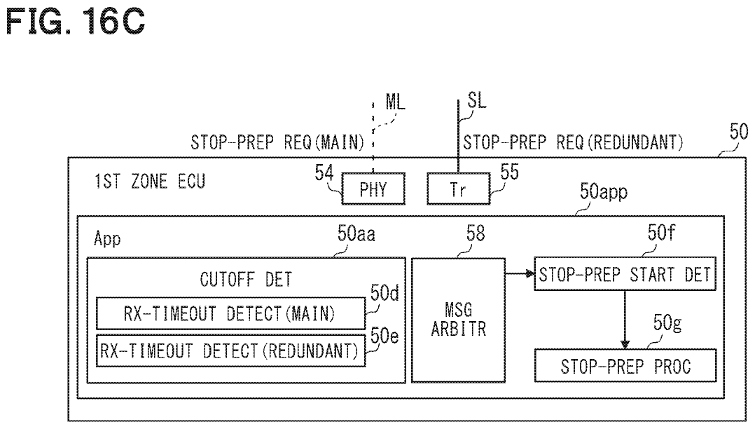

A serial number may be assigned to a data frame configuring the message. As shown in FIG. 16A, each ECU 20, 50, 60 first determines whether the same message from the same source has been already received (S201a). If the same message has been received, the ECU 20, 50, 60 reads the serial numbers assigned to the data frames.

The ECU 20, 50, 60 adopts the received message if its serial number has a higher priority (S201f), in this case if the serial number assigned to the received frame is larger than the serial number assigned to the message in the previously received frame (S203). If the condition of S201f is not met, the received message is discarded (S202). In other words, an application 20app, 50app, 60app of the ECU 20, 50, 60 having received the message may adopt the message by accepting only the frame having the serial number larger than the previously received frame. The frame having the same or smaller serial number may be discarded as a delayed frame.

### On Acknowledgement ACK

The message arbitration unit 28, 58, 68 sends an acknowledgement ACK only for the message adopted in S203 above. An acknowledgement ACK may be sent for any received message, regardless of whether the message is adopted (S202) or discarded (S203). In this case, an acknowledgement ACK may be sent at the time when the content of the message is recognized.

### Specific examples of vehicle power states and stop preparation processes

When each ECU 20, 50, 60 receives a delayed message for the vehicle power state in S201a while performing the stop preparation process based on the earlier received message, the ECU 20, 50, 60 discards the delayed message and continues performing the stop preparation process. When each ECU 20, 50, 60 receives a delayed message while performing a process of stop preparation completion, the ECU 20, 50, 60 discards the delayed message. Via receiving the message from the redundant communication line SL, it is possible to determine and change whether the stop preparation process has started.

After executing the arbitration process on the message for the vehicle power state in S102, the ECU 20, 50, 60 determines whether or not the received message has been adopted (S103), as shown in FIG. 12. When the message received this time has not been adopted, the flow is ended. When the message received this time message has been adopted (YES in S103), the ECU 20, 50, 60 determines whether it is necessary for the ECU 20, 50, 60 to change the vehicle power state thereof following the message for the vehicle power state (S104). If necessary, the ECU 20, 50, 60 change the vehicle power state thereof (S105).

Arbitrating the messages in this way can prevent an occurrence of a situation where the processing by the ECU (receiver side) on the messages sent from the mobility computer 10 in a case of changing the status from “onboard” to “parked” is performed in an order different from the sending order. For example, it is possible to prevent such a glitch that the ECU 20, 50, 60 being a receiver accepts a main message and transitions to “onboard,” thereafter accepts another main message and transitions to “parked,” thereafter accepts a redundant message and transitions again to “onboard” and thereafter accepts another redundant message and transitions to “parked”.

Next, the message relaying process S2 will be described.

### Message Relaying Process

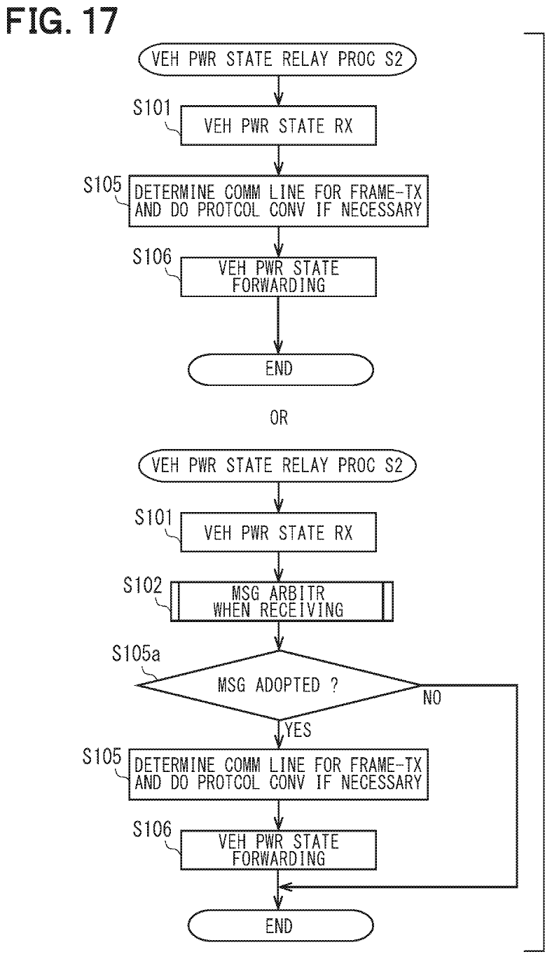

As shown in FIG. 9, when the mobility computer 10 sends the message for the vehicle power state to the zone ECUs 50 and 60 (S05 and S06), the zone ECUs 50 and 60 receive the message for the vehicle power state (S1). As shown in FIG. 9, the zone ECU 50, 60 executes the message relaying process S2 for the vehicle power state prior to the message receiving process S1. The message relaying process S2 shown in FIG. 17 includes a process of forwarding the main message or the redundant message to another ECU.

In the message relaying process S2, as shown in the upper part of FIG. 17, when the zone ECU 50, 60 receives the main message for the vehicle power state (S101), the zone ECU 50, 60 determines the communication line to which the frame is to be sent out and performs protocol conversion if necessary (S105). When relaying the message, the message arbitration unit 58, 68 arbitrates to which communication line the message is to be forwarded among the main communication line ML and the redundant communication line SL. To do so, the zone ECU 50, 60 determines the communication line by referencing to contents of the communication frame of the Ethernet switch 12a, 13a. A detailed method is described in, for example, in JP2018-125601. The Zone ECU 50, 60 receives an Ethernet communication frame from the Ethernet switch 12a, 13a of the mobility computer 10. In the received Ethernet communication frame, the data for CAN-ID generation is embedded in the beginning part of the payload being the data area. The Zone ECU 50, 60 determine to which communication line the message is to be relayed, based on the data for CAN-ID generation set by the mobility computer 10. In the present embodiment, the zone ECU 50 determines to relay to the main communication line ML6 for CAN communication and the zone ECU 60 determines to relay to the main communication line ML7 for CAN communication.

The communication circuit 56, 66 then forwards the main message to the end ECU 71 to 73, 81 to 83 through the main communication line ML6, ML7 (S106). Each end ECU 71 to 73, 81 to 83 performs the message receiving process S3 for the vehicle power state. As shown in the lower part of FIG. 17, at message relaying, the message may be forwarded on condition that the arbitration unit 58, 68 has executed the message arbitration S102 and has adopted the message.

### Message Receiving Process S3

The message receiving process S3 is executed not only by the end ECU 71 to 73, 81 to 83, but also by the first PNB ECU 30 and the second PNB ECU 40. In the message receiving process S3, as shown in FIG. 18, when the end ECU 71 to 73, 81 to 83 receives the main message for the vehicle power state, the end ECU 71 to 73, 81 to 83 reads the message for the vehicle power state and determines if it is necessary to change the vehicle power state thereof (S104). The ECU 20, 50, 60 then change the vehicle power state thereof (i.e., the vehicle power state that is set to the ECU 20, 50, 60) if necessary (S105).

When the communication is performed successfully, the main or redundant message for the vehicle power state is successfully sent to all the ECUs 20, 30, 40, 50, 60, 71 to 73. However, as mentioned above, in view of a possibility that the message is not successfully conveyed to all of the ECUs due to partial cutoff of the main communication line ML, etc., the mobility computer 10 sends the redundant message for the vehicle power state through a separate redundancy route.

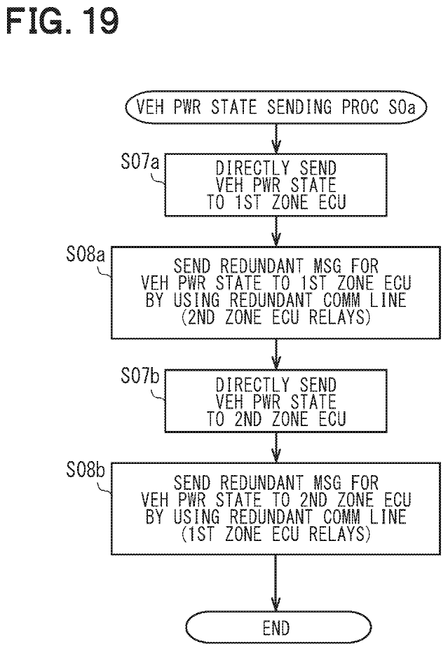

The mobility computer 10 next executes the vehicle power state sending process S0a shown in FIG. 19. In this vehicle power state sending process S0a shown in FIG. 19, the mobility computer 10 sends the message for the vehicle power state directly to the first zone ECU 50 as the redundant message through the main communication line ML4 (S07a). In addition, the mobility computer 10 sends the redundant message for the vehicle power state to the first zone ECU 50 by using the redundant communication line SL1 (S08a). It may be preferable that the second zone ECU 60 relay the redundant message.

Furthermore, the mobility computer 10 executes a process in which the role of the first zone ECU 50 and the role of the second zone ECU 60 are exchanged. The mobility computer 10 sends the message for the vehicle power state directly to the second zone ECU 60 as the redundant message through the main communication line ML5 (S07b). In addition, the mobility computer 10 sends the redundant message for the vehicle power state to the second zone ECU 60 by using the redundant communication line SL1 (S08b). Here, it may be preferable that the first zone ECU 50 relay the redundant message.

### Specific Examples of Process S07a, S08a

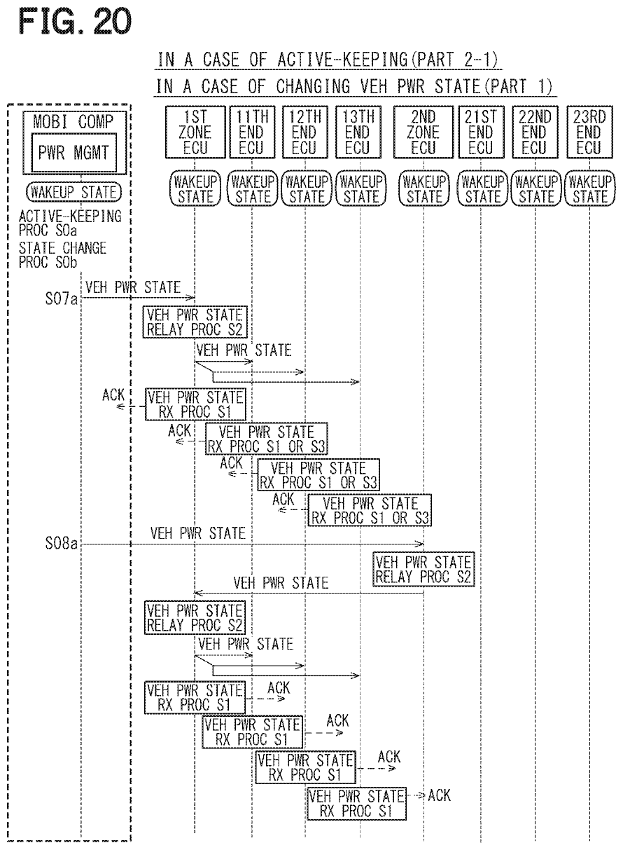

As shown in the upper part of FIG. 20, the mobility computer 10 sends the redundant message for the vehicle power state to the first zone ECU 50 (S07a). The first zone ECU 50 executes the message relaying process S2 for the vehicle power state and thereafter executes the message receiving process S1. In the message relaying process S2, the PHY 54 receives the message, the gateway 50g converts the protocol, and the communication circuit 56 forwards the redundant message to the end ECU 71 to 73. In the message receiving process S1, the first zone ECU 50 performs the message arbitration S102 (see FIG. 14 to FIG. 16C) and sets the vehicle power state thereof based on the message (S104 and S105 in FIG. 12) upon adopting the message (S203 in FIG. 14 to FIG. 16).

As shown in the upper part of FIG. 20, the end ECU 71 to 72 executes the message receiving process S1 or S3 depending on reception status. If the end ECU 71 to 72 receives the main message for the vehicle power state earlier and receives the redundant message for the vehicle power state this time, the end ECU 71 to 72 executes the arbitration between the main message and the redundant message (message receiving process S1). If the end ECU 71 to 72 has not received the main message earlier, the end ECU 71 to 72 does not execute arbitration this time but only performs the message receiving process S3 even when the end ECU 71 to 72 receives the redundant message for the vehicle power state.

Next, as shown in the lower part of FIG. 20, the mobility computer 10 sends the redundant message for the vehicle power state to the first zone ECU 50 by using the second zone ECU 60 as the relay ECU (S08a). The second zone ECU 60 executes the message relaying process S2 for the redundant message for the vehicle power state. In the message relaying process S2, when the PHY 64 receives the redundant message, the gateway 60g switches over the destination and performs the protocol conversion, and the communication circuit 65 forwards the redundant message to the first zone ECU 50 through the redundant communication line SL1.

When the first zone ECU 50 receives the redundant message from the second zone ECU 60 through the communication circuit 55, the first zone ECU 50 executes the message relaying process S2 and thereafter executes the message receiving process S1. In the message relaying process S2, the communication circuit 56 forwards the redundant message, which is received from communication circuit 55, to the end ECU 71 to 73 through main communication line ML6. When the first zone ECU 50 executes the message arbitration S102 (see FIG. 14 to FIG. 16C) in the message receiving process S1 and adopts the message (S203 in FIG. 14 to FIG. 16A), the first zone ECU 50 sets the vehicle power state thereof based on the message (S104 and S105 in FIG. 12).

As shown in the lower part of FIG. 20, the end ECU 71 to 73 executes the message receiving process S1 according to the reception status. If the end ECU 71 to 72 receives the main message for the vehicle power state earlier and receives the redundant message for the vehicle power state this time, the end ECU 71 to 72 executes the arbitration between the main message and the redundant message (the message receiving process S1).

### Specific Example of Process S07b, S08b

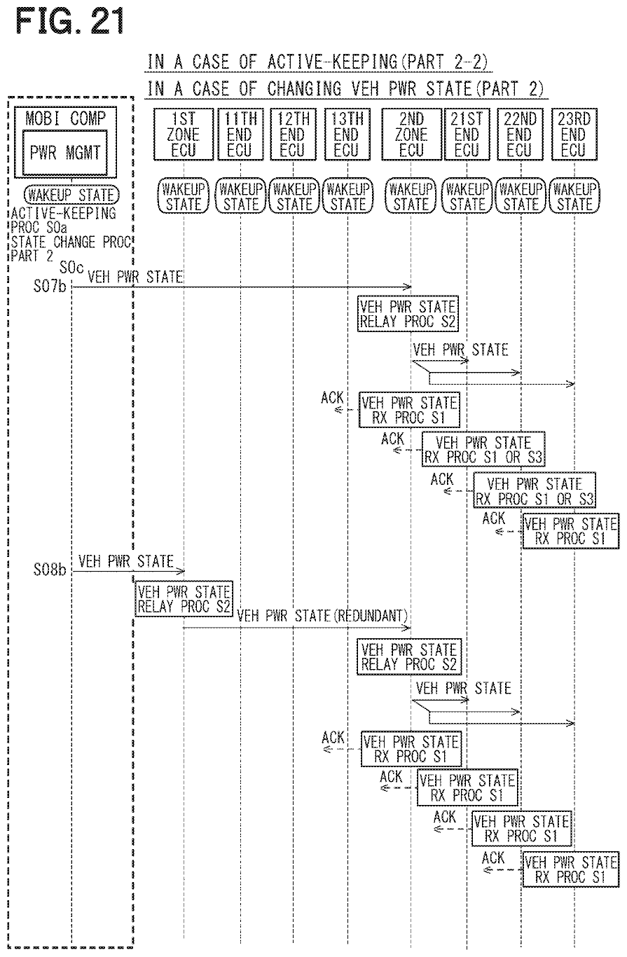

The process is then executed in which the role is exchanged between the first zone ECU 50 and the second zone ECU 60. As shown in the upper part of FIG. 21, the mobility computer 10 sends the redundant message for the vehicle power state to the second zone ECU 60 (S07b). The second zone ECU 60 executes the message relaying process S2 for the vehicle power state and thereafter executes the message receiving process S1. In the message relaying process S2, the PHY 64 receives the message, the gateway 50g switches over the destination connection and performs the protocol conversion, and the communication circuit 66 forwards the redundant message to the end ECU 81 to 83. In the message receiving process S1, when the second zone ECU 60 executes the message arbitration S102 (see FIG. 14 to FIG. 16C) and adopts the message (S203 in FIG. 14 to FIG. 16A), the second zone ECU 60 sets the vehicle power state thereof based on that message (S104 and S105 in FIG. 12).

As shown in the upper part of FIG. 21, the end ECU 81 to 82 executes the message receiving process S1 or S3 depending on the reception status. When the end ECU 81 to 82 receives the main message for the vehicle power state earlier and receives the redundant message for the vehicle power state this time, the end ECU 81 to 82 executes the arbitration between the main message and the redundant message (message receiving process S1). When the end ECU 81 to 82 has not received the main message earlier but receives the redundant message this time, only the message receiving process S3 is performed.

Then, as shown in the lower part of FIG. 21, the mobility computer 10 sends the redundant message for the vehicle power state to the second zone ECU 60 by using the first zone ECU 50 as the relay ECU (S08b). The second zone ECU 60 executes the message relaying process S2 for the redundant message for the vehicle power state. In the message relaying process S2, when the PHY 54 receives the redundant message, the gateway 50g switches over the destination connection and performs the protocol conversion, and the communication circuit 55 forwards the redundant message to the second zone ECU 60 through redundant communication line SL1.

When the second zone ECU 60 receives the redundant message from the first zone ECU 50 through the communication circuit 65, the second zone ECU 60 executes the message relaying process S2 and thereafter executes the message receiving process S1. In the message relaying process S2, the redundant message received from communication circuit 65 is forwarded by the communication circuit 66 to the end ECUs 81 to 83 through main communication line ML6. In the message receiving process S1, when the second zone ECU 60 executes the message arbitration S102 (see FIG. 14 to FIG. 16C) and adopts the message (S203 in FIG. 14 to FIG. 16A), the second zone ECU 60 sets the vehicle power state thereof based on that message (S104 and S105 in FIG. 12).

As shown in the lower part of FIG. 21, the end ECU 81 to 83 executes the message receiving process S1 depending on the reception status. When the end ECU 81 to 83 receives the main message for the vehicle power state earlier and receives the redundant message for the vehicle power state this time, the end ECU 81 to 83 executes the arbitration between the main message and the redundant message (message receiving process S1).

### Modification of Message Sending Process

The above has described successive execution by the mobility computer 10 of the message sending processes of FIG. 9, FIG. 19, and FIG. 20. However, the present embodiment is not limited to this. For example, the message sending process of FIG. 9 may be omitted, and successive execution of the message sending processes of FIG. 19 and FIG. 20 may be employed. The sending process for the redundant message may be partially omitted. In short, as long as the redundant message is communicated, any form of process may be adopted.

### On Relay ECU

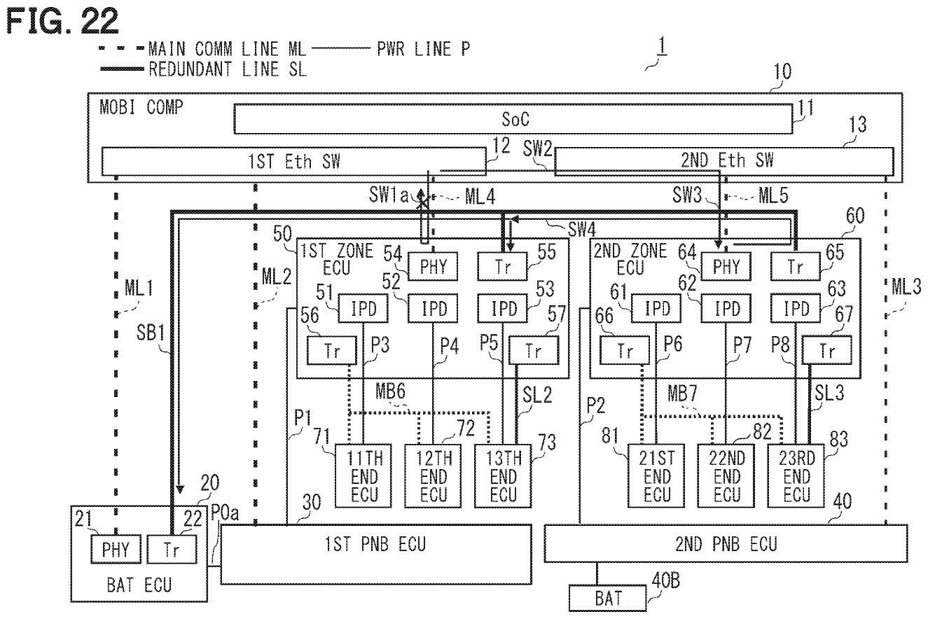

In the above, the first zone ECU 50 and the second zone ECU 60 are illustrated as relay ECUs. According to this configuration, even if, as shown in FIG. 22 with the communication cutoff route SW1a for example, the main communication line ML4 connecting the mobility computer 10 and the first zone ECU 50 is cut off, it is possible to convey the redundant message to the first zone ECU 50 and the end ECU 71 to 73 being the cascade-connection ECU.

The present embodiment is not limited to the above. Any of the zone ECUs 50 and 60 not reaching the power-off nor the sleep state but still in the wake-up state may be selectively used as the relay ECU.

The mobility computer 10 may use, as the relay ECU, the ECU that is in the wake-up at a time of activation/stop of the high voltage system among the first and second zone ECUs 50 and 60, and may send the redundant message to the necessary other zone ECU 50, 60, as well as the end ECU 71 to 73 or 81 to 83.

For example, even when the first zone ECU 50 is in the wake-up and the second zone ECU 60 is in sleep mode, the mobility computer 10 sending the message to the PHY 54 of the first zone ECU 50 through the main communication line ML4 causes the gateway 50g of the first zone ECU 50 to switch over the destination connection and perform the protocol conversion and the communication circuit 55 to send the message to the battery ECU 20 and the second zone ECU 60 through the redundant communication line SL1.

Because of this, it is possible to send the redundant message to the battery ECU 20 and the second zone ECU 60. The communication circuit 56 of the first zone ECU 50 can also send the redundant message to the end ECU 71 to 73 through the main communication line ML6. The communication circuit 66 of the second zone ECU 60 can send the redundant message to the end ECU 81 to 83 through the redundant communication line SL3. Because of this, it is possible to send the redundant message to each ECU 20, 30, 40, 50, 60, 71 to 73, 81 to 83 without adding a gateway function to the battery ECU 20.

The battery ECU 20, which supplies the high voltage system power, may additionally include a gateway function to perform the protocol conversion between the automotive Ethernet and the CAN. In this case, the battery ECU 20 can relay the main message and the redundant message. This can increase the number of redundant routes and the communication route redundancy.

### Process for Responding to Status Change

The following will describe an example of a case where a change in status ST1 to ST5 occurs. For example, when transitioning from the status ST3 “onboard and driving” to status ST2 “onboard and parked”, the mobility computer 10 executes sending the messages to all of the ECUs, including sending the message for the vehicle power state/stop preparation request and sending the message for the power control request at a time of stop. Now, the description will be given mainly on communication processes for the messages for the stop preparation request and the power control request at a time of stop. In other words, the communication processes for changing the status from “running” to “parked” are executed.

### Stop Process A

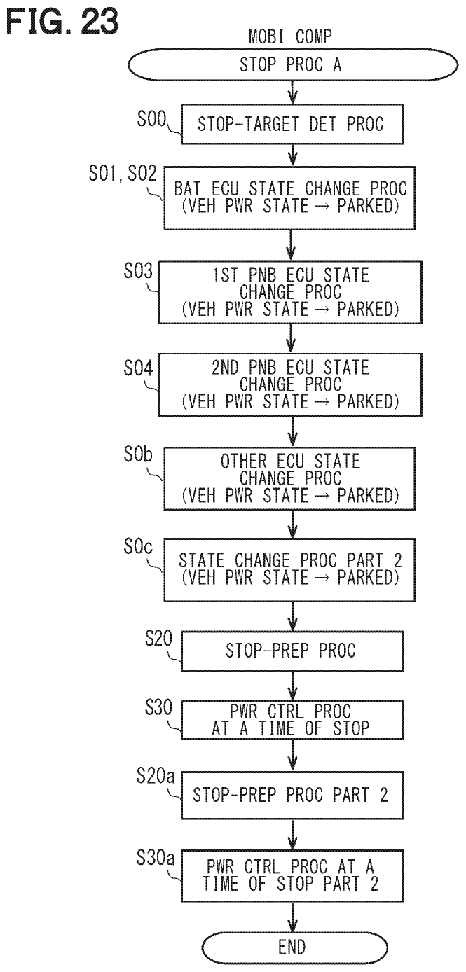

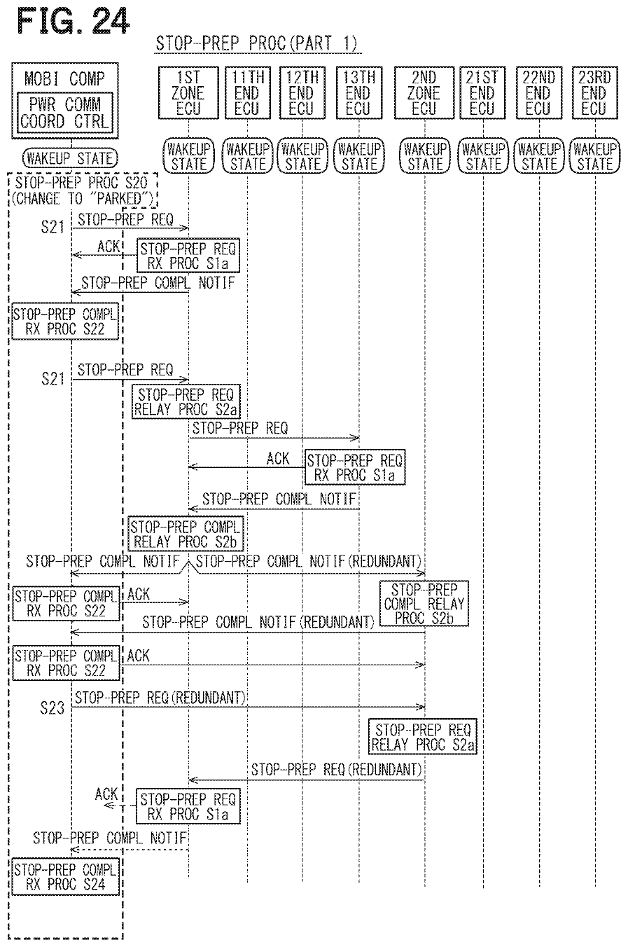

As shown in FIG. 23, the mobility computer 10 executes a stop process A. In the stop process A, the mobility computer 10 executes a process of determining a stop target ECU (S00). The mobility computer 10 determines the stop target ECU by referencing to the management table. The mobility computer 10 then sends the message for the vehicle power state to each ECU (S01, S02, S03, S04, S0b, S0c).

Here, the mobility computer 10 generates the message for the vehicle power state for changing the status from “running” to “parked”, sends the main message through the main communication route described above, and also sends the redundant message through the redundant route. Since the communication process for the vehicle power state has been described above, the duplicated description for the process S01, S02, S03, S04, S0b, and S0c are omitted here.

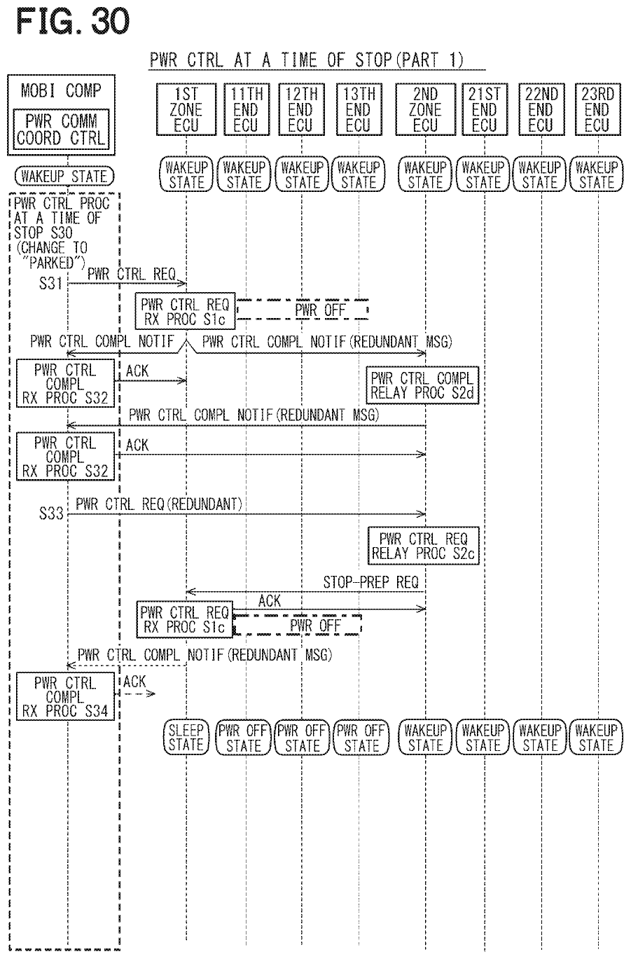

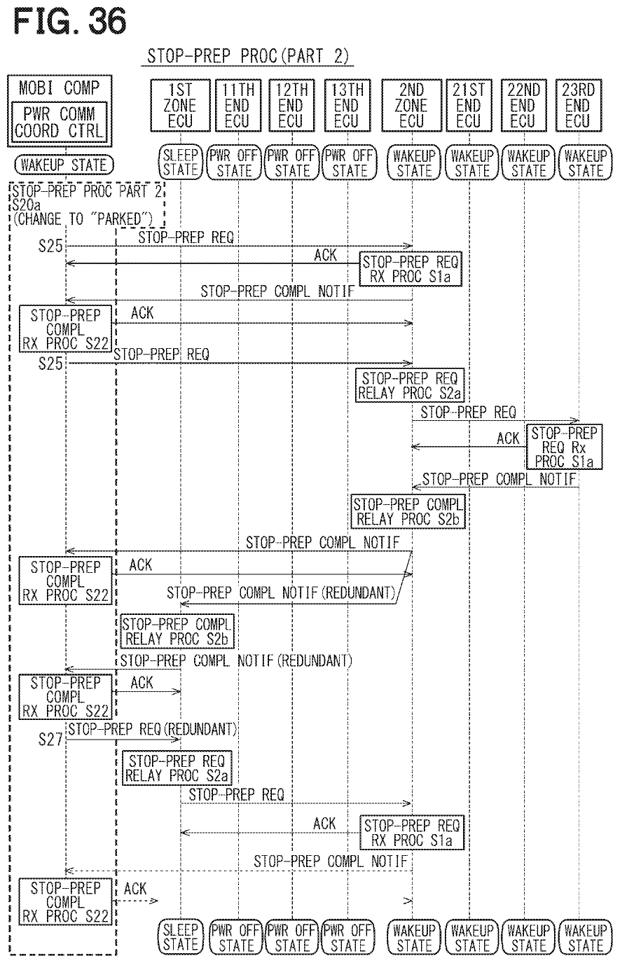

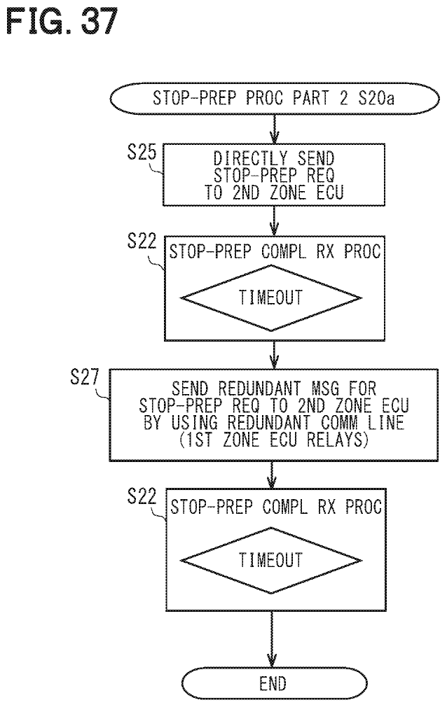

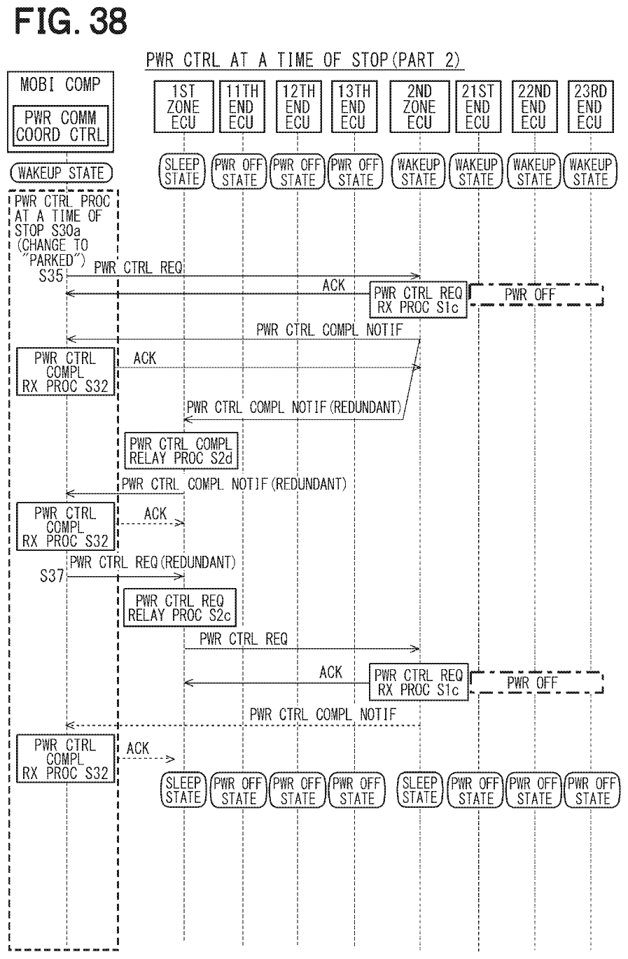

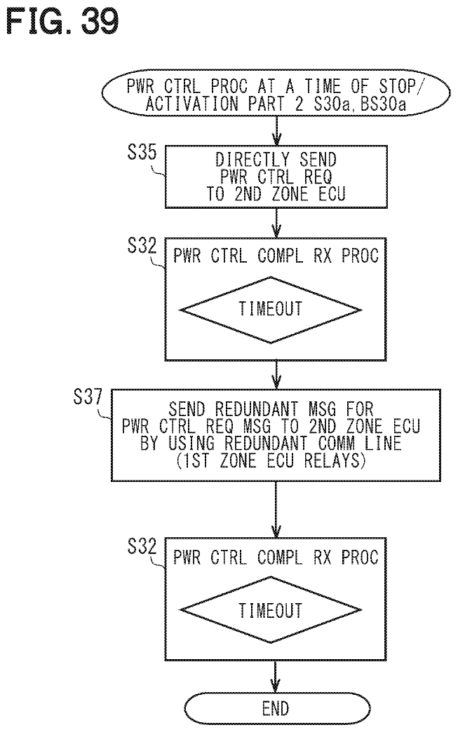

Then, in the stop process A, the mobility computer 10 executes a stop preparation process (S20: see FIG. 24 to FIG. 29), executes a power control process at a time of stop (S30: see FIG. 30 to FIG. 35), executes a stop preparation process Part 2 (S20a: see FIG. 36 to FIG. 37), and executes a power control process at a time of stop Part 2 (S30a: see FIG. 38 to FIG. 39).

### Stop Preparation Process (S20)

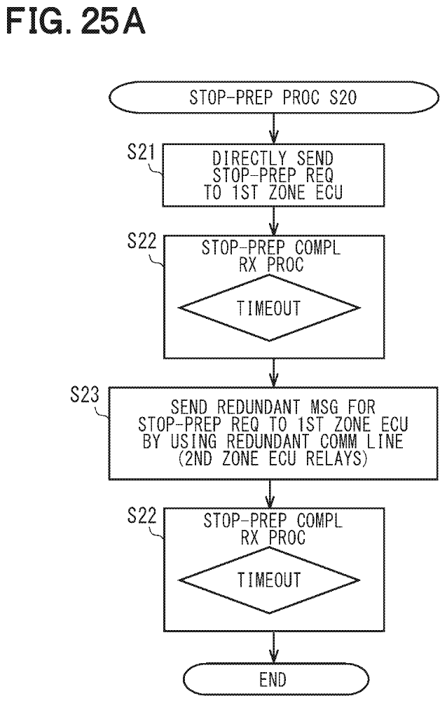

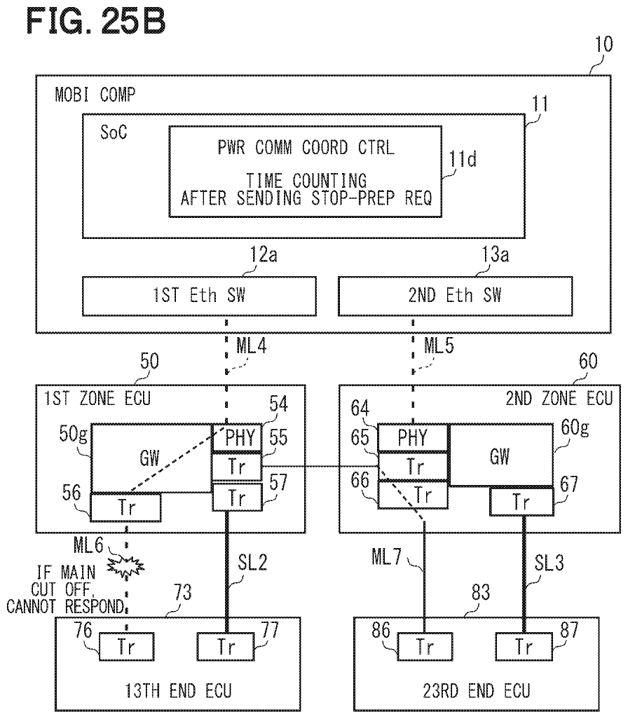

As shown in the upper part of FIG. 24 and FIG. 25A, in the stop preparation process (S20), the mobility computer 10 sends the main message for the stop preparation request directly from the first Ethernet switch 12a to the first zone ECU 50 through the main communication line ML4 (S21). The mobility computer 10 sets a value of a stop preparation request count timer to the main message of the frame and sends the frame. The value of the stop preparation request count timer is set to a timer value that takes into account a time required for the communication using the redundant communication line SL1. As shown in FIG. 25B, the power communication coordination control 11d of the mobility computer 10 starts the time count after sending the message (in this case, the main message) for the stop preparation request. When the stop preparation request count timer value is reached after sending the main message for the stop preparation request and the mobility computer 10 fails to receive the message for a stop preparation completion notification as a response, the mobility computer 10 may consider this as some kind of communication abnormality or an abnormality in the main communication line ML (e.g., ML6). When the mobility computer 10 determines that some kind of communication abnormality has occurred in other than the main communication line ML of the main communication route, the mobility computer 10 may not consider this as an abnormality in the main communication line ML (e.g., ML6).

Thereafter, the redundant message is sent. The time count may be started after the redundant message is sent. This redundant message is also sent so that the stop preparation request count timer value is set into the redundant message. This is made in view that, for example, the cutoff of the main communication line ML6 in the main communication route makes it impossible for the end ECU 71 to 73 to respond. The mobility computer 10 waits for receipt of the message for the stop preparation completion notification. Upon receipt of the message for the stop preparation completion notification, the mobility computer 10 executes a stop preparation completion receiving process (S22). In this stop preparation completion receiving process (S22), when the sent stop preparation request count timer value is reached, the mobility computer 10 times out and forcibly ends waiting for the receipt and ends the stop preparation completion receiving process.

### Stop Preparation Request Receiving Process S1a of First Zone ECU 50

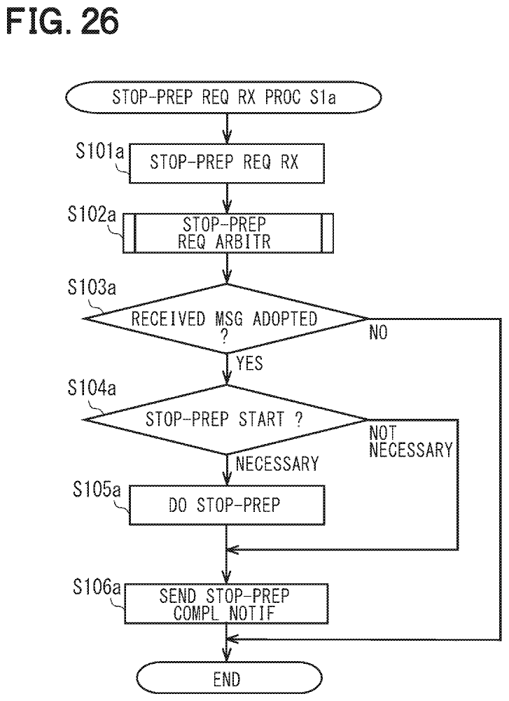

As shown in the upper part of FIG. 24, upon receipt of the main message for the stop preparation request, the first zone ECU 50 executes the stop preparation request receiving process (S1aa: see upper part of FIG. 26). As shown in FIG. 26, when the PHY 54 receives the main message for the stop preparation request (S101a), the first zone ECU 50 performs the arbitration on the message for the stop preparation request (S102a).

FIG. 16B shows the first zone ECU 50 and a processing function for the stop preparation request message built in the first zone ECU 50. As shown in FIG. 16B, the first zone ECU 50 executes the function of the message arbitration unit 58 by the application 50app (S102a), executes the stop preparation start determination 50f, and executes a stop preparation 50h. As shown in FIG. 16C, the first zone ECU 50 may use the cutoff determination application 50aa to determine the cutoff of the main communication line ML and the cutoff of the redundant communication line SL. The cutoff determination application 50aa may use the function of the reception timeout detection 50d, 50e, which counts the communication time and detect whether a given timeout time has been reached or not. The reception timeout detection 50d includes a function of determining the cutoff of the main communication line ML, and the reception timeout detection 50e includes a function of determining the cutoff of the redundant communication line SL. The message arbitration unit 58 performs the arbitration (S102a) similar to S102 described above with reference to FIG. 14, FIG. 15A, and FIG. 16A to FIG. 16C, and the duplicated description is omitted here.

If the first zone ECU 50 adopts the message for the stop preparation request (S203 in FIG. 14, FIG. 15A, FIG. 16A) (YES in S103a in FIG. 26), the first zone ECU 50 determines whether it is necessary to start the stop preparation based on the message (S104a: stop preparation start determination 50f), and if necessary, executes the stop preparation (S105a: stop preparation 50h).

### Stop Preparation Request to Thirteenth end ECU 73

When sending the main message for the stop preparation request to the thirteenth end ECU 73, the mobility computer 10 sends the main message for the stop preparation request directly from the first Ethernet switch 12a to the first zone ECU 50 through the main communication line ML4 (S21 in FIG. 24).

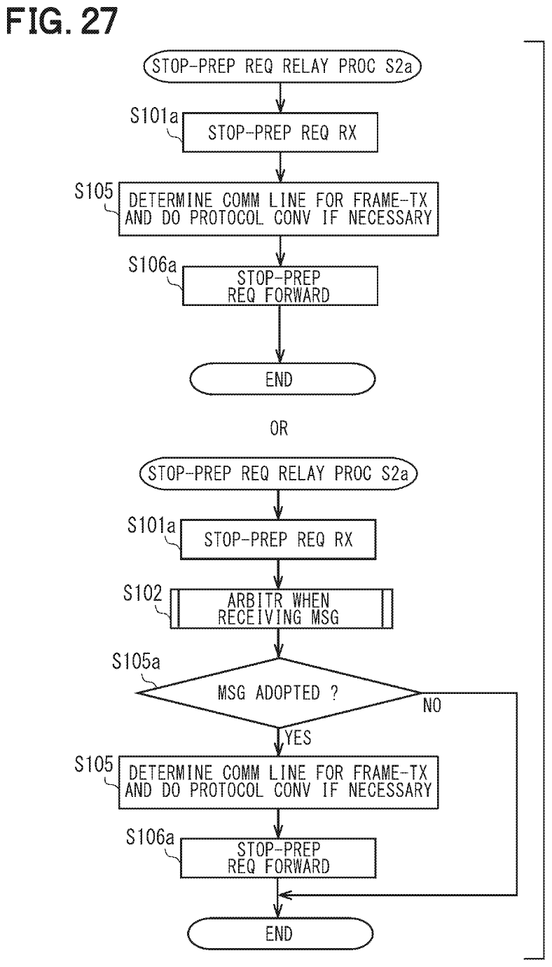

The first zone ECU 50 relays the main message for the stop preparation request to another cascade-connection electronic control unit (e.g., the thirteenth end ECU 73 being the high voltage system ECU) (S2a in FIG. 24: see FIG. 27). As shown in the upper part of FIG. 27, when the PHY 54 receives the main message for the stop preparation request (S101a), the first zone ECU 50 determines the communication line to which the frame is to be sent out and performs the protocol conversion if necessary (S105). When relaying a message, the message arbitration unit 58 arbitrates to which communication line the message is to be forwarded among the main communication line ML and the redundant communication line SL. The communication circuit 56 then forwards the main message for the stop preparation request to the thirteenth end ECU 73 (S106a). As shown in the lower part of FIG. 27, when relaying the message, the message may be forwarded on the condition that the message arbitration S102 has been performed by message arbitration unit 58 and the message has been adopted.

### Stop Preparation Request Receiving Process S1a of Thirteenth End ECU73

Upon receipt of the main message for the stop preparation request, the thirteenth end ECU 73 executes the stop preparation request receiving process (S1a: see FIG. 26). As shown in FIG. 26, when the communication circuit 76 receives the main message for the stop preparation request (S101a), the thirteenth end ECU 73 performs the arbitration on the message for the stop preparation request (S102a). The message arbitration (S102a) is the process similar to S102 described above with reference FIG. 14, FIG. 15A, and FIG. 16A to FIG. 16C, and the duplicated description here is omitted.

When the thirteenth end ECU 73 adopts the message for the stop preparation request (S203 in FIG. 14, FIG. 15A, and FIG. 16A) (YES in S103a in FIG. 26), the thirteenth end ECU 73 determines based on the message whether it is necessary to start the stop preparation (S104a), and if necessary, executes the stop preparation (S105a). If it is necessary to start the stop preparation (NO in S104a), or if the thirteenth end ECU 73 has completed the stop preparation (S105a), the communication circuit 76 sends the message to the mobility computer 10 as the main message for the stop preparation completion notification (S106a in FIG. 26: S1a in FIG. 24) to notify that the stop preparation is complete.

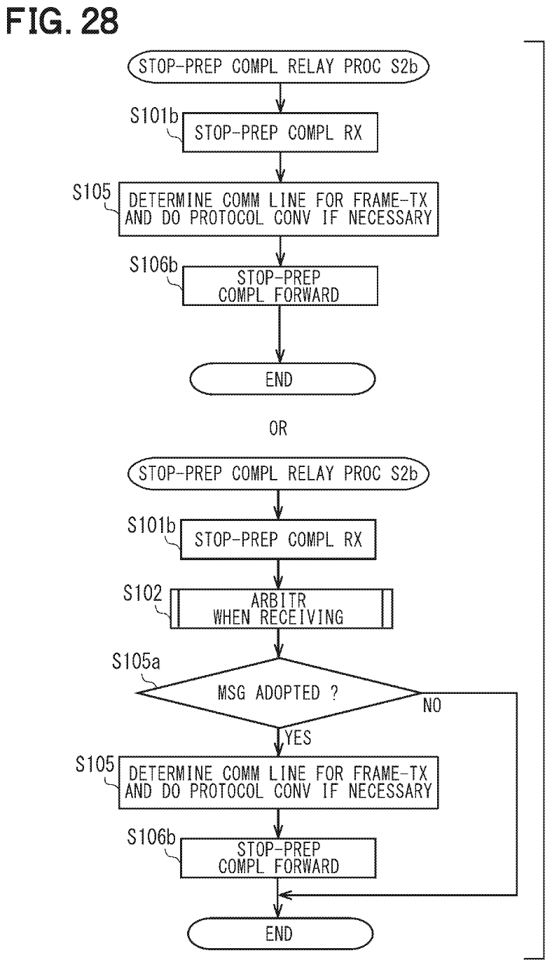

Upon receipt of the message for the stop preparation completion notification from the thirteenth end ECU 73, the first zone ECU 50 relays the message to the mobility computer 10 (S2b in FIG. 24: see FIG. 28). As shown in FIG. 28, Upon receipt of the message for the stop preparation completion notification (S101b), the first zone ECU 50 determines which communication line the frame is to be sent out to and performs the protocol conversion if necessary (S105). When relaying a message, the message arbitration unit 58 arbitrates to which communication line the message is to be forwarded among the main communication line ML and the redundant communication line SL. In this case, in the first zone ECU 50, the PHY 54 forwards the message for the stop preparation completion notification to the mobility computer 10 as the main message. At this time, simultaneously (broadcast) or sequentially, the first zone ECU 50 forwards the message for the stop preparation completion notification by communication circuit 55 to the second zone ECU 60 as the redundant message (S2b in FIG. 24: S106b in FIG. 28). As shown in the lower part of FIG. 28, when relaying the message, the message may be forwarded on the condition that the message arbitration S102 has been performed by the message arbitration unit 58, 68 and the message has been adopted.

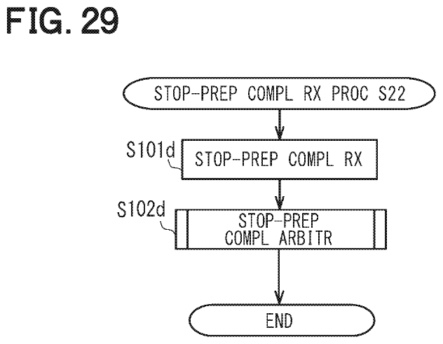

When the first Ethernet switch 12a receives the main message for the stop preparation completion notification from the first zone ECU 50, the mobility computer 10 executes the stop preparation completion receiving process (S22 in FIG. 24: see FIG. 29). As shown in FIG. 29, upon receipt of the main message for the stop preparation completion (S101d), the mobility computer 10 performs the message arbitration on the message for the stop preparation completion notification (S102d). The message arbitration (S102d) is the process similar to S102 described above with reference to FIG. 14, FIG. 15A, and FIG. 16A to FIG. 16C, and the duplicated description here is omitted.

Upon receipt of the redundant message for the stop preparation completion notification forwarded from the first zone ECU 50, the second zone ECU 60 executes the stop preparation completion relaying process (S2b in FIG. 24: see FIG. 28). As shown in the upper part of FIG. 28, when the communication circuit 65 receives the message for the stop preparation completion notification (S101b), the second zone ECU 60 determines the communication line to which the frame is to be sent out and performs the protocol conversion if necessary (S105). When relaying the message, the message arbitration unit 58, 68 arbitrates to which communication line the message is to be forwarded among the main communication line ML and the redundant communication line SL. The PHY 64 forwards the redundant message for the stop preparation completion notification to the mobility computer 10. As shown in the lower part of FIG. 28, when relaying the message, the message may be forwarded on the condition that the message arbitration S102 has been performed by the message arbitration unit 58, 68 and the message has been adopted.

When the second Ethernet switch 13a receives the redundant message for the stop preparation completion notification from the second zone ECU 60, the mobility computer 10 executes the stop preparation completion receiving process (S22 in FIG. 24: see FIG. 29). As shown in FIG. 29, upon receipt of the redundant message for the stop preparation completion notification (S101d), the mobility computer 10 performs the message arbitration on the stop preparation completion notification (S102d). The message arbitration (S102a) is the process similar to S102 described above with reference to FIG. 14, FIG. 15A, and FIG. 16A to FIG. 16C, and the duplicated description here is omitted.

### Redundant Message Communication for Stop Preparation Request

As shown in the lower part of FIG. 24 and FIG. 25A, the mobility computer 10 sends the redundant message for the stop preparation request to the first zone ECU 50 by using the redundant communication line SL1 (S23). In this case, the second zone ECU 60 relays the redundant message for the stop preparation request. The mobility computer 10 waits for the receipt of the message for the stop preparation completion notification, and upon receipt of the message for the stop preparation completion notification, executes the stop preparation completion receiving process (S22).

The second zone ECU 60 relays the redundant message for the stop preparation request (S23 to S2a in FIG. 24), and the first zone ECU 50 receives the redundant message for the stop preparation request (S1a). The processes in S2a and S1a are the same as described above, so the description is omitted. When the first zone ECU 50 executes the stop preparation request receiving process, the first zone ECU 50 sends the redundant message for the stop preparation completion notification to the mobility computer 10. After executing this series of processes, the first zone ECU 50 transitions to sleep. The mobility computer 10 receives the redundant message for the stop preparation completion notification (S2).

Upon elapse of the given timeout time after sending the redundant message for the stop preparation request (S23), the mobility computer 10 may end waiting for receipt of the message for the stop preparation completion notification and forcibly ends the receiving process for the redundant message for the stop preparation completion notification in S22. The mobility computer 10 then ends the stop preparation process (S20). The first zone ECU 50 may not necessarily be required to send the redundant message for the stop preparation completion notification to the mobility computer 10 and may transition to sleep.

### Power Control Process at a Time of Stop (S30)

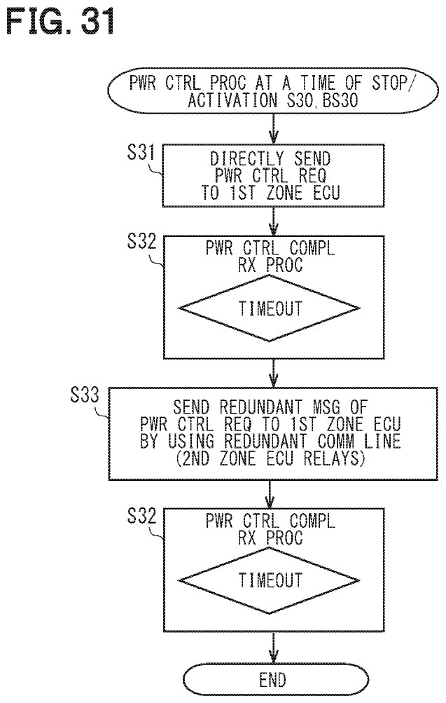

The mobility computer 10 next executes the power control process at a time of stop (S30 in FIG. 23: see FIGS. 30 to 31). As shown in FIG. 30 and FIG. 31, in the power control process at a time of stop (S30), the mobility computer 10 sends the main message for the power control process at a time of stop directly from the first Ethernet switch 12a to the first zone ECU 50 through the main communication line ML4 (S31). The mobility computer 10 waits for receipt of the message for the power control completion notification at a time of stop, and upon receipt of the power control completion notification at a time of stop, the mobility computer 10 executes the power control completion receiving process at a time of stop (S32).

### Power Control Request Receiving Process S1c at a Time of Stop by the First Zone ECU 50

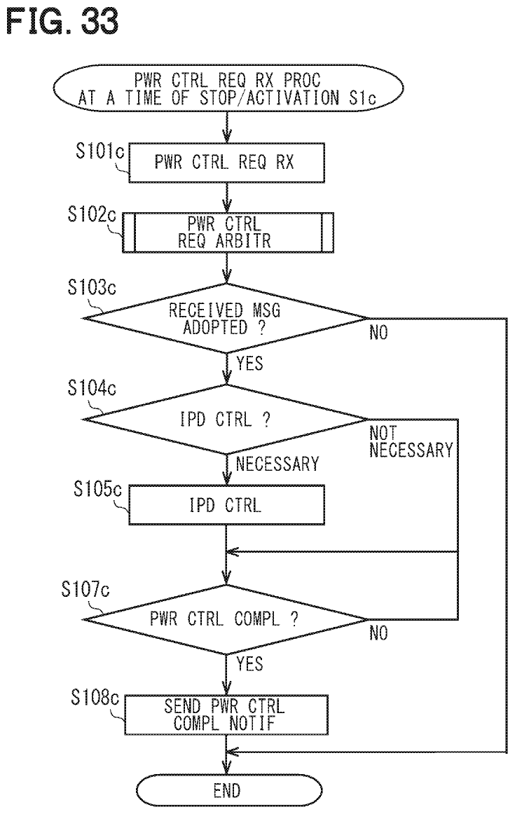

As shown in FIG. 30, when the first zone ECU 50 receives the main message for the power control request at a time of stop, the first zone ECU 50 executes the receiving process for the power control request at a time of stop (S1c: FIG. 33). As shown in FIG. 33, when the PHY 54 receives the main message for the power control request at a time of stop (S101c), the first zone ECU 50 performs the message arbitration on the message for the power control request at a time of stop (S102c). The message arbitration (S102c) is the process similar to S102 described above with reference to FIG. 14, FIG. 15A, and FIG. 16A to FIG. 16C, so that the description is omitted.

When the first zone ECU 50 adopts the message (S203 in FIG. 14, FIG. 15A, and FIG. 16A) for the power control request at a time of stop (YES in S103c in FIG. 33), the first zone ECU 50 determines based on the message whether it is necessary to control a change in on-state or off-state of the IPDs 51 to 53 (S104a) and if necessary performs the control on one or more of the IPDs 51 to 53 (S105c). For example, in order to change the status from “onboard” to “parked”, the first zone ECU 50 performs the control to turn OFF the IPDs 51 to 53 so that the end ECUs 71 to 73 are powered off. This cuts off the supply of power to the end ECUs 71 to 73.

The first zone ECU 50 waits for completion of the power control (S107c). When the power control is completed, the PHY 54 sends the main message for the power control completion notification to the mobility computer 10 through the main communication line ML4, and the communication circuit 55 sends the redundant message for the power control completion notification to the second zone ECU 60 through the redundant communication line SL1 (S108c).

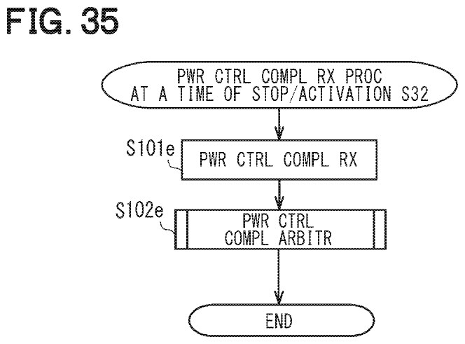

When the first Ethernet switch 12a receives the main message for the power control completion notification at a time of stop from the first zone ECU 50, the mobility computer 10 executes the power control completion receiving process at a time of stop (S32 in FIG. 30: see FIG. 35). As shown in FIG. 35, upon receipt of the main message for the power control completion notification at a time of stop (S101e), the mobility computer 10 performs message arbitration on the stop preparation completion notification (S102e). The message arbitration (S102e) is the process similar to S102 described above with reference to FIG. 14, FIG. 15A, and FIG. 16A to FIG. 16C, so that the description is omitted.

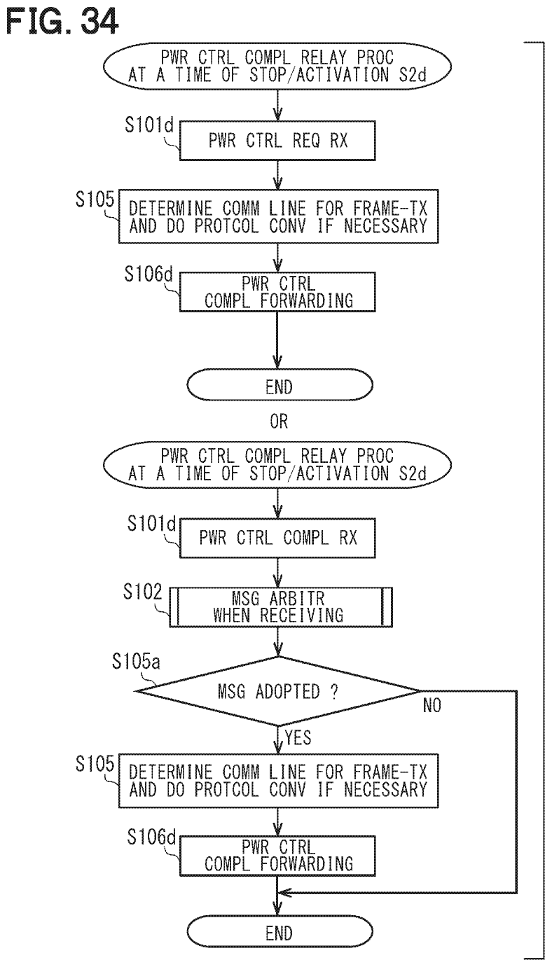

When the second zone ECU 60 receives the redundant message for the power control completion notification at a time of stop forwarded from the first zone ECU 50, the second zone ECU 60 executes the power control completion relaying process at a time of stop (S2d in FIG. 30: see FIG. 34). As shown in the upper part of FIG. 34, when the communication circuit 65 receives the redundant message for the power control completion notification at a time of stop (S101c), the second zone ECU 60 determines the communication line to which the frame is be sent out and performs the protocol conversion if necessary (S105). When relaying the message, the message arbitration unit 68 arbitrates to which communication line the message is to be forwarded among the main communication line ML and the redundant communication line SL. The PHY 64 then forwards the redundant message for the power control completion notification at a time of stop to the mobility computer 10 (S106c). As shown in the lower part of FIG. 34, when relaying the message, the message may be forwarded on the condition that the message arbitration S102 has been performed by message arbitration unit 68 and the message has been adopted.

When the second Ethernet switch 13a receives the redundant message for the power control completion notification at a time of stop from the second zone ECU 60, the mobility computer 10 executes the power control completion receiving process at a time of stop (S32 in FIG. 30: see FIG. 35). As shown in FIG. 35, upon receipt of the redundant message for the power control completion at a time of stop (S101e), the mobility computer 10 performs the message arbitration on the power control completion notification at a time of stop (S102e). The message arbitration (S102e) is the process similar to S102 described above with reference to FIG. 14, FIG. 15A, and FIG. 16A to FIG. 16C, so that the description is omitted.

At this point, the first zone ECU 50 has transitioned to the sleep state and the end ECUs 71 to 73 have transitioned to the power-off state, but the second zone ECU 60 and the end ECUs 81 to 83 managed by the second zone ECU 60 are still in the wake-up state. Therefore, in the stop process A, the mobility computer 10 executes the stop preparation process Part 2 (S20a in FIG. 23: see FIGS. 36 to 37), and thereafter executes the power control process at a time of stop Part 2 (S30a in FIG. 23: see FIGS. 38 to 39).

### Stop Preparation Process Part 2 (S20a)

In the stop preparation process No. 2(S20a), the mobility computer 10 exchange the role of the relay ECU between the target first zone ECU 50 and second zone ECU 60 to again execute the sending process of sending the message for the stop preparation request similarly to the stop preparation process S20 shown in FIG. 25A. Specifically, the mobility computer 10 again sends the message for the stop preparation request to the second zone ECU 60 by using the first zone ECU 50 as the relay ECU. This message can be considered a redundant message because of the role exchange and the resending.

In the stop preparation process Part 2 (S20a), the mobility computer 10 directly sends the message for the stop preparation request (considerable as the main message and also as the redundant message) from the second Ethernet switch 13a to the second zone ECU 60 through the main communication line ML5 (S25 in FIG. 36 and FIG. 37). The mobility computer 10 executes the timeout process in the same manner as described above, waits for receipt of the message for the stop preparation completion notification, and executes the stop preparation completion receiving process upon receipt of the stop preparation completion notification (S22 in FIG. 36).

As shown in FIG. 36, the second zone ECU 60 executes the stop preparation request receiving process (S1a) and sends the main message for the stop preparation completion notification to the mobility computer 10. When the mobility computer 10 sends the main message for the stop preparation request to the thirteenth end ECU 73, the mobility computer 10 sends the main message to the second zone ECU 60 and the second zone ECU 60 executes the stop preparation request relaying processing (S2a), and sends the main message for stop preparation request to the twenty-third end ECU 83.

The twenty-third end ECU 83 executes the stop preparation request receiving process (S1a) and sends the main message for the stop preparation completion notification to the second zone ECU 60. The second zone ECU 60 executes the stop preparation completion relaying process (S2b), sends the main message for the stop preparation completion notification to the mobility computer 10 and sends the redundant message for the stop preparation completion notification to the first zone ECU 50.

The mobility computer 10 executes the stop preparation completion receiving process (S22). Upon receipt of the redundant message for the stop preparation completion notification forwarded from the second zone ECU 60, the first zone ECU 50 executes the stop preparation completion relaying process (S2b) and sends the redundant message for the stop preparation completion notification to the mobility computer 10. The mobility computer 10 executes the stop preparation completion receiving process (S22) and receives the redundant message for the stop preparation completion notification. The processes in S1a, S2a, S2b, and S22 are similar to those described above, so that the description is omitted.

The second zone ECU 60 or the twenty-third end ECU 83 performs the message arbitration when executing the stop preparation request receiving process (S1a). The mobility computer 10 also performs the arbitration between the main message and the redundant message when executing the stop preparation completion receiving process (S22). These message arbitrations are similar to S102 described above with reference to FIG. 14, FIG. 15A, and FIG. 16A to FIG. 16C, so that the description is omitted.

### Redundant Message Communication for Stop Preparation Request

As shown in the lower part of FIG. 36 and FIG. 37, the mobility computer 10 sends the redundant message for the stop preparation request to the second zone ECU 60 via the first zone ECU 50 by using the redundant communication line SL1 (S27). In this case, the first zone ECU 50 relays the redundant message for the stop preparation request. The mobility computer 10 waits for receipt of the message for the stop preparation completion notification and executes the stop preparation completion receiving process upon receipt of the stop preparation completion notification (S22).

The first zone ECU 50 relays the redundant message for the stop preparation request (S2a) and the second zone ECU 60 receives the redundant message for the stop preparation request (S1a). The processes in S2a, S1a are similar to those described above, so that the description is omitted. When the second zone ECU 60 executes the stop preparation request receiving process, the second zone ECU 60 sends the redundant message for the stop preparation completion notification to the mobility computer 10. The mobility computer 10 receives the redundant message for the stop preparation completion notification (S22).

Upon elapse of the timeout time determined in S22 after sending the redundant message for the stop preparation request (S23), the mobility computer 10 may forcibly end the receiving process for the redundant message for the stop preparation completion notification. Because of this, the mobility computer 10 ends the stop preparation process Part 2 (S20a).

### Omission to Send Redundant Message for Stop Preparation Request

After sending the main message for the stop preparation request and before sending the redundant message, the mobility computer 10 may receive the completion notification corresponding to the main message for the stop preparation request (may receive the stop preparation completion notification) from the target control device (ECU 20, 30, 40, 50, 60, 71 to 73, 81 to 83) being the message destination. In this case, the mobility computer 10 may not necessarily be required to send the redundant message for the stop preparation request. The mobility computer 10 may transition to the sleep mode without sending the redundant message for the stop preparation request.

### Power Control Processing at a Time of Stop Part 2 (S30a)

In the stop process A, the mobility computer 10 then executes the power control process at a time of stop Part 2 (S30a in FIG. 23: see FIGS. 38 to 39). In the power control process at a time of stop Part 2, the mobility computer 10 exchanges the relay ECU role between the target first zone ECU 50 and second zone ECU 60 to execute again the message sending process for the power control request at a time of stop as in the power control process at a time of stop (S30) shown in FIG. 31.

As shown in FIG. 38 and FIG. 39, in the power control process at a time of stop Part 2 (S30a), the mobility computer 10 sends the main message for the power control process at a time of stop directly from the second Ethernet switch 13a to the second zone ECU 60 through the main communication line ML5 (S35). The mobility computer 10 waits for receipt of the message for the power control completion notification at a time of stop and executes the power control completion receiving process at a time of stop (S32) upon receipt of the power control completion notification at a time of stop. The process in S32 is similar to those described above, so that the description is omitted.

When the second zone ECU 60 receives the main message for the power control request at a time of stop, the second zone ECU 60 executes the receiving process for the power control request at a time of stop (S1c). The process of S1c is similar to those described above, so that details thereof are omitted. Based on the message for the power control request at the stop, the second zone ECU 60 executes the control on one or more of the IPDs 61 to 63 if necessary. For example, in order to change the status from “onboard” to “parked”, the second zone ECU 60 performs the control to turn OFF the IPDs 61 to 63 so that the end ECUs 81 to 83 are powered off. This cuts off the supply of power to the end ECUs 81 to 83.

When the second zone ECU 60 completes the power control, the PHY 64 sends the main message for the power control completion notification to the mobility computer 10 through the main communication line ML5, and the communication circuit 65 sends the redundant message for the power control completion notification to the first zone ECU 50 through the redundant communication line SL1.

When the second Ethernet switch 13a receives the main message for the power control completion notification at a time of stop from the second zone ECU 60, the mobility computer 10 executes the power control completion receiving process at a time of stop (S32). When the first zone ECU 50 receives the redundant message for the power control completion notification at a time of stop forwarded from the second zone ECU 60, the first zone ECU 50 executes the power control completion relaying process at a time of stop (S2d) and forwards the redundant message for the power control completion notification at a time of stop to the mobility computer 10. When the first Ethernet switch 12a receives the redundant message for the power control completion notification at a time of stop from the first zone ECU 50, the mobility computer 10 executes the power control completion receiving process at a time of stop (S32).

The message arbitration is performed when the second zone ECU 60 executes the power control request receiving process (S1c) at a time of stop. The mobility computer 10 also performs the arbitration between the main message and the redundant message when executing the power control completion receiving process at a time of stop (S32). These message arbitrations are similar to S102 described above with reference to FIG. 14, FIG. 15A, and FIG. 16A to FIG. 16C, so that the description is omitted.

### Redundant Message Communication for Power Control Request at a Time of Stop

As shown in the lower part of FIG. 38 and FIG. 39, the mobility computer 10 sends the redundant message for the power control request at a time of stop to the second zone ECU 60 by using the redundant communication line SL1 (S37). In this case, the first zone ECU 50 relays the redundant message for the power control request at a time of stop. The mobility computer 10 waits for receipt of the redundant message for the power control completion notification at a time of stop and executes the power control completion receiving process at a time of stop upon receipt of the power control completion notification at a time of stop (S32).

The first zone ECU 50 relays the redundant message for the power control request (S37 to S2c in FIG. 38), and the second zone ECU 60 receives the redundant message for the power control request (S1c). The relaying process in S2c is similar to S2b described, and the process in S1c is similar to S1c described above, so that the description is omitted. The second zone ECU 60 executes the power control request receiving process (S1c). In order to change the status from “onboard” to “parked,” the second zone ECU 60 performs the control to turns OFF the IPDs 61 to 63 so that the end ECUs 81 to 83 are powered off. This cuts off the supply of power to the end ECUs 81 to 83. By sending the redundant message, it is possible to convey the power control request as reliably as possible. The second zone ECU 60 sends the redundant message for the power control completion notification to the mobility computer 10. The mobility computer 10 receives the redundant message for the power control completion notification (S32).

Upon elapse of the given timeout time after sending the redundant message for the power control request (S37), the mobility computer 10 may forcibly end the receiving process for the redundant message for the stop preparation completion notification in S32. The mobility computer 10 then ends the power control process at a time of stop (S30). After executing this series of processes, the second zone ECU 60 transitions to sleep. The second zone ECU 60 may not necessarily be required to send the redundant message for the power control completion notification at the time of the stop to the mobility computer 10. Because of this, in the stop process A shown in FIG. 23, the mobility computer 10 can cause the zone ECUs 50 and 60 to transition to the sleep state and the end ECU 71 to 73, 81 to 83 to transition to the power-off state, and the mobility computer 10 stops the stop process A.

### Omission to Send Redundant Message for Power Control Request at a Time of Stop

After sending the main message for the power supply control request at a time of stop and before sending the redundant message, the mobility computer 10 may receive the message for the completion notification corresponding to the main message for the power supply control request at a time of stop (receive the power control completion notification at a time of stop) from the target control device being the transmission destination (ECU 20, 30, 40, 50, 60, 71 to 73, 81 to 83). In this case, the mobility computer 10 may not necessarily be required to send the redundant message for the power supply control request at a time of stop to the control device being the transmission destination.

### Activation Process B

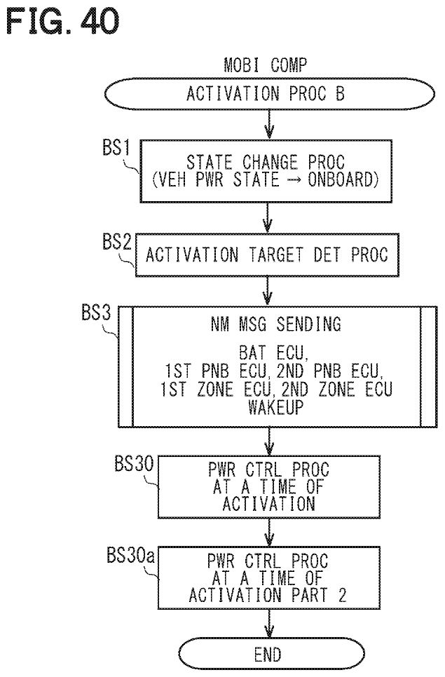

The activation process B for transitioning the status from “parked” to “onboard” will be described with reference to FIG. 40 to FIG. 46. As shown in FIG. 40, the mobility computer 10 changes the vehicle power state from “parked” to “onboard” (BS1). The mobility computer 10 determines the activation target ECU, by referencing to the built-in management table (BS2). The mobility computer 10 sends the NM frame including an NM message indicative of the activation request to all of the ECUs in the vehicle (BS3).

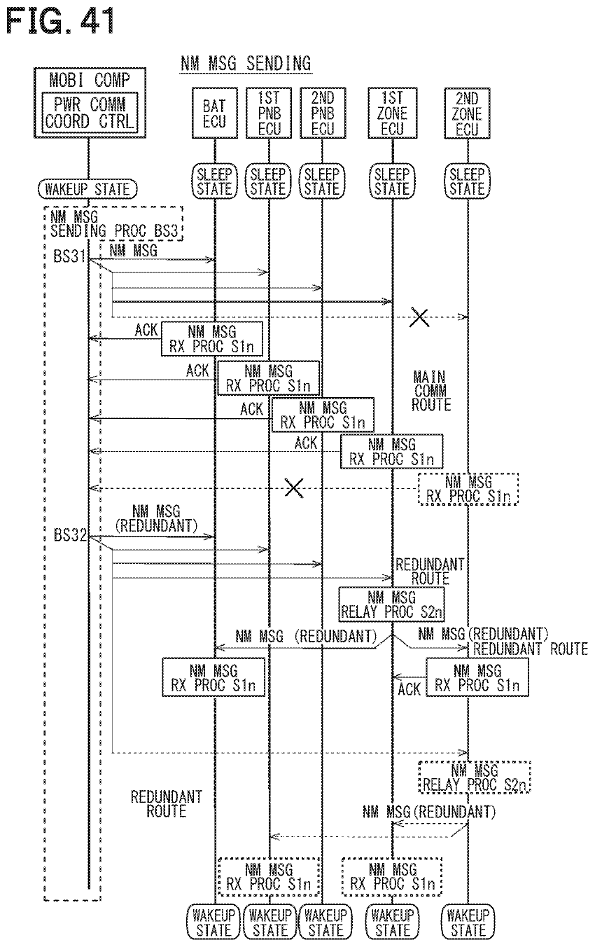

As shown in FIG. 41, in the NM message sending process (BS3), the mobility computer 10 broadcasts the NM message to all the ECUs (see BS31 in FIG. 41). The mobility computer 10 sends the NM frame including the NM message through the main communication line ML. As the main message, the NM message is sent to all of the ECUs (20, 30, 40, 50, 60: corresponding to multiple control devices).

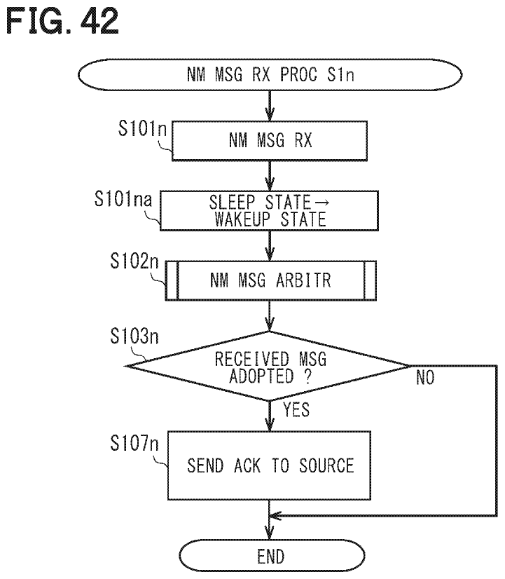

All of the ECUs execute the receiving process for the NM message (S1n in FIG. 41: see FIG. 42). When the status is “parked”, the battery ECU 20, the first PNB ECU 30, the second PNB ECU 40, the first zone ECU 50, and the second zone ECU 60 are all in the sleep mode. As shown in FIG. 42, each ECU receives the NM frame (S101n), so that the battery ECU 20, the first PNB ECU 30, the second PNB ECU 40, the first zone ECU 50, and the second zone ECU 60 shown in FIG. 1A transition to the wake-up state.

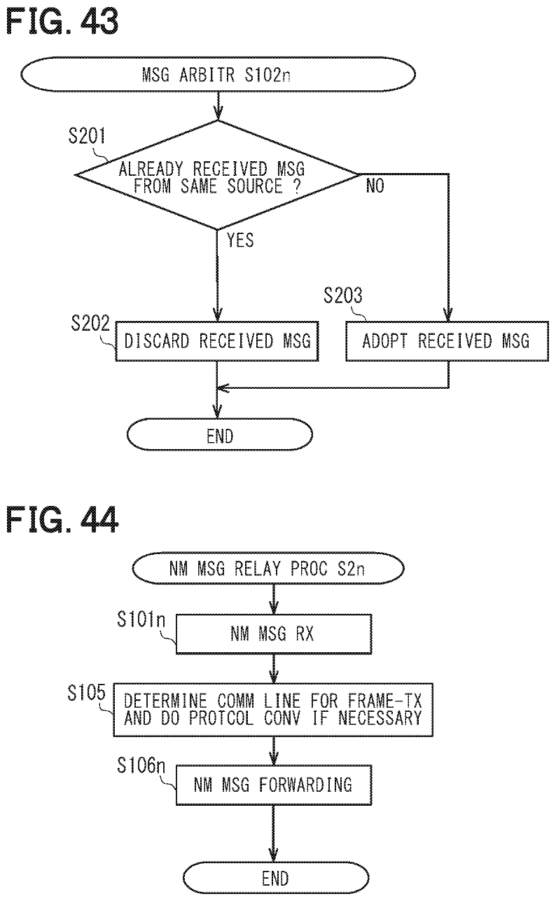

All the ECUs perform the arbitration on the NM frame (S102n: see FIG. 43). As shown in FIG. 43, the ECU determines whether or not the given condition is met and whether or not the message has already been received from the same source (S201). When the ECU has already received the message from the same source in S201, the ECU discards the message (S202). When the ECU has not received the message from the same source, the ECU adopts the message (S203).

When the status is “parked” and the ECU 20, 30, 40, 50, 60 is in sleep mode and receives the NM message for the first time, the ECU adopts the NM message (S103n).

As shown in FIG. 42, when ECU 20, 30, 40, 50, 60 receives the NM message for the first time, the ECU sends the acknowledgement ACK to the source ECU being the mobility computer 10 and adopts the received message (S107n). Therefore, as long as the main communication line ML is not cut off, the mobility computer 10 can recognize the successful receipt of the NM message by receiving the acknowledgement ACK from the respective ECU 20, 30, 40, 50, 60.

The mobility computer 10 then sends the NM message to all of the ECUs again (BS32 in FIG. 41). At this time, the message is sent as the redundant message through the redundancy route. The mobility computer 10 sends to the ECU 20, 30, 40, 50, 60. The mobility computer 10 sends the NM message to the first zone ECU 50, and the first zone ECU 50 relays the NM message (S2n: see FIG. 44) to forward the NM message to the battery ECU 20 and the second zone ECU 60.

In the NM message relaying process (S2n) by the first zone ECU 50 shown in FIG. 44, when the PHY 54 receives the NM message through the main communication line ML4 (S101n), the gateway 50g switches over the destination communication line and performs the protocol conversion if necessary (S105), and the communication circuit 55 forwards the NM message (S106n). Because of this, it is possible for the battery ECU 20 and the second zone ECU 60 to receive the NM message forwarded through the redundant communication line SL1.

The mobility computer 10 also sends the NM message to the battery ECU 20 and the first zone ECU 50 through yet another redundant route. As shown in the lower part of BS32 in FIG. 41, the mobility computer 10 sends the NM message to the second zone ECU 60, and the second zone ECU 60, relays the NM message (S2n: see FIG. 44) to forward the NM message to the battery ECU 20 and the first zone ECU 50.

In the NM message relaying process (S2n) by the second zone ECU 60 shown in FIG. 44, when the PHY 64 receives the NM message through the main communication line ML5 (S101n), the gateway 50g switches over the destination communication line and performs the protocol conversion (S105) and the communication circuit 65 forwards the NM message (S106n). Because of this, it is possible for the battery ECU 20 and the first zone ECU 50 to receive the NM message forwarded through the redundant communication line SL1.

### Normal Communication Through Main Communication Route

When a respective ECU 20, 30, 40, 50, 60 successfully executes the process on the message received for the first time through the main communication line ML, the ECU performs the message arbitration process such that the NM message received for the second and subsequent times through the redundant communication line SL is discarded. Specifically, the receiver ECU (also called destination ECU) once activated discards the NM message received for the second and subsequent times when receiving the NM frame multiple times from the same source. This is so called first-come-first-win.

When the ECU 20, 30, 40, 50, 60 receives the NM message for the second or later times through the redundant communication line SL1, the ECU does not send the acknowledgement ACK to the source because the ECU does not adopt the received message. Alternatively, even if the ECU does not adopt the received message, the ECU may send the acknowledgement ACK. Although the description has been given on the NM frame including the NM message, the same method is applicable to other messages described above including, for example, the message for the stop preparation request and the message for the power control request.

### Case of Cutoff of Main Communication Route (Communication Cutoff at the Dashed Line in FIG. 41)

If the main communication line ML5 connecting to the second zone ECU 60 is cut off as shown in the dashed line in FIG. 41, the NM message is not directly sent to the second zone ECU 60. In this case, the mobility computer 10 does not receive the acknowledgement ACK from the second zone ECU 60 even after the given time has elapsed in the timeout process, so that the mobility computer can recognize that the main communication route using the main communication line ML5 is cut off.

Even when the main communication line ML5 is cut off, the second zone ECU 60 can still receive the first redundant NM message sent by the mobility computer 10 and relayed by the first zone ECU 50. Therefore, even if the main communication line ML5 is cut off, the second zone ECU 60 can receive the NM message and can activate from the sleep state to the wake-up state and can continue normal operation.

Because the second zone ECU 60 adopts the redundant NM message, the second zone ECU 60 can recognize that the second zone ECU 60 has not received the main message supposed to be sent earlier. Therefore, the second zone ECU 60 may recognize that an abnormality has occurred in the communication through the main communication line ML5. In this case, the second zone ECU 60 may switch over the communication route by detecting the cutoff. Specifically, the second zone ECU 60 switch over to the route using the first zone ECU 50 as a relay ECU to send the message to the mobility computer 10 from now on (corresponding to a function of cutoff detection and communication switchover). For sending the message from now on, the second zone ECU 60 may switch over to the redundant communication line SL1 determined as not cut off among the connected main communication line ML5 and the connected redundant communication line SL1.

The second zone ECU 60 also sends the acknowledgement ACK to the first zone ECU 50 to adopt the NM message received at this time. When a protocol includes such a first-come-first-win rule that if the NM message for the first time is adopted, the message for the second and subsequent times is discard without sending the acknowledgement ACK, the receipt by the first zone ECU 50 of the acknowledgement ACK makes it possible to recognize that the second zone ECU 60 has not receive the NM message supposed to be sent earlier.

Therefore, the first zone ECU 50 can recognize that the main communication line ML5 connecting between the mobility computer 10 and the second zone ECU 60 is cut off. The message received from now on from the second zone ECU 60 through the redundant communication line SL1 may be relayed and forwarded by the first zone ECU 50 to the mobility computer 10 as the main message. Although the description has been given on the NM frame including the NM message, the same method is applicable to other messages mentioned above so that the cutoff is detectable and the switchover of the message destination and the relay communication line is performable.

### Omission to Send Redundant Message for NM Message

After sending the main message for the NM message and before sending the redundant message for the NM message, the mobility computer 10 may receive the acknowledgement ACK corresponding to the main message. In this case, the mobility computer 10 may not necessarily be required to send the redundant message to the ECU (e.g., 20, 30, 40, 50, 60). If the NM message is cut off, it is not necessary to send the redundant message for the NM message in cases where an internal factor activation of each ECU 20, 30, 40, 50, 60 keeps the active state.

### Selective Sending of Redundant Message

Prior to sending the redundant NM message, the mobility computer 10 may not receive the acknowledgement ACK corresponding to the main message sent by the second zone ECU 60 and may recognize that the main communication line ML5 is cut off. In this case, the mobility computer 10 may selectively send the redundant message such that the redundant message is sent only to the second zone ECU 60.

### Process After Waking Up

When the mobility computer 10 recognizes that all of the ECUs 20, 30, 40, 50, 60 have woken up, the mobility computer 10 executes the power control process at a time of activation (BS30) and executes the power control process at a time of activation Part 2 (BS30a), as shown in FIG. 40.

FIG. 31 illustrates the power control process at a time of activation (BS30), and FIG. 39 illustrates the power control process at a time of activation Part 2 (BS30a). These processes (BS30 and BS30a) are generally the same as the power control process at a time of stop. A difference is merely the IPD on/off control performed according to status changing from “onboard” to “parked” and “parked” to “onboard”. For this reason, the description will be given schematically.

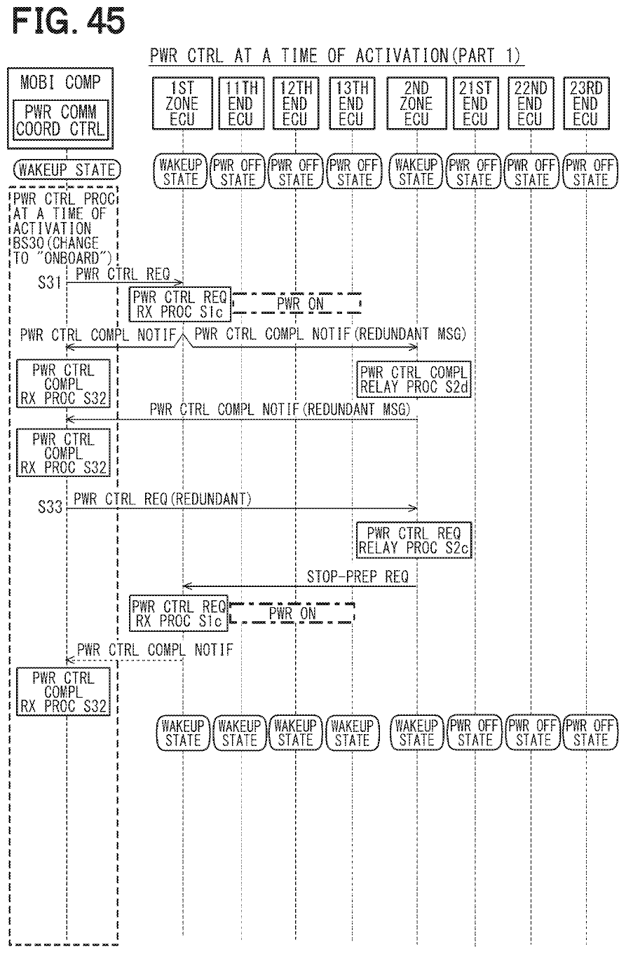

Upon receiving the acknowledgement ACK, the mobility computer 10 sends the main message and the redundant message for the power control request at a time of activation to the first zone ECU 50 (see S31 and S33 in FIG. 45).

As shown in FIG. 45, when the mobility computer 10 sends the main message for the power control request at a time of activation to the first zone ECU 50 (S31), the first zone ECU 50 executes the activation power control request receiving process (S1c: see FIG. 33). Because of the status change from “parked” to “onboard”, the first zone ECU 50 turns ON the IPDs 51 to 53 to provide the power to the end ECUs 71 to 73. Because of this, the ECUs 71 to 73 are powered on and become the wake-up state.

When the first zone ECU 50 executes the activation power control request receiving process, the first zone ECU 50 sends the main message for the activation power control completion directly to the mobility computer 10 and also sends the redundant message for the activation power control completion to the second zone ECU 60. The second zone ECU 60 relays the redundant message for the power control completion at a time of activation (S2d) to send to the mobility computer 10.

When the first Ethernet switch 12a receives the main message for the power control completion notification at a time of activation from the first zone ECU 50, the mobility computer 10 executes the power control completion receiving process at a time of activation (S32). When the second zone ECU 60 receives the redundant message for the power control completion notification at a time of activation forwarded from the first zone ECU 50, the second zone ECU 60 executes the power control completion relaying process at a time of activation (S2d) and forwards the redundant message for the power control completion notification at a time of activation to the mobility computer 10. When the second Ethernet switch 13a receives the redundant message the power control completion notification at a time of activation from the second zone ECU 60, the mobility computer 10 executes the power control completion receiving process at a time of activation (S32).

The message arbitration is performed when the first zone ECU 50 executes the power control request receiving process (S1c) at a time of activation. The mobility computer 10 also performs the arbitration between the main message and the redundant message when executing the power control completion receiving process at a time of activation (S32). These message arbitration processes are similar to S102 described above with reference to FIG. 14, FIG. 15A, and FIG. 16A to FIG. 16C, so that the description is omitted.

### Redundant Message Communication for Power Control Request at a Time of Activation

As shown in the lower part of FIG. 31 and FIG. 45, the mobility computer 10 sends the redundant message for the power control request at a time of activation to the second zone ECU 60 by using the redundant communication line SL1 (S33). In this case, the second zone ECU 60 relays the redundant message for the power control request at a time of activation. The mobility computer 10 waits for receipt of the redundant message for the power control completion notification at a time of activation and executes the power control completion receiving process at a time of activation upon receipt of the redundant message for the power control completion notification at a time of activation (S32).

The second zone ECU 60 relays the redundant message for the power control request at a time of activation (S2c) and the first zone ECU 50 receives the redundant message for the power control request at a time of activation (S1c). The processes in S2c and S1c are similar to those described above, so that the description is omitted. The first zone ECU 50 executes the power control request receiving process (S1c). In order to change the status from “parked” to “onboard”, the first zone ECU 50 performs the control to turn ON the IPD 51 to 53 so that the end ECUs 71 to 73 are powered on. Because of this, the supply of power to the end ECUs 71 to 73 is started.

By sending the redundant message, it is possible to convey the power control request as reliably as possible even if part of the main communication line ML is cut off. The first zone ECU 50 sends the redundant message for the power control completion notification to the mobility computer 10. The mobility computer 10 receives the redundant message for the power control completion notification (S32).

Upon elapse of the given timeout time after sending the redundant message for the power control request (S31), the mobility computer 10 may forcibly end the receiving process for the redundant message for the stop preparation completion notification in S32. The mobility computer 10 then ends the activation power control process (BS30). The second zone ECU 60 may not necessarily send the redundant message for the power control completion notification at a time of activation to the mobility computer 10. Because of this, in the start-up process B shown in FIG. 40, the mobility computer 10 can cause the end ECUs 71 to 73 to transition to the wake-up state.

### Power Control Process at a Time of Activation Part 2 (BS30a)

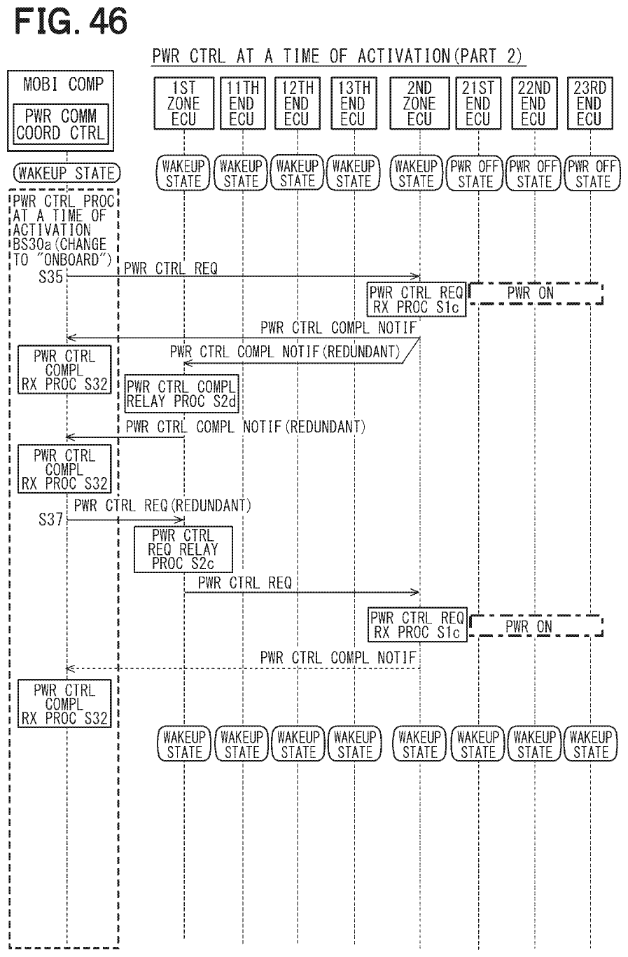

In the activation process B, the mobility computer 10 next executes the power control process at a time of activation Part 2 (BS30a in FIG. 40: see FIG. 46). In the power control process at a time of activation Part 2 (BS30a), the mobility computer 10 exchanges the relay ECU role between the target first zone ECU 50 and second zone ECU 60 to execute again the sending process for the message for the power control request at a time of activation, similarly to the power control process at a time of activation shown in FIG. 45 (BS30) (See FIG. 39 and FIG. 46).

As shown in FIG. 39 and FIG. 46, in the power control process at a time of activation Part 2 (BS30a), the mobility computer 10 sends the main message for the power control process at a time of activation directly from the second Ethernet switch 13a to the second zone ECU 60 through the main communication line ML5 (S35). The mobility computer 10 waits for receipt of the message for the power control completion notification at a time of activation and executes the power control completion receiving process at a time of activation (S32) upon receipt of the message for the power control completion notification at a time of activation. The process in S32 is similar to those described above, so that the description is omitted.

When the second zone ECU 60 receives the main message for the power control request at a time of activation, the second zone ECU 60 executes the power control request receiving process at a time of activation (S1c). The process in S1c is similar to those described above, so that its detailed description is omitted, but the second zone ECU 60 controls the IPDs 61 to 63 based on the message for the power control request at a time of activation. In order to change the status from “parked” to “onboard”, the second zone ECU 60 performs the control to turn ON the IPDs 61 to 63 so that the end ECUs 81 to 83 are powered on. Because of this, it is possible to supply power to the end ECUs 81 to 83.

When the second zone ECU 60 completes the power control, the PHY 64 sends the main message for the power control completion notification to the mobility computer 10 through the main communication line ML5 and the communication circuit 65 sends the redundant message for the power control completion notification to the first zone ECU 50 through the redundant communication line SL1.

When the second Ethernet switch 13a receives the main message for the power control completion notification at a time of activation from the second zone ECU 60, the mobility computer 10 executes the power control completion receiving process at a time of activation (S32). When the first zone ECU 50 receives the redundant message for the power control completion notification at a time of activation forwarded from the second zone ECU 60, the first zone ECU 50 executes the power control completion relaying process at a time of activation (S2d) to forward the redundant message for the power control completion notification at a time of activation to the mobility computer 10. When the first Ethernet switch 12a receives the redundant message for the power control completion notification at a time of activation from the first zone ECU 50, the mobility computer 10 executes the power control completion receiving process at a time of activation (S32).

The message arbitration is performed when the second zone ECU 60 executes the power control request receiving process at a time of activation (S1c). The mobility computer 10 also performs the arbitration between the main message and the redundant message when executing the power control completion receiving process at a time of activation (S32). These message arbitration processes are similar to S102 described above with reference to FIG. 14, FIG. 15A, and FIG. 16A to FIG. 16C, so that the description is omitted.

### Redundant Message Communication for Power Control Request at a Time of Activation

As shown in FIG. 39 and the lower part of FIG. 46, the mobility computer 10 sends the redundant message for the power control request at a time of activation to the second zone ECU 60 by using the redundant communication line SL1 (S37). In this case, the first zone ECU 50 relays the redundant message for the power control request at a time of activation. The mobility computer 10 waits for receipt of the redundant message for the power control completion notification at a time of activation and executes the power control completion receiving process at a time of activation (S32) upon receipt of the power control completion notification at a time of activation.

The first zone ECU 50 relays the redundant message for the power control request (S2c) and the second zone ECU 60 receives the redundant message for the power control request (S1c). The processes in S2c and S1c are similar to those described above, so that the description is omitted. The second zone ECU 60 executes the power control request receiving process (S1c). In order to change the status from “parked” to “onboard”, the second zone ECU 60 performs the control to turn ON the IPD 61 to 63 so that the end ECUs 81 to 83 are powered on. Because of this it is possible to supply power to the end ECUs 81 to 83 reliably. By sending the redundant message, it is possible to convey the power control request as reliably as possible. The second zone ECU 60 sends the redundant message for the power control completion notification to the mobility computer 10. The mobility computer 10 receives the redundant message for the power control completion notification (S32).

Upon elapse of the given timeout time after sending the redundant message for the power control request (S37), the mobility computer 10 may forcibly end the receiving process for the redundant message for the power control completion notification at a time of activation in S32. The mobility computer 10 then ends the power control process at a time of activation. (S30) The second zone ECU 60 may not necessarily send the redundant message for the power control completion notification at a time of activation to the mobility computer 10. Because of this, the mobility computer 10 can cause the end ECUs 81 to 83 to transition to the wake-up state, and ends the activation process B shown in FIG. 40.

### Omission to Send Redundant Message for Power Control Request at a Time of Activation

After sending the main message for the power supply control request at a time of activation and before sending the redundant message, the mobility computer 10 may receive the message for completion notification corresponding to the main message for the power supply control request at a time of activation from the target control device (ECU 20, 30, 40, 50, 60) being the message destination. In this case, the mobility computer 10 may not necessarily be required to send the redundant message for the power supply control request at a time of activation to the destination ECU.

### Overview of the Present Embodiment

The communication system 1 of the vehicle in the present embodiment can use the communication process to perform the activation control. In this regard, a possible concern is such that failing to execute a correct stop process due to a communication abnormality could lead to an equipment malfunction. For addressing this concern, the communication system 1 of the present embodiment is configured such that the message arbitration unit 58, 68, 718, 728, 738, 818, 828, 838, 28 performs the arbitration on the main message and the redundant message, so that even if a communication abnormality occurs, it is possible to keep operation, stop or activate normally.

The present embodiment uses a redundant bus mesh network configuration in which the redundant communication line SL1 (CAN bus) provided between the zone ECU 50, 60 and the battery ECU 20 is employed in a star network configuration including the mobility computer 10 and the zone ECUs 50 and 60. Specifically, the redundant message for appropriate execution of the stop process or the activation process even in the event of communication abnormality occurrence is communicable. Therefore, it is possible to appropriately keep the target ECU active, stop and activate the target ECU, while causing equipment malfunction as rarely as possible.

The description has been given on the configuration including the message arbitration unit 58, 68, 718, 728, 738, 818, 828, 838, 28 which performs arbitration on the main message and one or more redundant messages, as outlined in FIG. 13. Because of this, it is possible to minimize the amount of communication in the mesh network and it is possible to keep the communication load at low, even if the mobility computer 10 sends the main and redundant messages all the time. It is possible to distribute the load due to the abnormality detection process into respective ECUs 20, 50, 60, 71 to 73, 81 to 83, reducing the load on the mobility computer 10 due to the abnormality detection process.

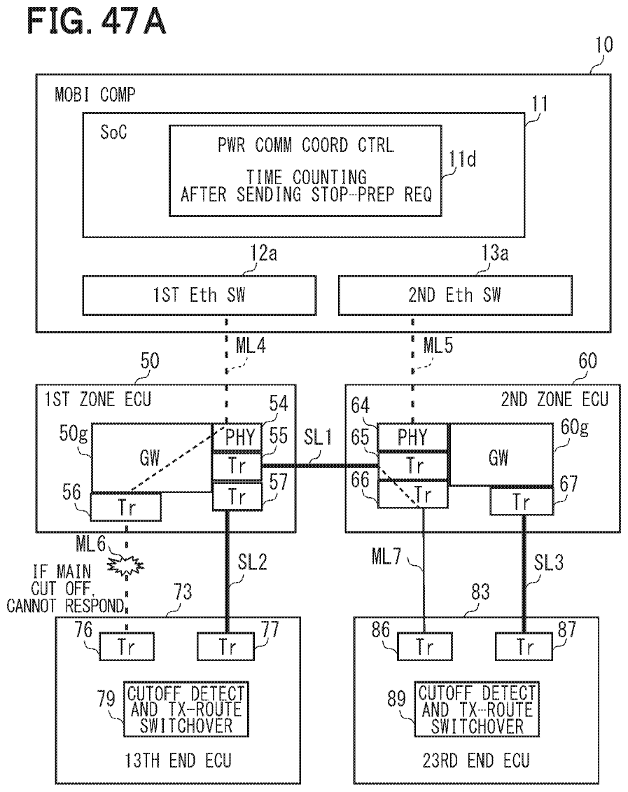

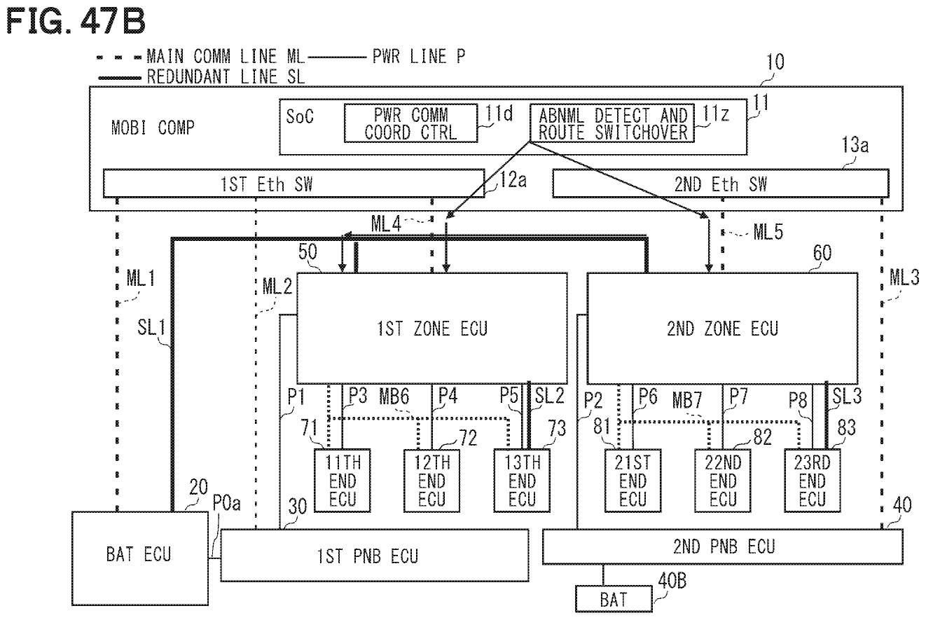

In the present embodiment, the mobility computer 10 acts as a representative to detect, by time-counting, whether the main message has reached each ECU, and upon timeout, send the main or redundant message by using a separate redundant route. In the present embodiment, as shown in FIG. 47A, the zone ECU 50, 60 or the end ECU 71 to 73, 81 to 83 includes the function of cutoff detection-and-transmission route switchover 79, 89, in addition to the process of forcibly stopping the receiving process in response to the timeout. The function of cutoff detection-and-transmission route switchover 79, 89 includes, for example, a function of switching over the transmission route via detecting in the above described way whether or not the main message for the NM message has been received and/or whether or not the redundant message for the NM message has been received, and/or whether or not the acknowledgement ACK has been received from the ECU having received the NM message.

FIG. 47A illustrates an example in which the thirteenth end ECU 73 has the function of cutoff detection-and-transmission route switch over 79 and the twenty-third end ECU 83 has the function of cutoff detection-and-transmission route switch over 89. When the function of cutoff detection-and-transmission route switchover 89 of the thirteenth end ECU 73 or the cutoff detection-and-transmission route switchover 89 of the twenty-third end ECU 83 detects a communication cutoff, the mobility computer 10 is not required to wait for the timeout, allowing communications to proceed quickly.

### Second Embodiment

A second embodiment will be described with reference to FIG. 47B. In the second embodiment, the mobility computer 10 includes a function of abnormality detection-and-route switchover 11z (routing reconfiguration, reestablishment) in place of or in addition to the message arbitration unit 58, 68, 718, 728, 738, 818, 828, 838, 28 of the first embodiment. The mobility computer 10 sends the main message for the stop preparation request and/or the power control request and receives a response notification indicative of completion corresponding to the main message. By detecting the timeout of this response message, the mobility computer 10 detects an abnormality in the main communication route. In this case, the mobility computer 10 may execute again the routing with the addresses assigned to the end ECUs 71 to 73 and thereby configure the next redundant route and switch over to this redundant route to send again.

Specifically, the mobility computer 10 may have redundant protocol functions (link aggregation, RSTP, etc.) of automotive Ethernet including abnormality detection determination, route re-establishment, and redundant transmission. RSTP is an abbreviation for Rapid Spanning Tree Protocol. With the function of abnormality detection-and-route switchover 11z, the mobility computer 10 can detect a route anomality and switch over the route to send again.

### Third Embodiment

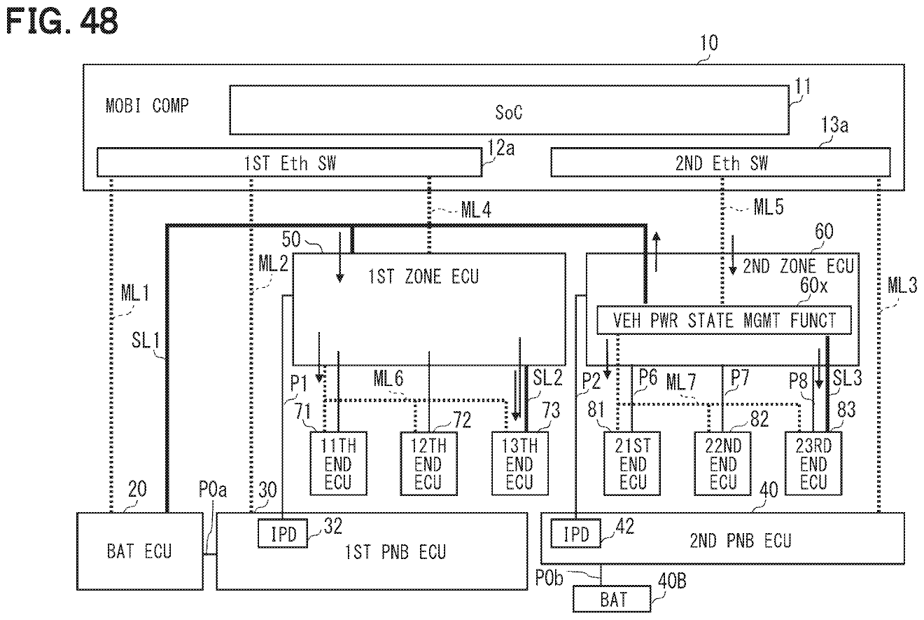

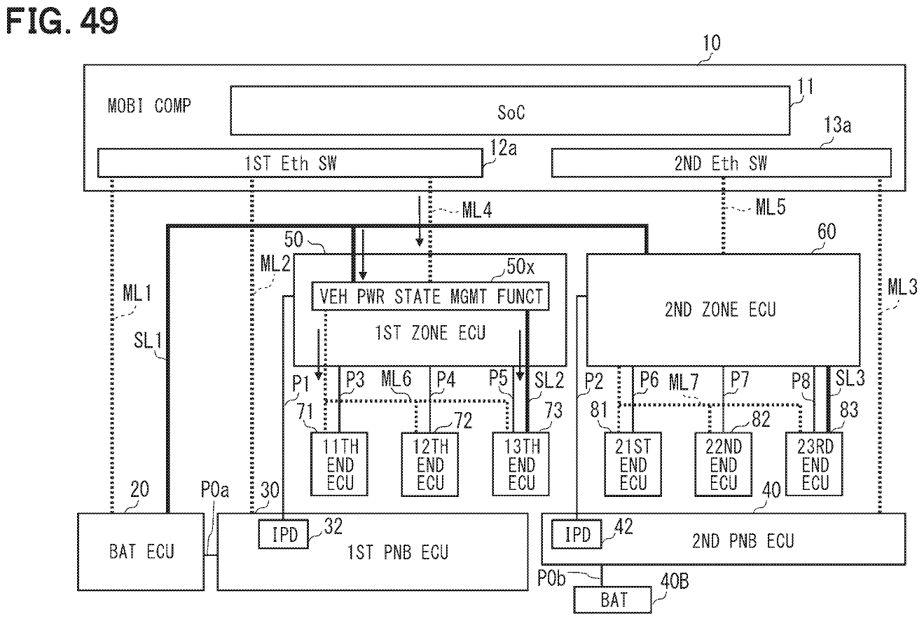

A third embodiment will be described with reference to FIG. 48 and FIG. 49. In the first embodiment, the mobility computer 10 manages the vehicle power state. In the present embodiment, the second zone ECU 60 may have the function of a vehicle power state management unit 60x as shown in FIG. 48, or the first zone ECU 50 may have the function of a vehicle power state management unit 50x as shown in FIG. 49.

It may be necessary that the message for the vehicle power state reaches the high voltage system ECU (in the present embodiment, the first zone ECU 50 and the end ECU 73) even if a fault occurs in the high voltage system and the communication is lost due to a communication cutoff of the fourth main communication line ML4 connected to the first zone ECU 50 for example.

In such a case, as shown in FIG. 48, the second zone ECU 60 being the low voltage system ECU may include the function of the vehicle power state management unit 60x. The function of the vehicle power state management unit 60x represents a vehicle power state management function performed after the second zone ECU 60 pulls up the message from a lower layer to a higher layer and reads the message by using an application 60app constituting the application layer being the higher layer. It may be preferable for the function of the vehicle power state management unit 60x to execute a process only at a time of stop of the high voltage system, so that the processing load on the vehicle power state management unit 60x can be reduced, wherein the high voltage system operates by the first zone ECU 50 and the end ECU 73 constituting the high voltage system control devices.

The mobility computer 10 broadcasts the message for the vehicle power state to the zones ECUs 50, 60 and the end ECUs 71 to 73, 81 to 83. In the present embodiment, by the function of the vehicle power state management unit 60x, the second zone ECU 60 sends the redundant message for the vehicle power state to the first zone ECU 50 through the redundancy communication line SL1. The first zone ECU 50 can then receive the redundant message for the vehicle power state from the second zone ECU 60 as well as the main message for the vehicle power state from the mobility computer 10, so that the messages can be communicated two or more times.

According to the present embodiment, the second zone ECU 60 (corresponding to a low voltage system control device) not being the high voltage system ECU (corresponding to a high voltage system control device) has the function of the vehicle power state management unit 60x being the source of the message for the vehicle power state. Therefore, even if a failure occurs in the route to the high voltage system ECU, the message for the vehicle power state can be reliably communicated.

As shown in FIG. 49, the first zone ECU 50 may have the function of the vehicle power state management unit 50x. The function of the vehicle power state management unit 50x represents a vehicle power state management function performed after the first zone ECU 60 pulls up the message from a lower layer to a higher layer and reads the message by using an application 50app constituting the application layer being the higher layer.

The first zone ECU 50 receives the main message for the vehicle power state from the mobility computer 10 through the main communication line ML4 or the redundant message for the vehicle power state from the second zone ECU 60. When the first zone ECU 50 receives the message from the redundant communication line SL1, the first zone ECU 50 performs the arbitration on the main message and the redundant message for the vehicle power state received through the main communication line ML4 and the redundant communication line SL1.

By the function of the vehicle power state management unit 50x, the first zone ECU 50 may determine the presence or absence of content change of these main and redundant messages, and if necessary, change the content of the previously received message and adopt the message accordingly.

The first zone ECU 50 sends the adopted message for the vehicle power state (main message, redundant message) to the end ECU 71 to 73 via the function of the vehicle power state management unit 50x. It is therefore possible to send the appropriate message for the vehicle power state to the end ECU 71 to 73 more reliably.

### Fourth Embodiment

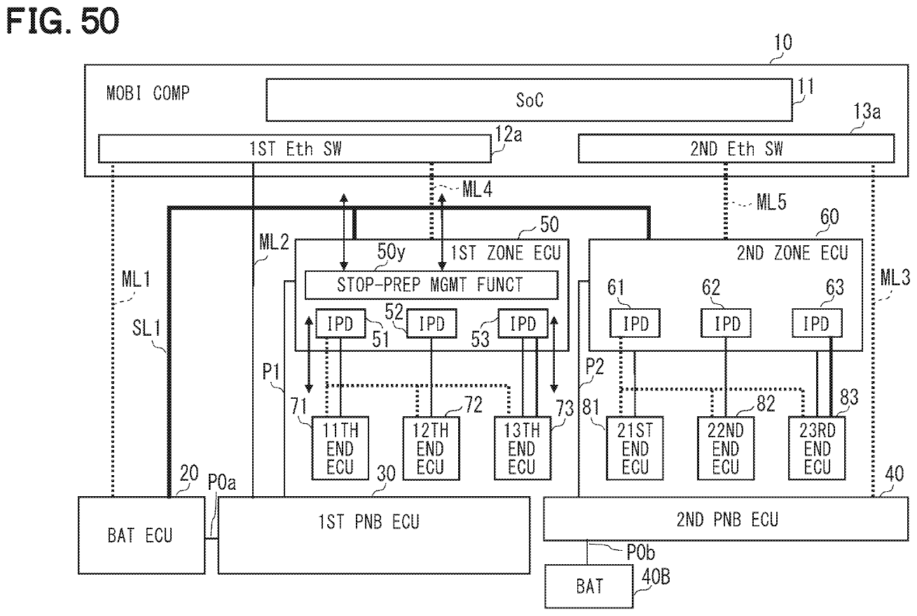

A fourth embodiment will be described with reference to FIG. 50. The first zone ECU 50 being the high-pressure system ECU may include a stop preparation management unit 50y that performs arbitration and management on the message for the stop preparation request.

The first zone ECU 50 receives the message for the stop preparation request from the second zone ECU 60 through the redundant communication line SL1 and performs the arbitration on the main message and the redundant message for the stop preparation request received through the main communication line ML4 and the redundant communication line SL1. By the function of the stop preparation management unit 50y, the first zone ECU 50 determines the presence or absence of content change of these main and redundant messages, and if necessary, changes the content of the previously received message and adopts the message accordingly. The first zone ECU 50 performs the arbitration on the main message and the redundant message for the stop preparation request received by the function of stop preparation management unit 50y and relays the message to the end ECU 71 to 73 to manage the stop preparation.

The first zone ECU 50 sends the adopted message for the stop preparation request (main message, redundant message) to the end ECU 71 to 73 via the function of the stop preparation management unit 50y. It is therefore possible to send the appropriate message for the stop preparation request to the end ECU 71 to 73 more reliably. In particular, even if the main communication line ML4 is lost when the high voltage system is stopped, it is possible to communicate the message for stop preparation request to the high voltage system ECU. Although not shown in the drawings, the second zone ECU 60 may have a function similar to the stop preparation management unit 50y.

### Fifth Embodiment

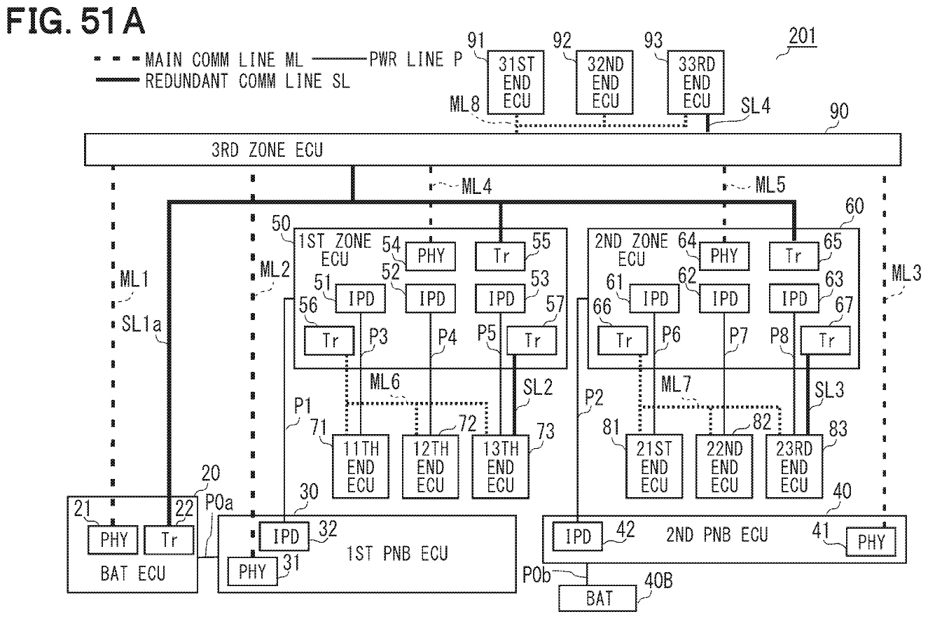

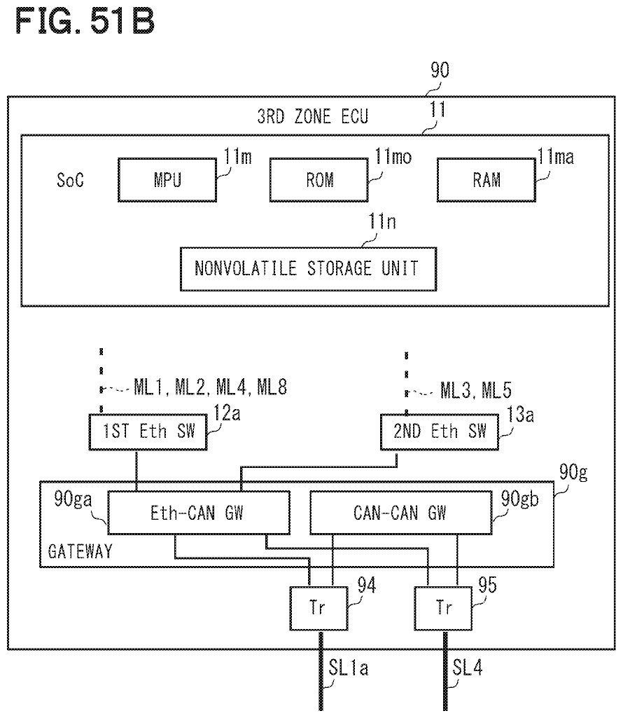

The fifth embodiment will be described with reference to FIG. 51A and FIG. 51B. A communication system 201 in FIG. 51A includes a third zone ECU 90 in place of the mobility computer 10 shown in FIG. 1A. The third zone ECU 90 includes hardware similar to the SoC 11 of the mobility computer 10, and includes a gateway 90g, a first Ethernet switch 12a, a second Ethernet switch 13a, and communication circuits 94, 95. The first Ethernet switch 12a is connected to the first main communication line ML1, the second main communication line ML2, the fourth main communication line ML4, and the eighth main communication line ML8. The second Ethernet switch 13a is connected to the third main communication line ML3 and the fifth main communication line ML5. The communication circuits 94 and 95 include functions of communications conforming to the CAN or CAN-FD standards and are connected to the redundant communication lines SL1a and SL4, respectively.

A thirty-first end ECU 91, a thirty-second end ECU 92, and a thirty-third end ECU 93 are communicably connected to the third zone ECU 90. The thirty-first end ECU 91, the thirty-second end ECU 92, and the thirty-third end ECU 93 are referred to as end ECUs 91 to 93. The third zone ECU 90 is connected to the end ECUs 91 to 93 through the eighth main communication line ML8. The third zone ECU 90 is connected to the thirty-third end ECU 93 through the fourth main communication line ML4.

The battery ECU 20, the first zone ECU 50, the second zone ECU 60, and the third zone ECU 90 are communicably connected to each other through the redundant communication line SL1a.

The gateway 90g has a function (Eth-CAN gateway 90ga) of protocol conversion between Ethernet and CAN for the communication frame of the first Ethernet switch 12a and the communication frame of the communication circuit 94, 95. The gateway 50 g also has a CAN-CAN gateway function (CAN-CAN gateway 90gb) for determining the communication line being to the relay destination and the transmission destination for the communication frame of the communication circuit 94 and the communication frame of the communication circuit 95.

The Eth-CAN gateway 90ga performs protocol conversion between the communication frame of the first Ethernet switch 12a and the communication frame of the communication circuit 94 and performs protocol conversion between the first Ethernet switch 12a and the communication circuit 95. The Eth-CAN gateway 90ga performs protocol conversion between the communication frame of the second Ethernet switch 13a and the communication frame of the communication circuit 94 and performs protocol conversion between the communication frame of the second Ethernet switch 13a and the communication frame of the communication circuit 95.

The third zone ECU 90 includes a message arbitration unit 98. The message arbitration unit 98 performs arbitration on whether to send the main message or the redundant message when sending the message. When sending the message, the message arbitration unit 98 arbitrates to which communication line the message is to be sent among the main communication line ML and the redundant communication line SL. When sending the message, the message arbitration unit 98 arbitrates whether the message is to be sent to the communication line in both the abnormal condition and the normal condition or either one of the abnormal condition and the normal condition. It may be preferable for the third zone ECU 90 to send the main and redundant messages at all times. However, for example, upon detecting an abnormality of communication line (ML in particular) cutoff, the third zone ECU 90 determines whether or not to send the main and redundant messages and sends the main and redundant messages as necessary.

For example, the third zone ECU 90 cannot send the main message directly to the first, second zone ECU 50, 60, if the third zone ECU 90 detects, for example, the cutoff of the main communication line ML4, ML5. In such a case, the message arbitration unit 98 determines and arbitrates whether to send the main message to a separate main communication line ML or whether to send the redundant message to a separate redundant communication line SL. By executing processes similar to those of the above embodiment, this communication system 1 can provide the similar operational effects.

### Other Embodiments

The present disclosure is not limited to the embodiments described above and the above embodiments can be modified and expanded in various ways, examples of which will be described below.

In the above-described embodiments, an important redundant communication line constituting a redundant route is the redundant communication line SL1. The number of redundant communication lines SL may be further increased, and the present disclosure is applicable to a configuration where the number of redundant communication lines SL connecting between the mobility computer 10 and another ECU or between the third zone ECU 90 and another ECU is two or more.

The Ethernet switches 12a and 13a described in the above embodiments may be integrated into a single unit, or may be separate as shown in the first embodiment, etc. The others are similar to those in the above-described embodiment, so that the description is omitted.

### Omission to Send Redundant Message When Timeout Occurs

The mobility computer 10 may not necessarily be required to send the redundant message for the stop preparation completion notification, the power control request at a time of stop, or the power control request at a time of activation upon the timeout in the receiving process for the main message for the stop preparation completion notification, the power control request at a time of stop, or the power control request at a time of activation.

For example, when the mobility computer 10 being the source can recognize, via the occurrence of the timeout, the completion of the stop preparation even without the stop preparation completion notification, the mobility computer 10 is not required to send the redundant message, wherein the stop preparation completion notification indicates that the control device (e.g., zone ECU 50, 60) having received the stop preparation request has completed the stop preparation. With respect to the power control request at a time of stop, the mobility computer 10 may not necessarily be required to send the redundant message for the power control request at a time of stop when it is considered that the control device has completed the stop preparation and the IPD of the high voltage system is controlled for off and the control device keeping the active state does not lead to malfunction.

The “main message” is a message communicated via the main communication route, and the “redundant message” is a message communicated via the redundant route. The “main communication line ML” represents a communication line to communicate both the main message and the redundant message. The redundant communication line SL” represents a communication line to communicate both the main message and the redundant message.

The main communication route is a route that enables the main message to be communicated between the mobility computer 10 and another ECU or between the third zone ECU 90 and another ECU and that includes the main communication line ML connecting between the mobility computer 10 or the third zone ECU 90 and another ECU 20, 50, 60, 71 to 73, 81 to 83. One or more redundant routes are for communicating the main message or the redundant message. One or more redundant routes include a redundant communication line SL being a communication route connecting between target devices, wherein the target devices are between at least two or more of: the mobility computer 10, the third zone ECU 90 and another ECU (20, 50, 60, 71 to 73, 81 to 83).

In a least the first and fifth embodiments, the communication system 1, 201 including coexistence of the automotive Ethernet network and the CAN network is illustrated. The present disclosure is not limited to this co-existence. The present disclosure is applicable to an automotive Ethernet network communication system and a CAN network communication system. The present disclosure is applicable to a communication system further including another automotive communication standards.

The system and the method described in the present disclosure may be implemented by a dedicated computer provided by configuring a memory and a processor programmed to execute one or more functions embodied by a computer program. Alternatively, the system and the method described in the present disclosure may be implemented by a dedicated computer provided by configuring a processor using one or more dedicated hardware logic circuits. Alternatively, the system and method described in the present disclosure may be implemented by one or more dedicated computers provided by configuring a memory and a processor programmed to perform one or more functions in combination with one or more hardware logic circuits. The computer program may be stored on a computer-readable non-transitory tangible storage medium as instructions executed by a computer.

Although the present disclosure has been described in accordance with the embodiments, it is to be understood that the present disclosure is not limited such embodiments and structures described in the embodiments. The present disclosure includes various modification examples and equivalent modifications. In addition, various combinations and forms, including a single element, more or less, are also within the sprit and the scope of the present disclosure.

What is claimed is:

1. A communication system comprising:
a plurality of control devices and a management device each provided by at least a processor and a memory and configured to be capable of communicating a message through a communication line;
a main communication route that enables a main message to be communicated between the management device and a control device, and that includes a main communication line connecting the management device and the control device, wherein the control device is included in the plurality of control devices; and
a redundant route that includes a redundant communication line connecting between two or more target devices, wherein the two or more target devices are between at least two of the management device and the plurality of control devices, and the redundant route is one or more redundant routes,
wherein the management device is configured to send the main message regarding activation or stop of the control device and a redundant message having the same message as the main message to the control device by using the main communication route and the redundant route, wherein the redundant message is one or more redundant messages,
the communication system further comprising:
a message arbitration unit that is provided in one or more of: the management device and the control device, and that performs arbitration on two or more of: the main message and the one or more redundant messages, wherein the message arbitration unit is provided by at least the processor and the memory.

2. The communication system according to claim 1, wherein:
when receiving or relaying the message, the message arbitration unit determines from which communication line the message has been received among the main communication line and the redundant communication line to adopt the message.

3. The communication system according to claim 1, wherein:
when receiving or relaying the message, the message arbitration unit performs the arbitration concerning which message is to be adopted among the main message and the redundant message.

4. The communication system according to claim 1, wherein:
upon receipt of both the main message and the redundant message, the message arbitration unit adopts an earlier-received message among the main message and the redundant message.

5. The communication system according to claim 1, wherein:
the main message and the redundant message as the message are assigned serial numbers, and
the message arbitration unit references to the serial numbers to adopt a high priority message among the main message and the redundant message.

6. The communication system according to claim 1, wherein:
upon adopting the message from among the main message and the redundant message, the message arbitration unit sends an acknowledgement only for the adopted message.

7. The communication system according to claim 1, wherein:
upon adopting the message from among the main message and the redundant message, the message arbitration unit sends an acknowledgement for the adopted message and also sends an acknowledgement for the message not adopted.

8. The communication system according to claim 1, wherein:
when relaying the message, the message arbitration unit performs the arbitration concerning to which communication line the message is to be forwarded among the main communication line and the redundant communication line.

9. The communication system according to claim 1, wherein:
when sending the message, the message arbitration unit performs the arbitration concerning which message is to be sent among the main message and the redundant message.

10. The communication system according to claim 1, wherein:
when sending the message, the message arbitration unit performs the arbitration concerning to which communication line the message is to be sent among the main communication line and the redundant communication line.

11. The communication system according to claim 1, wherein:
when sending the message, the message arbitration unit performs the arbitration concerning whether to send the message to the redundant communication line in both a normal condition and an abnormal condition or in either one of the normal condition and the abnormal condition.

12. The communication system according to claim 1, wherein:
if the management device has not received a completion notification corresponding to the message, the management device forcibly ends waiting for receipt of the completion notification upon elapse of a given timeout time after sending the message.

13. The communication system according to claim 1, wherein:
the message is any of: a vehicle power state; a stop preparation request; a stop preparation completion notification; a power control request at a time of stop or activation; a power control completion notification at a time of stop or activation; and
an NM message.

14. The communication system according to claim 1, wherein:
upon completing stop preparation corresponding to the message for a stop preparation request by the management device, the control device sends the message for a stop preparation completion notification to the management device through the main communication line.

15. The communication system according to claim 1, wherein:
upon completing stop preparation corresponding to the message for a stop preparation request by the management device, the control device sends the message for a stop preparation completion notification to the management device by switching over to a communication line determined as not cutoff among the main communication line and the redundant communication line.

16. The communication system according to claim 1, wherein:
upon completing power control corresponding to the message for a power control request at a time of stop by the management device, the control device sends the message for a power control completion notification to the management device through the main communication line.

17. The communication system according to claim 1, wherein:
upon completing power control corresponding to the message for a power control request at a time of stop by the management device, the control device sends the message for a power control completion notification to the management device by switching over to a communication line determined as not cutoff among the main communication line and the redundant communication line.

18. The communication system according to claim 1, wherein:
the management device sends the main message being an NM message indicative of an activation request and the redundant message to the plurality of control devices.

19. The communication system according to claim 18, wherein:
the control device receives the NM message from the management device and sends an acknowledgement to the management device upon adopting the NM message.

20. The communication system according to claim 1, wherein:
upon completing power activation corresponding to a power control request at a time of activation by the management device, the control device sends the message for a power control completion notification at a time of activation through the main communication route.

21. The communication system according to claim 1, wherein
upon completing power control corresponding to the message for a power control request at a time of stop by the management device, the control device sends the message for a power control completion notification to the management device by switching over to a communication line determined as not cutoff among the main communication line and the redundant communication line.

22. The communication system according to claim 1, wherein:
the plurality of control device includes a first control device and a second control device;
the first control device is configured as a first relay ECU connected to the redundant communication line;
the second control device is configured as a second relay ECU connected to the redundant communication line; and
when sending the main message to the first control device, the management device sends the main message to the second relay ECU and the second relay ECU relays to the first control device through the redundant communication line.

23. The communication system according to claim 1, wherein:
the plurality of control devices includes a first control device and a second control device;
the first control device is configured as a first relay ECU connected to the redundant communication line;
the second control device is configured as a second relay ECU connected to the redundant communication line; and
when sending the main message to the second control device, the management device sends the main message to the first relay ECU and the first relay ECU relays to the second control device through the redundant communication line.

24. The communication system according to claim 22, wherein:
the management device exchanges a relay ECU role between the first control device and the second control device to send again the main message as the redundant message.

25. The communication system according to claim 22, wherein:
the main message is the message for a stop preparation request, a power control request at a time of stop, or a power control request at a time of activation.

26. The communication system according to claim 1, wherein:
the plurality of control devices includes a first control device and a second control device;
the first control device is configured as a first relay ECU connected to the redundant communication line;
the second control device is configured as a second relay ECU connected to the redundant communication line; and
when sending the redundant message to the first control device, the management device sends the redundant message to the second relay ECU and the second relay ECU relays to the first control device through the redundant communication line.

27. The communication system according to claim 1, wherein:
the plurality of control devices includes a first control device and a second control device;
the first control device is configured as a first relay ECU connected to the redundant communication line;
the second control device is configured as a second relay ECU connected to the redundant communication line; and
when sending the redundant message to the second control device, the management device sends the redundant message to the first relay ECU and the first relay ECU relays to the second control device through the redundant communication line.

28. The communication system according to claim 26, wherein:
the plurality of control devices includes a first control device and a second control device; and
the management device exchanges a relay ECU role between the first control device and the second control device to send again the redundant message.

29. The communication system according to claim 26, wherein:
the redundant message is the message for a stop preparation request, a power control request at a time of stop, or a power control request at a time of activation.

30. The communication system according to claim 1, wherein:
the plurality of control devices includes a cascade-connection control device that is connected to at least one or more of the control devices for cascade-connection; and
the plurality of control devices includes a plurality of relay ECUs provided for relaying the message from the management device to the cascade-connection control device.

31. The communication system according to claim 1, wherein:
the plurality of control devices includes a cascade-connection control device that is connected to at least one or more of the control devices for cascade-connection; and
the plurality of control devices includes a battery ECU that controls supply of power for a high voltage system and a relay ECU provided for relaying the messages from the management device to the cascade-connection control device.

32. The communication system according to claim 1, wherein:
if, after sending the main message and before sending the redundant message, the management device receives the message for a completion notification corresponding to the main message from the control device being a destination of the main message, the management device does not send the redundant message to the control device being the destination.

33. The communication system according to claim 1, wherein:
the plurality of control devices includes a high voltage system control device and a low voltage system control device;
the low voltage system control device includes a vehicle power state management unit that manages a vehicle power state; and
when the management device sends the main message for the vehicle power state, the vehicle power state management unit of the low voltage system control device receives the main message for the vehicle power state and sends the redundant message for the vehicle power state through the redundant route,
wherein the vehicle power state management unit is provided by at least the processor and the memory.

34. The communication system according to claim 33, wherein:
the vehicle power state management unit performs a process only at a time of stop of a high voltage system, wherein the high voltage system operates by the high voltage system control device.

35. The communication system according to claim 1, wherein:
the plurality of control devices includes a high voltage system control device and a low voltage system control device;
when the management device sends the main message for a vehicle power state and the low voltage system control device receives the main message for the vehicle power state from the management device, the low voltage system control device sends the redundant message for the vehicle power state to the high voltage system control device through the redundant route; and
the high voltage system control device includes a vehicle power state management unit that performs arbitration on the main message for the vehicle power state received from the high voltage system control device and the redundant message and manages the vehicle power state,
wherein the vehicle power state management unit is provided by at least the processor and the memory.

36. The communication system according to claim 1, wherein:
the plurality of control devices includes a high voltage system control device and a low voltage system control device;
the plurality of control devices includes a cascade-connection control device connected to a high voltage system control device for cascade connection, wherein the high voltage system control device is one or more high voltage system control devices;
when the management device sends the main message for a stop preparation request and the low voltage system control device receives the main message for the stop preparation request from the management device, the low voltage system control device sends the redundant message for the stop preparation request to the high voltage system control device through the redundant route; and
the high voltage system control device includes a stop preparation management unit that performs arbitration on the main message for the stop preparation request received from the low voltage system control device and the redundant message and relays the message to the cascade-connection control device and manages stop preparation,
wherein the stop preparation management unit is provided by at least the processor and the memory.

37. The communication system according to claim 1, wherein:
the management device sends the redundant message through the redundant route when changing from a first status to a second status, the first status is on-board and driving, and the second status is on-board and parked.

38. The communication system according to claim 35, wherein:
through the redundant communication line, the management device sends the main message regarding stop of the control device and the redundant message at a time of stop of a high voltage system, wherein the high voltage system operates by the high voltage system control device.

39. The communication system according to claim 1, wherein:
the management device includes a plurality of Ethernet switches; and
the management device sends the main message and the redundant message respectively from the Ethernet switches different from each other.

40. The communication system according to claim 1, further comprising
an abnormality detection route switchover unit that detects a route abnormality and performs route switchover using a redundancy protocol function of an automotive Ethernet, which includes an abnormality detection determination, route re-establishment, and redundant transmission function,
wherein the abnormality detection route switchover unit is provided by at least the processor and the memory.

41. The communication system according to claim 1, wherein:
by using a gateway, the control device performs protocol conversion to relay the message to the redundant communication line.

42. A management device in a communication system,
the communication system including:
a plurality of control devices and the management device each provided by at least a processor and a memory and configured to be capable of communicating a message through a communication line;
a main communication route that enables a main message to be communicated between the management device and a control device, and that includes a main communication line connecting the management device and the control device, wherein the control device is included in the plurality of control devices; and
a redundant route that includes a redundant communication line connecting between two or more target devices, wherein the two or more target devices are between at least two of the management device and the plurality of control devices, and the redundant route is one or more redundant routes,
wherein a message arbitration unit is provided in one or more of: the management device and the control device, and the message arbitration unit performs arbitration on two or more of: the main message and one or more redundant messages,
wherein the management device is configured to send the main message regarding activation or stop of the control device and the one or more redundant messages having the same message as the main message to the control device by using the main communication route and the redundant route,
wherein the abnormality detection route switchover unit is provided by at least the processor and the memory.

43. A control device in a communication system,
the communication system including:
a plurality of control devices and a management device each provided by at least a processor and a memory and configured to be capable of communicating a message through a communication line;
a main communication route that enables a main message to be communicated between the management device and a control device, and that includes a main communication line connecting the management device and the control device, wherein the control device is included in the plurality of control devices; and
a redundant route that includes a redundant communication line connecting between two or more target devices, wherein the two or more target devices are between at least two of the management device and the plurality of control devices, and the redundant route is one or more redundant routes,
wherein the management device is configured to send the main message regarding activation or stop of the control device and a redundant message having the same message as the main message to the control device by using the main communication route and the redundant route, wherein the redundant message is one or more redundant messages,
the control device comprising:
a message arbitration unit that performs arbitration on two or more of: the main message and the one or more redundant messages,
wherein the message arbitration unit is provided by at least the processor and the memory.

44. A control method performed by a communication system,
the communication system including:
a plurality of control devices and a management device each provided by at least a processor and a memory and configured to be capable of communicating a message through a communication line;
a main communication route that enables a main message to be communicated between the management device and a control device, and that includes a main communication line connecting the management device and the control device, wherein the control device is included in the plurality of control devices; and
a redundant route that includes a redundant communication line connecting between two or more target devices, wherein the two or more target devices are between at least two of the management device and the plurality of control devices, and the redundant route is one or more redundant routes,
wherein the management device is configured to send the main message regarding activation or stop of the control device and a redundant message having the same message as the main message to the control device by using the main communication route and the redundant route, wherein the redundant message is one or more redundant messages,
the control method comprising:
by one or more of the management device and the control device, performing arbitration on two or more of: the main message and the one or more redundant messages.

45. A non-transitory storage medium storing a control program executed by a communication system,
the communication system including:
a plurality of control devices and a management device each provided by at least a processor and a memory and configured to be capable of communicating a message through a communication line;
a main communication route that enables a main message to be communicated between the management device and a control device, and that includes a main communication line connecting the management device and the control device, wherein the control device is included in the plurality of control devices; and
a redundant route that includes a redundant communication line connecting between two or more target devices, wherein the two or more target devices are between at least two of the management device and the plurality of control devices, and the redundant route is one or more redundant routes,
the control program causing:
the management device to send the main message regarding activation or stop of the control device and a redundant message having the same message as the main message to the control device by using the main communication route and the redundant route, wherein the redundant message is one or more redundant messages; and
one or more of the management device and the control device to perform arbitration on two or more of: the main message and the one or more redundant messages.
